(19) United States
(12) Patent Application Publication
(10) Pub. No.: US 2025/0294394 A1
(43) Pub. Date: Sep. 18, 2025

(54) EVENT-DRIVEN MEASUREMENT AND REPORTING

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 19/067,830

(22) Filed: Feb. 28, 2025

Related U.S. Application Data
(60) Provisional application No. 63/565,947, filed on Mar. 15, 2024.
(60) Provisional application No. 63/567,777, filed on Mar. 20, 2024.
(60) Provisional application No. 63/568,928, filed on Mar. 22, 2024.
(60) Provisional application No. 63/634,760, filed on Apr. 16, 2024.
(60) Provisional application No. 63/635,240, filed on Apr. 17, 2024.
(60) Provisional application No. 63/641,203, filed on May 1, 2024.

(51) Int. Cl. H04W 24/10; H04B 7/06; H04B 17/318

(52) U.S. Cl. CPC H04W 24/10; H04B 7/06952; H04B 17/328

(57) ABSTRACT

Methods and apparatuses for event-driven measurement and reporting. A method performed by a user equipment (UE) includes receiving first information related to an event for triggering a beam report, receiving a set of one or more periodic reference signals (RSs) for event evaluation, and receiving second information related to the beam report. The method further includes obtaining one or more quality metrics based on measurement of the one or more periodic RSs, determining the event based on the first information and the one or more quality metrics, determining, based on the determination of the event and the second information, and transmitting the beam report. The beam report indicates at least one quality metric from the one or more quality metrics. The one or more quality metrics are associated with the event.

### CROSS-REFERENCE TO RELATED AND CLAIM OF PRIORITY

The present application claims priority under 35 U.S.C. § 119(e) to U.S. Provisional Patent Application No. 63/565,947 filed on Mar. 15, 2024; U.S. Provisional Patent Application No. 63/567,777 filed on Mar. 20, 2024; U.S. Provisional Patent Application No. 63/568,928 filed on Mar. 22, 2024; U.S. Provisional Patent Application No. 63/634,760 filed on Apr. 16, 2024; U.S. Provisional Patent Application No. 63/635,240 filed on Apr. 17, 2024; and U.S. Provisional Patent Application No. 63/641,203 filed on May 1, 2024, which are hereby incorporated by reference in their entirety.

### TECHNICAL FIELD

The present disclosure relates generally to wireless communication systems and, more specifically, the present disclosure relates to methods and apparatuses for event-driven measurement and reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to event-driven measurement and reporting.

In one embodiment, a user equipment (UE) is provided. The UE includes a transceiver configured to receive first information related to an event for triggering a beam report, receive a set of one or more periodic reference signals (RSs) for event evaluation, and receive second information related to the beam report. The UE further includes a processor operably coupled with the transceiver. The processor configured to obtain one or more quality metrics based on measurement of the one or more periodic RSs, determine the event based on the first information and the one or more quality metrics, and determine, based on the determination of the event and the second information. The beam report indicates at least one quality metric from the one or more quality metrics. The one or more quality metrics are associated with the event. The transceiver is further configured to transmit the beam report.

In another embodiment, a base station (BS) is provided. The BS includes a processor and a transceiver operably coupled with the processor. The transceiver is configured to transmit first information related to an event for triggering a beam report, transmit a set of one or more periodic RSs for event evaluation, transmit second information related to the beam report, and receive the beam report after occurrence of the event. The beam report indicates at least one quality metric from one or more quality metrics associated with the one or more periodic RSs. The beam report is based on the second information. Occurrence of the event is based on first information and the one or more quality metrics. The one or more quality metrics are associated with the event.

In yet another embodiment, a method performed by a UE is performed. The method includes receiving first information related to an event for triggering a beam report, receiving a set of one or more periodic RSs for event evaluation, and receiving second information related to the beam report. The method further includes obtaining one or more quality metrics based on measurement of the one or more periodic RSs, determining the event based on the first information and the one or more quality metrics, determining, based on the determination of the event and the second information, and transmitting the beam report. The beam report indicates at least one quality metric from the one or more quality metrics. The one or more quality metrics are associated with the event.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIGS. 7A and 7B illustrate examples of report contents and formats according to embodiments of the present disclosure;

FIGS. 8A, 8B, and 8C illustrate examples of report contents and formats according to embodiments of the present disclosure;

FIG. 9 illustrates examples of priority values/orders of different UEI reports according to embodiments of the present disclosure;

FIG. 10 illustrates an example of a two-part UEI report according to embodiments of the present disclosure; and

FIG. 11 illustrates an example method performed by a UE in a wireless communication system according to embodiments of the present disclosure.

### DETAILED DESCRIPTION

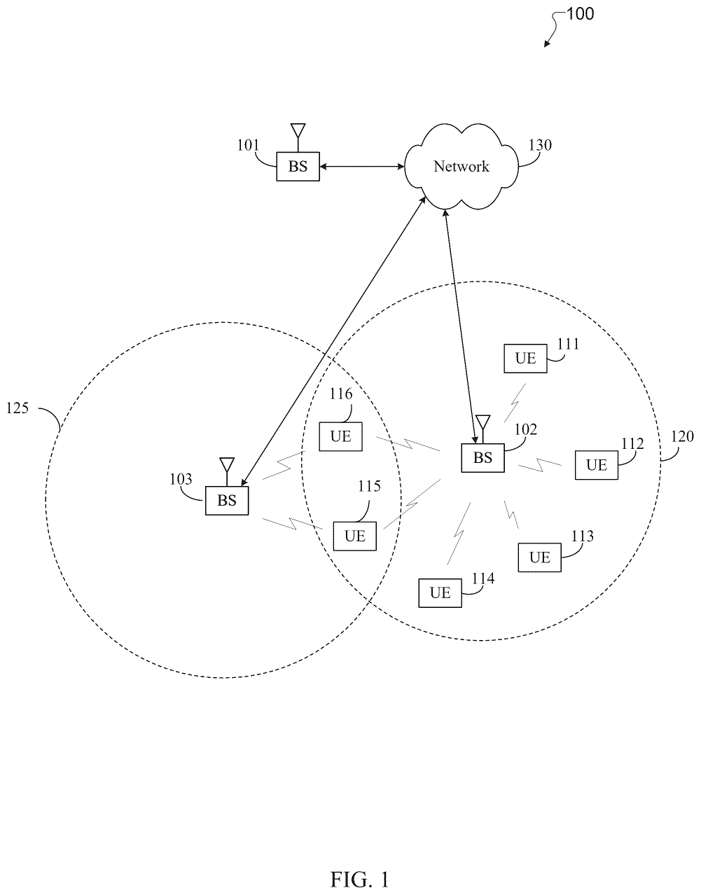

FIGS. 1-11, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1]3GPP TS 38.211 v16.1.0, “NR; Physical channels and modulation;” [REF2]3GPP TS 38.212 v16.1.0, “NR; Multiplexing and Channel coding;” [REF3]3GPP TS 38.213 v16.1.0, “NR; Physical Layer Procedures for Control;” [REF4]3GPP TS 38.214 v16.1.0, “NR; Physical Layer Procedures for Data;” [REF 5]3GPP TS 38.321 v16.1.0, “NR; Medium Access Control (MAC) protocol specification;” and [REF6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing event-driven measurement and reporting. In certain embodiments, one or more of the BSs 101-103 include circuitry, programing, or a combination thereof to support event-driven measurement and reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

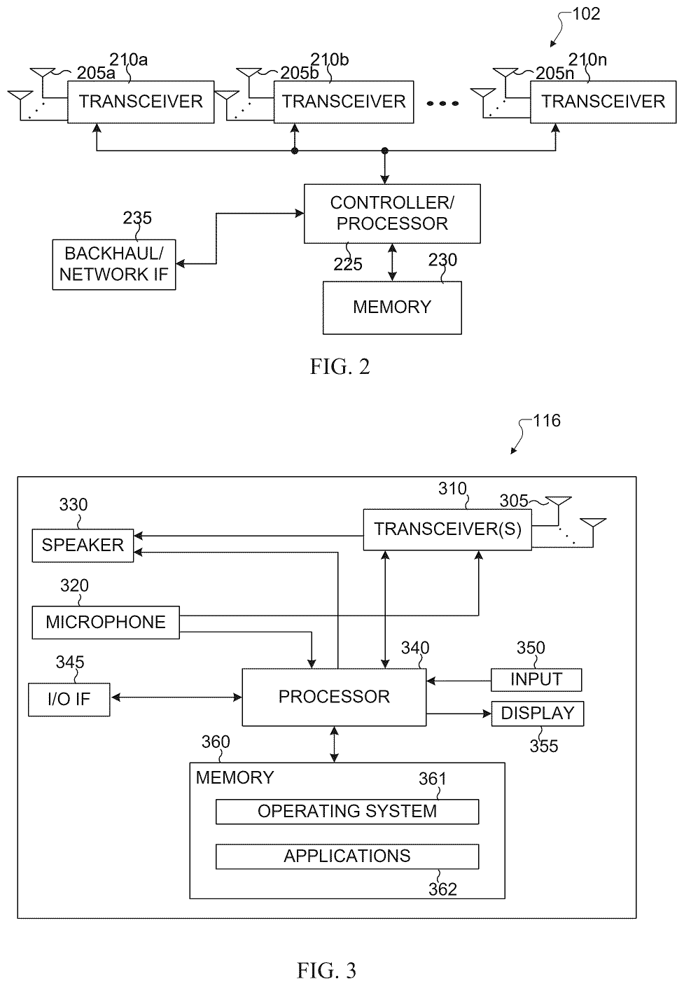

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting event-driven measurement and reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or perform event-driven measurement and reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

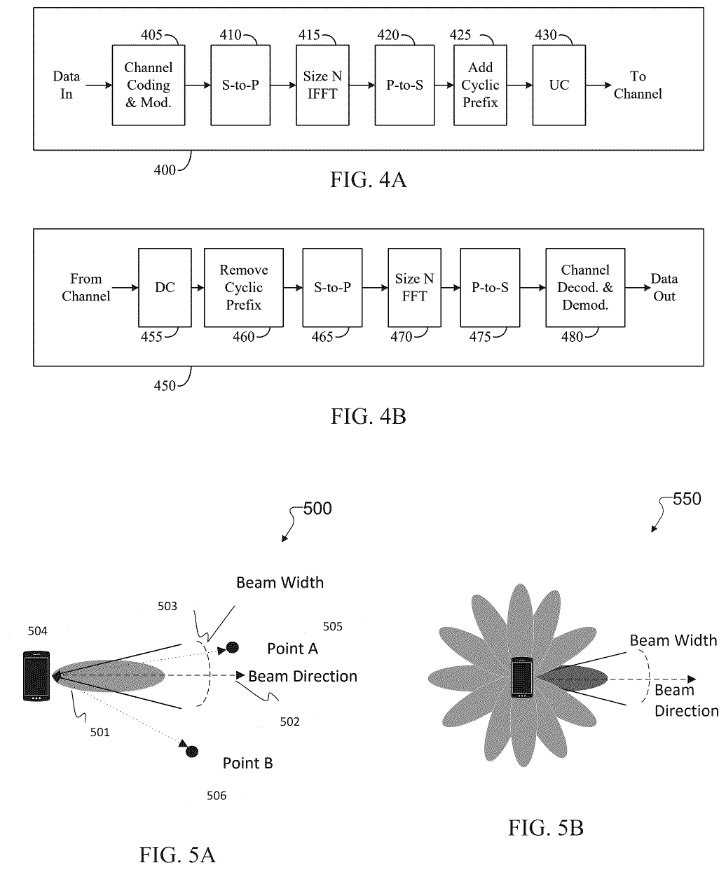

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support event-driven measurement and reporting as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

As illustrated in FIG. 5A, in a wireless system 500, a beam 501 for a device 504 can be characterized by abeam direction 502 and abeam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

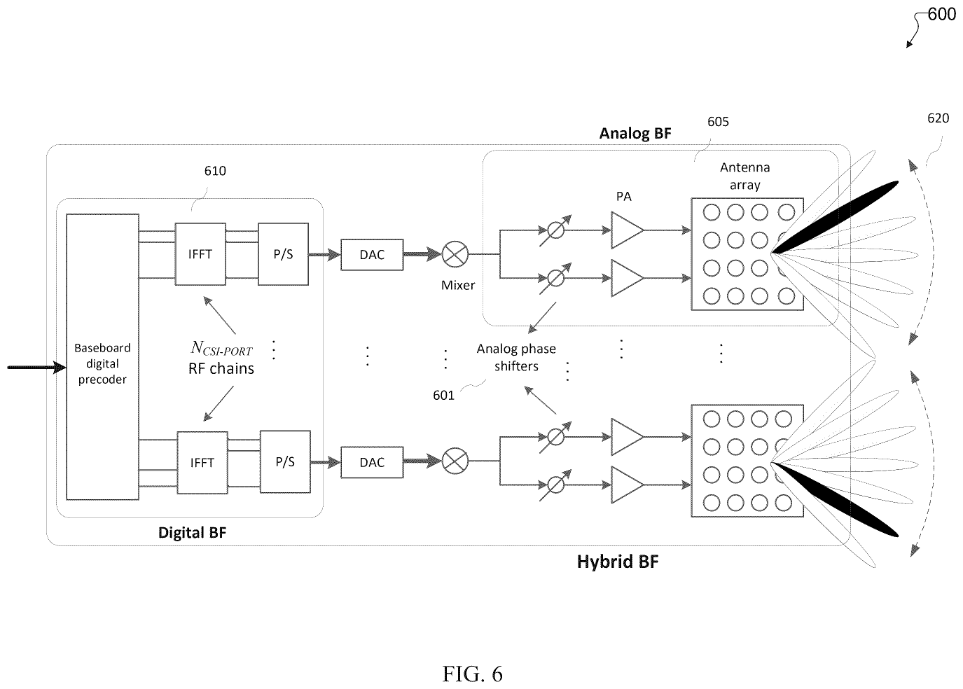

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

In various embodiments of the present disclosure, a beam is determined by either of;
A transmission configuration indication (TCI) state, that establishes a quasi-colocation (QCL) relationship between a source reference signal (e.g. synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE (e.g., the UE 116), or a spatial TX filter for transmission of uplink channels from the UE.

In (up to Rel.17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Embodiments of the present disclosure recognizes that, although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from common beam or CSI reports) and application scenarios.

Although UE-initiated reporting and/or beam switching and/or beam activation/deactivation can be beneficial, efficient designs are needed to ensure that the latency is reduced and, at the same time, error events can be minimized. Therefore, there is a need for efficient designs for UE-initiated reporting and/or beam switching and/or beam activation/deactivation for a content that can offer good trade-off between latency and reliability, in particular, when the UE-initiated beam management framework can include multiple report types (or report quantities), or/and multiple event types when a report types can be associated with an event (e.g. for beam report, the event can be beam failure, and for CSI, the event can be user throughput degradation or increasing retransmission rate).

The present disclosure provides various aspects and detailed design examples on the UE-initiated beam management framework including UE-initiated/triggered beam/CSI reporting and/or UE-initiated/triggered beam switching and/or UE-initiated/triggered beam activation/deactivation/sub-selection. To better support/enable the UE-initiated and the event-based beam operations, this disclosure presents example embodiments on means and/or procedures of transmitting the UE-initiated report(s) along with its indicator(s) via various uplink channels, and configuring and determining measurement RS resource(s) for the UE-initiated beam operations.

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The UE could send to the network (e.g., the network 130) the UE-initiated (UEI)/UE-triggered report of a (report-)type (A), (B) and/or (C) according to one or more of:
Fixed rule(s) in system specification(s): for example, the UE could send to the network a UEI report of a (report-)type (A), or a (report-)type (B), or a (report-)type (C), or a (report-)type (A) followed by a (report-)type (B).
Network's configuration(s)/indication(s), e.g., via higher layer RRC signaling(s)/parameter(s) and/or MAC CE command(s) and/or dynamic downlink control information (DCI) based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report of a (report-)type (A), ‘01’ indicating a UEI report of a (report-)type (B), ‘10’ indicating a UEI report of a (report-)type (C), and ‘11’ indicating a UEI report of a (report-)type (A) followed by a (report-)type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g. NW/gNB (e.g., the BS 102) or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ, Jᵢ)}, where Iᵢ is an beam (source RS) indicator (e.g. CSI-RS resource indicator (CRI), SSB resource indicator (SSBRI)) and Jᵢ is a beam metric (e.g. L1-reference signal received power (RSRP)/L1-signal-to-interference-plus-noise ratio (SINR)).
In one example, the content includes CSI-related quantity/quantities. For example, at least one of rank indicator (RI), precoding matrix indicator (PMI), channel quality indicator (CQI), CQI report interval (CRI), layer index (LI).
In one example, the content includes time-domain channel property (TDCP)-related quantity/quantities. For example, an indicator about the Doppler profile (e.g. Doppler spread or Doppler shift, relative Doppler spreads, or relative Doppler shifts), or an indicator about the auto-correlation profiles (e.g. (auto-)correlation values corresponding to a few dominant lags/delays).
In one example, the content includes other (e.g. non-beam, non-CSI, non-TDCP) quantity/quantities.
In one example, quantity/quantities comprises a selector/indicator indicating selection of one (or >1) of either
   beam (TCI state) TCI states (e.g. DL TCI state, UL TCI state, or unified (joint) DL/UL TCI state), or
   panel(s) (e.g. UE panels for DL reception or/and UL transmission), or
   antenna(e) (e.g. UE antennae for DL reception or/and UL transmission), or
   antenna port(s) (e.g. UE antenna ports for DL reception or/and UL transmission).
In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception or/and UL transmission).
In one example, the content includes beam-related quantity/quantities (examples herein) and at least one other quantity/quantities (examples herein).
In one example, the content includes CSI-related quantity/quantities (examples herein) and at least one other quantity/quantities (examples herein).
In one example, the content includes TDCP-related quantity/quantities (examples herein) and at least one other quantity/quantities (examples herein).
In one example, the content includes beam-related quantity/quantities (examples herein) and CSI-related quantity/quantities (examples herein).
In one example, the content includes beam-related quantity/quantities (examples herein) and TDCP-related quantity/quantities (examples herein).
In one example, the content includes TDCP-related quantity/quantities (examples herein) and CSI-related quantity/quantities (examples herein).

In one example, the report is targeting a physical layer (L1) communication (e.g. L1 DL/UL, or L1 SL), i.e. such reporting is to enable fast/reliable DL/UL or SL transmission/reception.

In one example, the link/channel between the target entity and the UE is a Uu interface (i.e. DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e. without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g. beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| Event type | Type | Trigger/pre-notification message | Content |
| 0: beam | (A) | Yes (e.g. beam-related event) | No |
| | (B) | No | Yes |
| | (C) | Yes (e.g. beam-related event) | Yes |
| 1: CSI | (A) | Yes (e.g. CSI-related event) | No |
| | (B) | No | Yes |
| | (C) | Yes (e.g. CSI-related event) | Yes |
| 2: TDCP | (A) | Yes (e.g. TDCP-related event) | No |
| | (B) | No | Yes |
| | (C) | Yes (e.g. TDCP-related event) | Yes |
| 3: non-CSI/beam/ | (A) | Yes (e.g. non-CSI-related event) | No |
| TDCP | (B) | No | Yes |
| | (C) | Yes (e.g. non-CSI-related event) | Yes |
| 4. other (content- | (A) | Yes (no need for content) | No |
| free/less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g. beam-related event), content- | No |
| | specific or event-specific | |
| 1 | No | Beam |
| 2 | Yes (e.g. beam-related event) | Beam |
| 3 | Yes (e.g. CSI-related event) | No |
| 4 | No | CSI |
| 5 | Yes (e.g. CSI-related event) | CSI |
| 6 | Yes (e.g. TDCP-related event) | No |
| 7 | No | TDCP |
| 8 | Yes (e.g. TDCP-related event) | TDCP |
| 9 | Yes (e.g. non-CSI-related event) | No |
| 10 | No | Non-CSI |
| 11 | Yes (e.g. non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for anew or updated report (e.g. beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g. CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.
For another example, the hint (or purpose of the PN message/trigger as specified herein in the present disclosure) is about beam/CSI parameters. For example, the parameter can be codebook type (e.g. from Type I to Type II or vice versa), or rank restriction (e.g. from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (cyclic delay diversity (CDD), cycling, space frequency block code (SFBC)), reciprocity (NCB, or non-PMI-feedback), or based on partial CSI (e.g. CRI-i1 or CRI-i1-CQI or LI-CRI-i1 or LI-CRI-i1-CQI), or based on single TRP to multi-TRP switch (or vice versa).
For another example, the hint (or purpose of the PN message/trigger as specified herein in the present disclosure) is about transmission parameters, e.g. modulation and coding scheme (MCS), or number of CWs.
For another example, when there is no pre-notification message/trigger associated with a content, i.e., the report-type is (B), the content can be transmitted using UL resource(s) configured (e.g. configured-grant physical uplink shared channel (PUSCH)), or reserved for the UE-initiated report, or via a random access channel (RACH) procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating that the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, uplink control information UCI and etc.

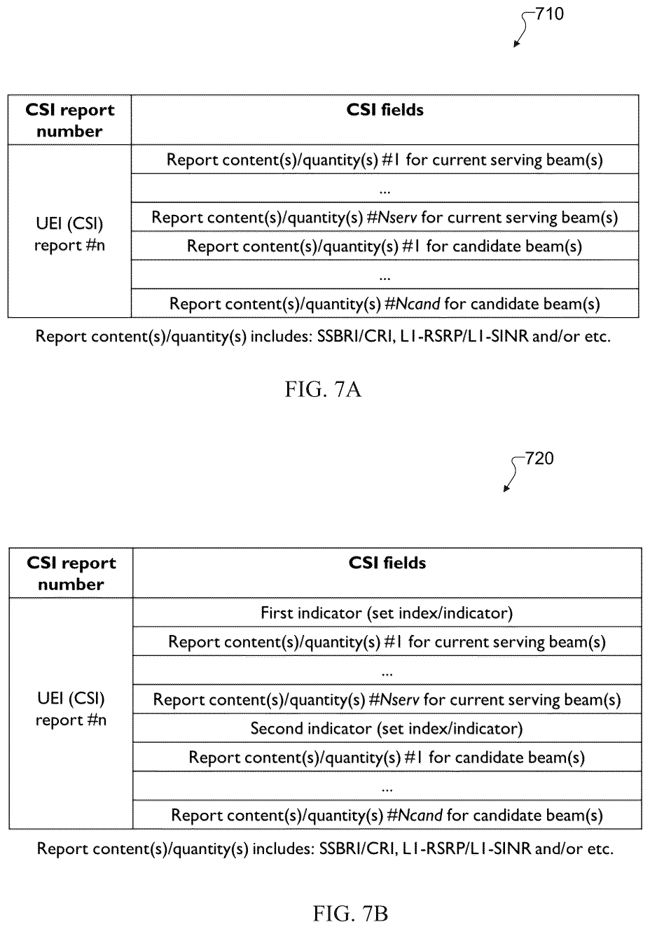

FIGS. 7A and 7B illustrate examples of report contents and formats 710 and 720 according to embodiments of the present disclosure. For example, report contents and formats 710 and 720 can be reported by any of the UEs 111-116 of FIG. 1. This example is for illustration only and other embodiments can be used without departing from the scope of the present disclosure.

In one embodiment, the UEI report could comprise (1) report content(s)/quantity(s) including resource indicators including SSBRI(s) and/or CRI(s) and the corresponding beam metric(s) including L1-RSRP(s)/L1-SINR(s) for current serving beam(s) only, (2) report content(s)/quantity(s) including resource indicators including SSBRI(s) and/or CSI(s) and the corresponding beam metric(s) including L1-RSRP(s)/L1-SINR(s) for candidate beam(s) only, and/or (3) report quantity(s)/content(s) including resource indicators including SSBRI(s) and/or CSI(s) and the corresponding beam metric(s) including L1-RSRP(s)/L1-SINR(s) for both current serving beam(s) and candidate beam(s).
For example, the UE could be provided/indicated/configured by the network, e.g., via higher layer RRC signaling(s)/parameter(s) and/or MAC CE command(s) and/or dynamic DCI based L1 signaling(s)—according to or based on a corresponding UE's capability or capability signaling, whether or not the UEI report should or could comprise (1), (2) and/or (3) as described herein; for instance, when/if a higher layer RRC signaling/parameter denoted by ‘servBeamInclusion’ is provided or configured, the UEI report could or should comprise (1) and/or (3); otherwise, the UEI report could or should comprise (2). Alternatively, when/if a higher layer RRC signaling/parameter, e.g., denoted by ueiReportContent is set to ‘servBeamOnly’, the UEI report could or should comprise (1), when/if the higher layer RRC signaling/parameter ueiReportContent is set to ‘candBeamOnly’, the UEI report could or should comprise (2), and/or when/if the higher layer RRC signaling/parameter ueiReportContent is set to ‘bothServAndCandBeam’, the UEI report could or should comprise (3). In this case, for (3), i.e., when/if the UE is configured to send a UEI report comprising report quantity(s)/content(s)—including resource indicator(s) such as SSBRI(s)/CRI(s) and/or beam metric(s) such as L1-RSRP(s)/L1-SINR(s)—for both the current serving beam(s) and the candidate beam(s), the UE could be further provided/indicated/configured by the network, e.g., via higher layer RRC signaling(s)/parameter(s) and/or MAC CE command(s) and/or dynamic DCI based L1 signaling(s)—according to or based on a corresponding UE's capability or capability signaling, the position(s)/ordering(s)/CSI report number(s)/CSI report index(es)/CSI report field(s) of the report content(s)/quantity(s) for the current serving beam(s) and/or the report content(s)/quantity(s) for the candidate beam(s) in the UEI report(s).
For another example, the UE could autonomously determine, select or decide whether or not the UEI report should or could comprise (1), (2) and/or (3) as described herein, and indicate to the network, e.g., in/by part of the UEI report including the PN message, their determination or selection or decision.
   In one example, the UE (e.g., the UE 116) could send to the network a/the PN message to indicate to the network whether or not the UEI report comprises (1), (2) and/or (3) as described herein. For instance, the PN message could be or could comprise a one-bit indicator; when/if the one-bit indicator is set to ‘0’ (or ‘1’), the UEI report comprises (1) and/or (3); otherwise, the UEI report comprises (2). Alternatively, the PN message could be or could comprise a multi-bit indicator (e.g., a two-bit indicator); when/if the two-bit indicator is set to ‘00’ (‘01’, ‘10’ or ‘11’), the UEI report comprise (1), when/if the two-bit indicator is set to ‘01’ (‘00’, ‘10’ or ‘11’), the UEI report comprises (2), and/or when/if the two-bit indicator is set to ‘10’ or ‘11’ (‘00’ or ‘01’), the UEI report comprises (3).
   In another example, the PN message could be or could comprise a bitmap with each bit position or entry in the bitmap corresponding/associated to a report content/quantity (such as a resource indicator SSBRI/CRI and/or a beam metric L1-RSRP/L1-SINR) in the UEI report. In this case, when/if a bit position/entry of the bitmap is set to ‘0’ (or ‘1’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to current serving beam(s), and/or when/if a bit position/entry of the bitmap is set to ‘1’ (or ‘0’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to candidate beam(s).
   In another example, each of the report content(s)/quantity(s) including a resource indicator such as a SSBRI/CRI or a beam metric such as a L1-RSRP/L1-SINR in a UEI report could be associated with an indicator provided in the same UEI report. In this case, the indicator could be a one-bit indicator; when/if the one-bit indicator is set to ‘0’ (or ‘1’), the resource indicator (including SSBRI and/or CRI) and/or the beam metric (including L1-RSRP and/or L1-SINR) associated/corresponding to the one-bit indicator could correspond to a current serving beam, and/or when/if the one-bit indicator is set to ‘1’ (or ‘0’), the resource indicator (including SSBRI and/or CRI) and/or the beam metric (including L1-RSRP and/or L1-SINR) associated/corresponding to the one-bit indicator could correspond to a candidate beam.
   In another example, each of the report content(s)/quantity(s) including a resource indicator such as a SSBRI/CRI or a beam metric such as a L1-RSRP/L1-SINR in a UEI report could be associated with an on/off indicator provided in the same UEI report. In this case, when/if the indicator is on or present in the UEI report or set to ‘on’, the resource indicator (including SSBRI and/or CRI) and/or the beam metric (including L1-RSRP and/or L1-SINR) associated/corresponding to the indicator could correspond to a current serving beam, and/or when/if the indicator is off or absent from the UEI report or set to ‘off’, the resource indicator (including SSBRI and/or CRI) and/or the beam metric (including L1-RSRP and/or L1-SINR) associated/corresponding to the indicator could correspond to a candidate beam.
   In another example, for (3), position(s)/ordering(s)/CSI report number(s)/CSI report index(es)/CSI report field(s) of the report content(s)/quantity(s) including resource indicator(s) such as SSBRI(s)/CRI(s) and/or beam metric(s) such as L1-RSRP(s)/L1-SINR(s) corresponding to current serving beam(s) and/or candidate beam(s) in the UEI report(s) could be fixed/predetermined/predefined. For instance, denote the number of the report content(s)/quantity(s) including resource indicator(s) such as SSBRI(s)/CRI(s) and/or beam metric(s) such as L1-RSRP(s)/L1-SINR(s) corresponding to current serving beam(s) by Nserv, the first (or last) Nserv position(s)/ordering(s)/CSI report number(s)/CSI report index(es)/CSI report field(s) in a/the UEI report could be used to carry or convey the report content(s)/quantity(s) for the current serving beam(s), and the rest of the position(s)/ordering(s)/CSI report number(s)/CSI report index(es)/CSI report field(s) in the same UEI report could be used to carry or convey the report content(s)/quantity(s) for the candidate beam(s). Alternatively, denote the number of the report content(s)/quantity(s) including resource indicator(s) such as SSBRI(s)/CRI(s) and/or beam metric(s) such as L1-RSRP(s)/L1-SINR(s) corresponding to candidate beam(s) by Ncand, the first (or last) Ncand position(s)/ordering(s)/CSI report number(s)/CSI report index(es)/CSI report field(s) in a/the UEI report could be used to carry or convey the report content(s)/quantity(s) for the candidate beam(s), and the rest of the position(s)/ordering(s)/CSI report number(s)/CSI report index(es)/CSI report field(s) in the same UEI report could be used to carry or convey the report content(s)/quantity(s) for the serving beam(s). One conceptual example characterizing the UEI reporting format and contents described herein in the present disclosure is presented in FIG. 7A.
   In another example, for (3), a first indicator and/or a second indicator could be provided, reported, sent, comprised, included, contained or transmitted in a/the UEI report as specified herein in the present disclosure. For this design example, the first indicator could be specific/associated/corresponding to or could be used to indicate a serving beam(s) RS set and/or information related to report content(s)/quantity(s) including resource indicator(s) such as SSBRI(s)/CRI(s) and/or beam metric(s) such as L1-RSRP(s)/L1-SINR(s) for the current serving beam(s) according to those specified herein in the present disclosure, and/or the second indicator could be specific/associated/corresponding to or could be used to indicate a candidate beam(s) RS set and/or information related to report content(s)/quantity(s) including resource indicator(s) such as SSBRI(s)/CRI(s) and/or beam metric(s) such as L1-RSRP(s)/L1-SINR(s) for one or more candidate beams according to those specified herein in the present disclosure. In particular, the first indicator could correspond to a set index/indicator for a serving beam(s) RS set denoted by so according to those specified herein in the present disclosure—e.g., the set index/indicator for the serving beam(s) RS set, and therefore, the first indicator, could be ‘0’ (or ‘1’ or ‘2’); optionally or alternatively, the first indicator could correspond to a one-bit indicator (e.g., a one-bit set index/indicator) with ‘0’ (or ‘1’ or ‘2’) corresponding to/indicating the serving beam(s) RS set and/or information related to report content(s)/quantity(s) including resource indicator(s) such as SSBRI(s)/CRI(s) and/or beam metric(s) such as L1-RSRP(s)/L1-SINR(s) for the current serving beam(s) according to those specified herein in the present disclosure. Furthermore, the second indicator could correspond to a set index/indicator for a candidate beam(s) RS set denoted by s̅₁ according to those specified herein in the present disclosure—e.g., the set index/indicator for the candidate beam(s) RS set, and therefore, the second indicator, could be ‘1’ (or ‘0’ or ‘2’); optionally or alternatively, the second indicator could correspond to a one-bit indicator (e.g., a one-bit set index/indicator) with ‘1’ (or ‘0’ or ‘2’) corresponding to/indicating the candidate beam(s) RS set and/or information related to report content(s)/quantity(s) including resource indicator(s) such as SSBRI(s)/CRI(s) and/or beam metric(s) such as L1-RSRP(s)/L1-SINR(s) for the candidate beam(s) according to those specified herein in the present disclosure. Denote the number of the report content(s)/quantity(s) including resource indicator(s) such as SSBRI(s)/CRI(s) and/or beam metric(s) such as L1-RSRP(s)/L1-SINR(s) corresponding to current serving beam(s) in a/the UEI report by Nserv, the first Nserv CSI fields in the UEI report following the CSI field that provides, carries or conveys the first indicator could be used to provide, carry or convey the Nserv report content(s)/quantity(s) specific to/for the current serving beam(s). In addition, denote the number of the report content(s)/quantity(s) including resource indicator(s) such as SSBRI(s)/CRI(s) and/or beam metric(s) such as L1-RSRP(s)/L1-SINR(s) corresponding to candidate beam(s) in a/the UEI report by Ncand, the first Ncand CSI fields in the UEI report following the CSI field that provides, carries or conveys the second indicator could be used to provide, carry or convey the Ncand report content(s)/quantity(s) specific to/for the candidate beam(s). The CSI field that provides, carries or conveys the first indicator in a/the UEI report, and/or the CSI field that provides, carries or conveys the second indicator in a/the UEI report, could be fixed—e.g., the CSI field that provides, carries or conveys the first (or second) indicator could correspond to the first (or 1^{st}) CSI field in a/the UEI report, and/or the CSI field that provides, carries or conveys the second (or first) indicator could correspond the first (or 1^{st}) CSI field that follows or is after the last CSI field that provides, carries or conveys the report content(s)/quantity(s) including resource indicator(s) such as SSBRI(s)/CRI(s) and/or beam metric(s) such as L1-RSRP(s)/L1-SINR(s) corresponding to the current serving (or candidate) beam(s)—in FIG. 7B, a conceptual example capturing the UEI reporting format and contents according to those disclosed in the present disclosure is provided. Furthermore, the CSI field that provides, carries or conveys the first indicator in a/the UEI report, and/or the CSI field that provides, carries or conveys the second indicator in a/the UEI report, could be determined according to/based on (i) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (ii) UE's autonomous determination/selection, which could be further sent to the network via various UL channels/signals including PUCCH, PUSCH, PRACH, and/or etc.
   In another example, for (3), each of the report contents/quantities (such as resource indicators SSBRIs/CRIs and/or beam metrics L1-RSRPs/L1-SINRs) in a UEI report could be associated/corresponding/specific to an indicator, which could be conveyed, provided, indicated, contained, included or comprised in the (same) UEI report. For example, the indicator could correspond to a set index/indicator for a serving beam(s) RS set denoted by go according to those specified herein in the present disclosure or a candidate beam(s) RS set denoted by s̅₁ according to those specified herein in the present disclosure—e.g., the indicator (or equivalently, the set index/indicator) could be ‘0’ (or ‘1’ or ‘2’) for the serving beam(s) RS set, and ‘1’ (or ‘0’ or ‘2’) for the candidate beam(s) RS set. For another example, the indicator could correspond to a one-bit indicator with ‘0’ (or ‘1’ or ‘2’) corresponding to/indicating the serving beam(s) RS set and/or information related to current serving beam(s), and ‘1’ (or ‘0’ or ‘2’) corresponding to/indicating the candidate beam(s) RS set and/or information related to candidate beam(s). In this case, when/if an indicator associated/corresponding/specific to a report content/quantity as specified/defined herein in the present disclosure in a UEI report is set to ‘0’ (or ‘1’ or ‘2’), the report content/quantity could be associated/corresponding/specific to the current serving beam(s), and when/if an indicator associated/corresponding/specific to a report content/quantity as specified/defined herein in the present disclosure in a UEI report is set to ‘1’ (or ‘0’ or ‘2’), the report content/quantity could be associated/corresponding/specific to the candidate beam(s).
   In another example, the UEI report could comprise, include, provide, contain or indicate a bitmap with each bit position or entry in the bitmap corresponding/associated to a report content/quantity (such as a resource indicator SSBRI/CRI and/or a beam metric L1-RSRP/L1-SINR) in the UEI report. In this case, when/if a bit position/entry of the bitmap is set to ‘0’ (or ‘1’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to current serving beam(s), and/or when/if a bit position/entry of the bitmap is set to ‘1’ (or ‘0’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to candidate beam(s).
   In another example, a UE could be provided/indicated/configured by the network (e.g., the network 130), e.g., via higher layer RRC signaling(s)/parameter(s) and/or MAC CE command(s) and/or dynamic DCI based L1 signaling(s)—according to or based on a UE's capability or capability signaling, a first (RSRP/SINR) threshold. In this case, when/if a beam metric such as a L1-RSRP or a L1-SINR reported in the UEI report is below (or beyond) the first threshold, the report content(s)/quantity(s) including a resource indicator such as a SSBRI or a CRI associated/corresponding to the beam metric could be or could correspond to a serving beam. Optionally, a UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, a second (RSRP/SINR) threshold. In this case, when/if a beam metric such as a L1-RSRP or a L1-SINR reported in the UEI report is beyond (or below) the second threshold, the report content(s)/quantity(s) including a resource indicator such as a SSBRI or a CRI associated/corresponding to the beam metric could be or could correspond to a candidate beam.

In the design examples specified/described herein in the present disclosure, the value(s) of Nserv and/or Ncand could be determined according to/based on (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). For instance, the UE could send or transmit PN message(s) to indicate the value(s) of Nserv and/or Ncand, and/or to indicate information related to the value(s) of Nserv and/or Ncand, wherein the PN message(s) could be in part 1 of a two-part UEI report (or a two-part UCI). Optionally, according to those specified herein in the present disclosure, a UEI report could comprise a mixture of both CRI(s) and SSBRI(s). For this case, the UE could indicate to the network, e.g., via/in part of the UEI report—for instance, via/by/in the PN message wherein the PN message could be in part 1 of a two-part UEI report (or a two-part UCI), the number(s)/value(s)/quantity(s) of the CRI(s) and/or SSBRI(s) reported in the same UEI report. In addition, one or more of the resource indicators reported in the UEI report could be associated or corresponding or specific to an indicator (provided, indicated, contained, included or comprised in the same UEI report). The indicator(s) could indicate whether the resource indicator(s) associated or corresponding or specific to the indicator(s) is CRI(s) or SSBRI(s). For instance, the indicator(s) could be one-bit indicator(s), and when/if an indicator is set to ‘0’ (or ‘1’), the resource indicator(s) associated or corresponding or specific to the indicator in a UEI report could correspond to a SSBRI, and when/if an indicator is set to ‘1’ (or ‘0’), the resource indicator(s) associated or corresponding or specific to the indicator in the UEI report could correspond to a CRI. Furthermore, a UEI report could also comprise a mixture of both L1-RSRP(s) and L1-SINR(s). For this case, the UE could indicate to the network, e.g., via/in part of the UEI report—for instance, via/by/in the PN message wherein the PN message could be in part 1 of a two-part UEI report (or a two-part UCI), the number(s)/value(s)/quantity(s) of the L1-RSRP(s) and/or L1-SINR(s) reported in the same UEI report. In addition, one or more of the radio link/beam quality(s) or metric(s) reported in the UEI report could be associated or corresponding or specific to an indicator (provided, indicated, contained, included or comprised in the same UEI report). The indicator(s) could indicate whether the radio link/beam quality(s)/metric(s) associated or corresponding or specific to the indicator(s) is L1-RSRP(s) or L1-SINR(s). For instance, the indicator(s) could be one-bit indicator(s), and when/if an indicator is set to ‘0’ (or ‘1’), the radio link/beam quality(s)/metric(s) associated or corresponding or specific to the indicator in a UEI report could correspond to a L1-RSRP, and when/if an indicator is set to ‘1’ (or ‘0’), the radio link/beam quality(s)/metric(s) associated or corresponding or specific to the indicator in the UEI report could correspond to a L1-SINR.

In one example, the UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, whether or not differential RSRP/SINR reporting is enabled for a UEI report comprising (1), (2) and/or (3) as described herein in the present disclosure. For example, when/if a higher layer parameter diffUeiReporting is provided or configured or set to ‘enabled’, the differential L1-RSRP/L1-SINR based reporting could be enabled/used, where a reference L1-RSRP/L1-SINR value could be quantized to a 7-bit value in the range [−140, −44] dBm for differential RSRP reporting/[−23, 40] dB for differential SINR reporting with 1 dB step size for differential RSRP reporting/0.5 dB step size for differential SINR reporting, and the differential L1-RSRP/L1-SINR could be quantized to a 4-bit value. The differential L1-RSRP/L1-SINR value could be computed with 2 dB step size for differential RSRP reporting/1 dB step size for differential SINR reporting with a reference to the reference L1-RSRP/L1-SINR value which is part of the same UEI report or in a different but linked/associated UEI report. In this case, the reference L1-RSRP/L1-SINR value could correspond to the largest measured L1-RSRP/L1-SINR value or the largest measured L1-RSRP/SINR value of a current serving beam or the measured L1-RSRP/L1-SINR value of the serving beam. Otherwise, the differential L1-RSRP/L1-SINR based reporting could be disabled or may not be used, where the measured L1-RSRP/L1-SINR value(s) could be quantized to a 7-bit value in the range [−140, −44] dBm with 1 dB step size.

In one example, whether or not differential RSRP/SINR reporting is enabled for a UEI report comprising (1), (2) and/or (3) as described herein in the present disclosure could depend on the number of report content(s)/quantity(s)—including resource indicator(s) such as SSBRI(s)/CRI(s) and/or beam metric(s) such as L1-RSRP(s)/L1-SINR(s)—for the current serving beam(s), and/or the number of report content(s)/quantity(s)—including resource indicator(s) such as SSBRI(s)/CRI(s) and/or beam metric(s) such as L1-RSRP(s)/L1-SINR(s)—for the candidate beam(s). For example, when/if the number of report content(s)/quantity(s)—including resource indicator(s) such as SSBRI(s)/CRI(s) and/or beam metric(s) such as L1-RSRP(s)/L1-SINR(s)—for the current serving beam(s), and/or the number of report content(s)/quantity(s)—including resource indicator(s) such as SSBRI(s)/CRI(s) and/or beam metric(s) such as L1-RSRP(s)/L1-SINR(s)—for the candidate beam(s), is greater than or equal to 1, the differential L1-RSRP/L1-SINR based reporting could be enabled/used, where a reference L1-RSRP/L1-SINR value could be quantized to a 7-bit value in the range [−140, −44] dBm with 1 dB step size, and the differential L1-RSRP/L1-SINR could be quantized to a 4-bit value. The differential L1-RSRP/L1-SINR value could be computed with 2 dB step size with a reference to the reference L1-RSRP/L1-SINR value which is part of the same UEI report or in a different but linked/associated UEI report. In this case, the reference L1-RSRP/L1-SINR value could correspond to the largest measured L1-RSRP/L1-SINR value or the largest measured L1-RSRP/SINR value of a current serving beam or the measured L1-RSRP/L1-SINR value of the serving beam in the same/current UEI report or a different UEI report associated/linked to the current UEI report, based on network's configuration(s)/indication(s) via higher layer RRC signaling(s)/parameter(s) and/or MAC CE command(s) and/or dynamic DCI based L1 signaling(s) according to a UE's capability or capability signaling and/or UE's autonomous determination, which could be further sent/indicated to the network in/by part of the UEI report(s)—e.g., via the PN message—and/or other UL channels/signals. Otherwise, the differential L1-RSRP/L1-SINR based reporting could be disabled or may not be used, where the measured L1-RSRP/L1-SINR value(s) could be quantized to a 7-bit value in the range [−140, −44] dBm with 1 dB step size. The UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, the number of report content(s)/quantity(s)—including resource indicator(s) such as SSBRI(s)/CRI(s) and/or beam metric(s) such as L1-RSRP(s)/L1-SINR(s)—for the current serving beam(s), and/or the number of report content(s)/quantity(s)—including resource indicator(s) such as SSBRI(s)/CRI(s) and/or beam metric(s) such as L1-RSRP(s)/L1-SINR(s)—for the candidate beam(s); alternatively, the UE could autonomous determine the number of report content(s)/quantity(s)—including resource indicator(s) such as SSBRI(s)/CRI(s) and/or beam metric(s) such as L1-RSRP(s)/L1-SINR(s)—for the current serving beam(s), and/or the number of report content(s)/quantity(s)—including resource indicator(s) such as SSBRI(s)/CRI(s) and/or beam metric(s) such as L1-RSRP(s)/L1-SINR(s)—for the candidate beam(s), and report their determined number(s)—e.g., by/in part of the UEI report and/or via the PN message—to the network.

In one example, for (1), i.e., when/if a UEI report could only comprise report content(s)/quantity(s) including resource indicator(s) such as SSBRI(s)/CRI(s) and beam metric(s) such as L1-RSRP(s)/L1-SINR(s) for the current serving beam(s), and/or when/if the differential RSRP/SINR based reporting is enabled/used according to those specified herein in the present disclosure, the reference L1-RSRP/L1-SINR value could correspond to one or more of the followings, based on network's configuration(s)/indication(s) via higher layer RRC signaling(s)/parameter(s) and/or MAC CE command(s) and/or dynamic DCI based L1 signaling(s) according to a UE's capability or capability signaling and/or UE's autonomous determination, which could be further sent/indicated to the network in/by part of the UEI report(s)—e.g., via the PN message—and/or other UL channels/signals:
the largest measured L1-RSRP/L1-SINR value in the same/current UEI report
the largest measured L1-RSRP/L1-SINR value in a different/previous/earlier UEI report
the largest measured L1-RSRP/L1-SINR value of a candidate beam in a different/previous/earlier UEI report
the measured L1-RSRP/L1-SINR value of the candidate beam in a different/previous/earlier UEI report where the different/previous/earlier UEI report could be the last UEI report sent prior to the current UEI report, or alternatively, the different/previous/earlier UEI report and the current UEI report could be associated/linked to each other, e.g., when/if a same value of an indicator/ID/index is respectively sent in the different/previous/earlier UEI report and the current UEI report. Furthermore, in this case, the UEI report could also comprise one or more RSRP/SINR values corresponding to or characterizing the difference(s) between the measured L1-RSRP/L1-SINR value(s) for the current serving beam(s) and the first threshold as specified herein in the present disclosure. For instance, if a measured L1-RSRP/L1-SINR value for a current serving beam is x dBm, and the first threshold is y dBm, the difference delta_serv=|x−y| dBm could be reported in the UEI report as a report content/quantity, and a corresponding one-bit sign indicator indicating either positive or negative of the difference could also be reported in the same UEI report. The value of delta_serv in the UEI report could be quantized to a A-bit value in the range [B, C] dBm with DdB step size, wherein the value(s) of A, B, C and/or D in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. Optionally, the UEI report could also comprise one or more RSRP/SINR values corresponding to or characterizing the difference(s) between the differential L1-RSRP/L1-SINR value(s), if reported, and a third threshold. For instance, if a differential L1-RSRP/L1-SINR value is x dBm, and the third threshold is y dBm, the difference delta_diff=|x−y| dBm could be reported in the UEI report as a report content/quantity, and a corresponding one-bit sign indicator indicating either positive or negative of the difference could also be reported in the same UEI report. The value of delta_diff in the UEI report could be quantized to a A-bit value in the range [B, C] dBm with DdB step size, wherein the value(s) of A, B, C and/or D in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. A UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, the third (RSRP/SINR) threshold.

In another example, for (2), i.e., when/if a UEI report could only comprise report content(s)/quantity(s) including resource indicator(s) such as SSBRI(s)/CRI(s) and beam metric(s) such as L1-RSRP(s)/L1-SINR(s) for the candidate beam(s), and/or when/if the differential RSRP/SINR based reporting is enabled/used according to those specified herein in the present disclosure, the reference L1-RSRP/L1-SINR value could correspond to one or more of the followings, based on network's configuration(s)/indication(s) via higher layer RRC signaling(s)/parameter(s) and/or MAC CE command(s) and/or dynamic DCI based L1 signaling(s) according to a UE's capability or capability signaling and/or UE's autonomous determination, which could be further sent/indicated to the network in/by part of the UEI report(s)—e.g., via the PN message—and/or other UL channels/signals:
the largest measured L1-RSRP/L1-SINR value in the same/current UEI report
the largest measured L1-RSRP/L1-SINR value in a different/previous/earlier UEI report
the largest measured L1-RSRP/L1-SINR value of a serving beam in a different/previous/earlier UEI report
the measured L1-RSRP/L1-SINR value of the serving beam in a different/previous/earlier UEI report where the different/previous/earlier UEI report could be the last UEI report sent prior to the current UEI report, or alternatively, the different/previous/earlier UEI report and the current UEI report could be associated/linked to each other, e.g., when/if a same value of indicator/ID/index is respectively sent in the different/previous/earlier UEI report and the current UEI report. Furthermore, in this case, the UEI report could also comprise one or more RSRP/SINR values corresponding to or characterizing the difference(s) between the measured L1-RSRP/L1-SINR value(s) for the candidate beam(s) and the second threshold as specified herein in the present disclosure. For instance, if a measured L1-RSRP/L1-SINR value for a candidate beam is x′dBm, and the second threshold is y′dBm, the difference delta_cand=|x′−y′| dBm could be reported in the UEI report as a report content/quantity, and a corresponding one-bit sign indicator indicating either positive or negative of the difference could also be reported in the same UEI report. The value of delta_cand in the UEI report could be quantized to aA′-bit value in the range [B′, C′] dBm with D′dB step size, wherein the value(s) of A′, B′, C′ and/or D′ in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. Optionally, the UEI report could also comprise one or more RSRP/SINR values corresponding to or characterizing the difference(s) between the differential L1-RSRP/L1-SINR value(s), if reported, and a fourth threshold. For instance, if a differential L1-RSRP/L1-SINR value is x′ dBm, and the fourth threshold is y′dBm, the difference delta_diff′=x′−y′| dBm could be reported in the UEI report as a report content/quantity, and a corresponding one-bit sign indicator indicating either positive or negative of the difference could also be reported in the same UEI report. The value of delta_diff′ in the UEI report could be quantized to aA′-bit value in the range [B′, C′] dBm with D′dB step size, wherein the value(s) of A′, B′, C′ and/or D′ in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. A UE (e.g., the UE 116) could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, the fourth (RSRP/SINR) threshold.

In another example, for (3), i.e., when/if a UEI report could comprise report content(s)/quantity(s) including resource indicator(s) such as SSBRI(s)/CRI(s) and beam metric(s) such as L1-RSRP(s)/L1-SINR(s) for the current serving beam(s) and report content(s)/quantity(s) including resource indicator(s) such as SSBRI(s)/CRI(s) and beam metric(s) such as L1-RSRP(s)/L1-SINR(s) for the candidate beam(s), and/or when/if the differential RSRP/SINR based reporting is enabled/used, e.g., for the serving beam(s) in the current UEI report, according to those specified herein in the present disclosure, the reference L1-RSRP/L1-SINR value for the current serving beam(s) in the current UEI report could correspond to one or more of the followings, based on network's configuration(s)/indication(s) via higher layer RRC signaling(s)/parameter(s) and/or MAC CE command(s) and/or dynamic DCI based L1 signaling(s) according to a UE's capability or capability signaling and/or UE's autonomous determination, which could be further sent/indicated to the network in/by part of the UEI report(s)—e.g., via the PN message—and/or other UL channels/signals:
the largest measured L1-RSRP/L1-SINR value in the same/current UEI report
the largest measured L1-RSRP/L1-SINR value in a different/previous/earlier UEI report
the largest measured L1-RSRP/L1-SINR value of a candidate beam in a different/previous/earlier UEI report
the measured L1-RSRP/L1-SINR value of the candidate beam in a different/previous/earlier UEI report
the largest measured L1-RSRP/L1-SINR value of a candidate beam in the same/current UEI report
the measured L1-RSRP/L1-SINR value of the candidate beam in the same/current UEI report where the different/previous/earlier UEI report could be the last UEI report sent prior to the current UEI report, or alternatively, the different/previous/earlier UEI report and the current UEI report could be associated/linked to each other, e.g., when/if a same value of an indicator/ID/index is respectively sent in the different/previous/earlier UEI report and the current UEI report. Furthermore, in this case, the UEI report could also comprise one or more RSRP/SINR values corresponding to or characterizing the difference(s) between the measured L1-RSRP/L1-SINR value(s) for the current serving beam(s) and the first threshold as specified herein in the present disclosure. For instance, if a measured L1-RSRP/L1-SINR value for a current serving beam is x dBm, and the first threshold is y dBm, the difference delta_serv=|x−y|dBm could be reported in the UEI report as a report content/quantity, and a corresponding one-bit sign indicator indicating either positive or negative of the difference could also be reported in the same UEI report. The value of delta_serv in the UEI report could be quantized to a A-bit value in the range [B, C] dBm with DdB step size, wherein the value(s) of A, B, C and/or D in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. Optionally, the UEI report could also comprise one or more RSRP/SINR values corresponding to or characterizing the difference(s) between the differential L1-RSRP/L1-SINR value(s) computed with respect to or regarding or for the current serving beam(s), if reported, and the third threshold as specified/described herein in the present disclosure. For instance, if a differential L1-RSRP/L1-SINR value computed with respect to or regarding or for a current serving beam is x dBm, and the third threshold is y dBm, the difference delta_diff=|x−y| dBm could be reported in the UEI report as a report content/quantity, and a corresponding one-bit sign indicator indicating either positive or negative of the difference could also be reported in the same UEI report. The value of delta_diff in the UEI report could be quantized to a A-bit value in the range [B, C] dBm with DdB step size, wherein the value(s) of A, B, C and/or D in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. In addition, when/if the differential RSRP/SINR based reporting, e.g., for the candidate beam(s) in the current UEI report, is enabled/used according to those specified herein in the present disclosure, the reference L1-RSRP/L1-SINR value for the candidate beam(s) in the current UEI report could correspond to one or more of the followings, based on network's configuration(s)/indication(s) via higher layer RRC signaling(s)/parameter(s) and/or MAC CE command(s) and/or dynamic DCI based L1 signaling(s) according to a UE's capability or capability signaling and/or UE's autonomous determination, which could be further sent/indicated to the network in/by part of the UEI report(s)—e.g., via the PN message—and/or other UL channels/signals:
the largest measured L1-RSRP/L1-SINR value in the same/current UEI report
the largest measured L1-RSRP/L1-SINR value in a different/previous/earlier UEI report
the largest measured L1-RSRP/L1-SINR value of a serving beam in a different/previous/earlier UEI report
the measured L1-RSRP/L1-SINR value of the serving beam in a different/previous/earlier UEI report
the largest measured L1-RSRP/L1-SINR value of a serving beam in the same/current UEI report
the measured L1-RSRP/L1-SINR value of the serving beam in the same/current UEI report where the different/previous/earlier UEI report could be the last UEI report sent prior to the current UEI report, or alternatively, the different/previous/earlier UEI report and the current UEI report could be associated/linked to each other, e.g., when/if a same value of indicator/ID/index is respectively sent in the different/previous/earlier UEI report and the current UEI report. Furthermore, in this case, the UEI report could also comprise one or more RSRP/SINR values corresponding to or characterizing the difference(s) between the measured L1-RSRP/L1-SINR value(s) for the candidate beam(s) and the second threshold as specified herein in the present disclosure. For instance, if a measured L1-RSRP/L1-SINR value for a candidate beam is x′dBm, and the second threshold is y′dBm, the difference delta_cand=|x′−y′| dBm could be reported in the UEI report as a report content/quantity, and a corresponding one-bit sign indicator indicating either positive or negative of the difference could also be reported in the same UEI report. The value of delta_cand in the UEI report could be quantized to aA′-bit value in the range [B′, C′] dBm with D′dB step size, wherein the value(s) of A′, B′, C′ and/or D′ in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling. Optionally, the UEI report could also comprise one or more RSRP/SINR values corresponding to or characterizing the difference(s) between the differential L1-RSRP/L1-SINR value(s) computed with respect to or regarding or for a candidate beam, if reported, and the fourth threshold. For instance, if a differential L1-RSRP/L1-SINR value computed with respect to or regarding or for a candidate beam is x′dBm, and the fourth threshold is y′dBm, the difference delta_diff=|x′−y′| dBm could be reported in the UEI report as a report content/quantity, and a corresponding one-bit sign indicator indicating either positive or negative of the difference could also be reported in the same UEI report. The value of delta_diff in the UEI report could be quantized to aA′-bit value in the range [B′, C′] dBm with D′dB step size, wherein the value(s) of A′, B′, C′ and/or D′ in this example could be fixed in system specifications (similar to those specified for the differential RSRP/SINR reporting) and/or configured/provided by the network, e.g., via higher layer RRC signaling/parameter and/or MAC CE command and/or dynamic DCI based L1 signaling, according to or based on a UE's capability or capability signaling.

For a first event, wherein the radio link or beam quality(s) of one or more current serving beams is below or less than or equal to a threshold-A (an instance for the first event), a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-A for the current serving beam(s), and/or information related to presence or absence of one or more of the report contents/quantities as described/specified herein in the present disclosure for the current serving beam(s). In this case, when a UE detects the first event, the UE could also identify or determine the one or more current serving beams with their associated/corresponding radio link or beam quality(s) including L1-RSRP(s) and/or L1-SINR(s) below or less than or equal to the threshold-A, wherein the identified or determined one or more current serving beams could be denoted by the current serving beam(s) that satisfies the condition of the first event or in general the beam(s) that satisfies the condition of a/the given event. Furthermore, a/the UEI report, e.g., for the first event, could comprise one or more of the following components for one or more first current serving beams with their associated/corresponding radio link/beam quality(s) less than or below or equal to the threshold-A according to those specified/defined herein in the present disclosure, wherein the one or more first current serving beams—denoted by the current serving beam(s) that satisfies the condition of the first event or in general the beam(s) that satisfies the condition of a/the given event—could comprise one or more (e.g., Ns) second current serving beams with their associated/corresponding radio link/beam quality(s) greater than or equal to or beyond a threshold-A′ or with their associated/corresponding radio link/beam quality(s) corresponding to the highest (or lowest) Ns radio link/beam quality(s) among the one or more first current serving beams as defined/specified herein in the present disclosure:
Component-1a: resource indicator(s) such as SSBRI(s)/CRI(s) for the one or more first current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more first current serving beams.
Component-1b: resource indicator(s) such as SSBRI(s)/CRI(s) for the one or more second current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more second current serving beams.
Component-1c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-1a for the one or more first current serving beams; differential RSRP/SINR reporting could be applied to Component-1c according to those specified herein in the present disclosure.
Component-1d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-1b for the one or more second current serving beams; differential RSRP/SINR reporting could be applied to Component-1d according to those specified herein in the present disclosure.
Component-1e: indicator(s) or bitmap(s) indicating the one or more first current serving beams—e.g., out of the current serving beams
Component-1f: indicator(s) or bitmap(s) indicating the one or more second current serving beams—e.g., out of the current serving beams or out of the first current serving beam(s)
Component-1g: a number of the one or more first current serving beams in the UEI report(s)
Component-1h: a number of the one or more second current serving beams in the UEI report(s)
Component-1i: indicator(s) indicating occurrence of the first event and/or an event index/ID associated/specific/corresponding to the first event
Component-1j: difference(s) between the beam metric(s) such as L1-RSRP(s)/L1-SINR(s) for the one or more first current serving beams and the threshold-A; For instance, if a (differential) L1-RSRP/L1-SINR value computed with respect to or regarding or for a first current serving beam is x dBm, and the threshold-A is y dBm, a difference delta_diff_A=|x−y|dBm could be reported in the UEI report as a report content/quantity, and a corresponding one-bit sign indicator indicating either positive or negative of the difference could also be reported in the same UEI report. Or, the difference delta_diff_A=(x−y) and/or (y−x) dBm could be reported in the UEI report as a report content/quantity. Optionally, the value of delta_diff_A could be quantized to a u-bit value with a v dB step size with respect to the threshold-A.
Component-1k: difference(s) between the beam metric(s) such as L1-RSRP(s)/L1-SINR(s) for the one or more second current serving beams and the threshold-A; For instance, if a (differential) L1-RSRP/L1-SINR value computed with respect to or regarding or for a second current serving beam is x′dBm, and the threshold-A is y dBm, a difference delta_diff_A′=|x′−y|dBm could be reported in the UEI report as a report content/quantity, and a corresponding one-bit sign indicator indicating either positive or negative of the difference could also be reported in the same UEI report. Or, the difference delta_diff_A′=(x′−y) and/or (y−x′) dBm could be reported in the UEI report as a report content/quantity.
Component-1l: indicator(s) indicating presence or absent of Component-1a in the UEI report(s); e.g., the indicator(s) could be a one-bit indicator with ‘1’ (or ‘0’) indicating presence and ‘0’ (or ‘1’) indicating absence of Component-1a in the UEI report(s). Optionally, the value of delta_diff_A′ could be quantized to a u-bit value with a v dB step size with respect to the threshold-A.
Component-1m: indicator(s) indicating presence or absent of Component-1b in the UEI report(s); e.g., the indicator(s) could be a one-bit indicator with ‘1’ (or ‘0’) indicating presence and ‘0’ (or ‘1’) indicating absence of Component-1b in the UEI report(s).
Component-1n: indicator(s) indicating presence or absent of Component-1c in the UEI report(s); e.g., the indicator(s) could be a one-bit indicator with ‘1’ (or ‘0’) indicating presence and ‘0’ (or ‘1’) indicating absence of Component-1c in the UEI report(s).
Component-1o: indicator(s) indicating presence or absent of Component-1d in the UEI report(s); e.g., the indicator(s) could be a one-bit indicator with ‘1’ (or ‘0’) indicating presence and ‘0’ (or ‘1’) indicating absence of Component-1d in the UEI report(s).
Component-1p: indicator(s) indicating presence or absence of Component-1j in the UEI report(s); e.g., the indicator(s) could be a one-bit indicator with ‘1’ (or ‘0’) indicating presence and ‘0’ (or ‘1’) indicating absence of Component-1j in the UEI report(s).
Component-1q: indicator(s) indicating presence or absence of Component-1k in the UEI report(s); e.g., the indicator(s) could be a one-bit indicator with ‘1’ (or ‘0’) indicating presence and ‘0’ (or ‘1’) indicating absence of Component-1k in the UEI report(s).

The value(s) of threshold-A, threshold-A′, Ns, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. In one example, Ns>1. In another example, Ns≥1.

In one example, a UE could send or transmit a first UEI report comprising one or more (or a subset) of Component-1a-Component-1q according to those specified herein in the present disclosure, and a second UEI report comprising one or more (or a subset) of Component-1a-Component-1q according to those specified herein in the present disclosure. The first and second UEI reports could be in two separate or different CSI reports (denoted by CSI-Reports) or reporting instances. In this case, the first and second UEI reports (and therefore, their corresponding CSI-Reports and/or reporting instances) could be correlated or associated to each other: for example, the first and second UEI reports as specified/defined herein in the present disclosure could comprise, contain, provide or include a/the same reporting (or event) ID/index; for another example, the first and second UEI reports could be sent/transmitted within a time window/period (e.g., in number of symbols/slots/etc.) according to (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For instance, a/the first UEI report transmitted or sent in a first CSI-Report or reporting instance could comprise at least Component-1a, a/the second UEI report transmitted or sent in a second CSI-Report or reporting instance (different from or other than the first CSI-Report or reporting instance) could comprise at least Component-1c, and the first UEI report is associated to the second UEI report such that they would contain, provide, comprise, include or indicate a same reporting (or event) ID.

In another example, a UE could send or transmit to the network, in a same CSI-Report/reporting instance, a UEI report comprising two parts (e.g., a two-part UCI), wherein part 1 of the UEI report (or UCI) could comprise one or more (or a subset) of Component-1a-Component-1q according to those specified herein in the present disclosure, and part 2 of the UEI report (or UCI) could comprise one or more (or a subset) of Component-1a-Component-1q according to those specified herein in the present disclosure. Furthermore, part 1 of the UEI report (or UCI) could be of fixed payload size and/or could indicate presence/absence of part 2 of the UEI report (or UCI)—e.g., part 1 of the UEI report (or UCI) could comprise, indicate or provide a one-bit indicator with ‘1’ (or ‘0’) indicating presence and ‘0’ (or ‘1’) indicating absence of part 2 of the UEI report (or UCI)—and/or payload size of the part 2 (if present). For example, part 1 of the UEI report (or UCI) could comprise at least Component-1i, and part 2 of the UEI report (or UCI) could comprise at least Component-1j. For another example, part 1 of the UEI report (or UCI) could comprise at least Component-1p, and part 2 of the UEI report (or UCI) could comprise at least Component-1j. For another example, part 1 of the UEI report (or UCI) could comprise at least Component-1i, and part 2 of the UEI report (or UCI) could comprise at least Component-1c. For another example, part 1 of the UEI report (or UCI) could comprise at least Component-1n, and part 2 of the UEI report (or UCI) could comprise at least Component-1c. For another example, part 1 of the UEI report (or UCI) could comprise at least Component-1c and/or Component-1j, and part 2 of the UEI report (or UCI) could be absent. For another example, part 1 of the UEI report (or UCI) could comprise at least Component-1i, and part 2 of the UEI report (or UCI) could be absent.

Whether the UE could separately send or transmit the first and second UEI reports in two separate CSI reports/CSI reporting instances according to those specified herein in the present disclosure or a joint UEI report comprising part 1 and/or part 2 according to those specified herein in the present disclosure could be determined according to (i) fixed rule(s) in system specifications or per RRC configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals through, e.g., a CSI/beam report and/or UE's capability signaling(s).

In another example, a UE could send or transmit, in a first CSI-Report or CSI reporting instance, a current UEI report providing, indicating or comprising an incremental or decremental value with respect to a previous radio link/beam quality or a previous quality metric for a (first/second) current serving beam as specified/defined herein in the present disclosure reported in a previous UEI report or derived/calculated from the report content(s)/quantity(s) reported in a previous UEI report, wherein the previous UEI report could be transmitted or sent in a second CSI-Report or CSI reporting instance. In this case, a current radio link/beam quality or a current quality metric for the same (first/second) current serving beam as specified/defined herein in the present disclosure could be determined, identified, obtained, calculated or derived from the incremental/decremental value reported in the current UEI report and the previous radio link/beam quality or the previous quality metric for the (first/second) current serving beam reported in the previous UEI report. For instance, a current UEI report could provide, indicate, comprise, contain or include a delta_p value (or an absolute |delta_p| value along with a one-bit sign indicator indicating positive or negative of the absolute |delta_p| value) with respect to a previous L1-RSRP value denoted by previous_p for a (first/second) current serving beam as specified/defined herein in the present disclosure reported in a previous UEI report or derived/calculated from the report content(s)/quantity(s) reported in a previous UEI report. In this case, a current L1-RSRP value denoted by current_p could correspond to or could be derived/calculated as current_p=previous_p+delta_p. Furthermore, the previous and current UEI reports (and therefore, their corresponding first and second CSI-Reports and/or reporting instances) could be correlated or associated to each other: for example, the previous and current UEI reports as specified/defined herein in the present disclosure could comprise, contain, provide or include a/the same reporting (or event) ID/index; for another example, the previous and current UEI reports could be sent/transmitted within a time window/period (e.g., in number of symbols/slots/etc.) according to (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In addition, whether a UEI report, transmitted or sent by a UE, could provide, indicate or comprise (1) an incremental or decremental value with respect to a previous UEI report according to or following those specified herein in the present disclosure or (2) one or more of Component-1a to Component-1q according to or following those specified herein in the present disclosure could be determined according to: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

For a second event, wherein the radio link or beam quality(s) of one or more candidate beams is beyond or greater than or equal to a threshold-B (an instance for the second event), a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-B for the candidate beam(s), and/or information related to presence or absence of one or more of the report contents/quantities as described/specified herein in the present disclosure for the candidate beam(s)—throughout the present disclosure, a candidate beam is equivalent to a candidate new beam or a new beam. In this case, when a UE detects the second event, the UE could also identify or determine the one or more candidate beams with their associated/corresponding radio link or beam quality(s) including L1-RSRP(s) and/or L1-SINR(s) beyond or greater than or equal to the threshold-B, wherein the identified or determined one or more candidate beams could be denoted by the candidate beam(s) that satisfies the condition of the second event or in general the beam(s) that satisfies the condition of a/the given event. Furthermore, a/the UEI report, e.g., for the second event, could comprise one or more of the following components for one or more first candidate beams with their associated/corresponding radio link/beam quality(s) greater than or beyond or equal to the threshold-B according to those specified/defined herein in the present disclosure, wherein the one or more first candidate beams—denoted by the candidate beam(s) that satisfies the condition of the second event or in general the beam(s) that satisfies the condition of a/the given event—could comprise one or more (e.g., Nc) second candidate beams with their associated/corresponding radio link/beam quality(s) greater than or equal to or beyond a threshold-B′ or with their associated/corresponding radio link/beam quality(s) corresponding to the highest (or lowest) Nc radio link/beam quality(s) among the one or more first candidate beams as defined/specified herein in the present disclosure:
Component-2a: resource indicator(s) such as SSBRI(s)/CRI(s) for the one or more first candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more first candidate beams.
Component-2b: resource indicator(s) such as SSBRI(s)/CRI(s) for the one or more second candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more second candidate beams.
Component-2c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-2a for the one or more first candidate beams; differential RSRP/SINR reporting could be applied to Component-2c according to those specified herein in the present disclosure.
Component-2d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-2b for the one or more second candidate beams; differential RSRP/SINR reporting could be applied to Component-2d according to those specified herein in the present disclosure.
Component-2e: indicator(s) or bitmap(s) indicating the one or more first candidate beams—e.g., out of the candidate beams
Component-2f: indicator(s) or bitmap(s) indicating the one or more second candidate beams—e.g., out of the candidate beams or out of the first candidate beam(s)
Component-2g: a number of the one or more first candidate beams in the UEI report(s)
Component-2h: a number of the one or more second candidate beams in the UEI report(s)
Component-2i: indicator(s) indicating occurrence of the second event and/or an event index/ID associated/specific/corresponding to the second event
Component-2j: difference(s) between the beam metric(s) such as L1-RSRP(s)/L1-SINR(s) for the one or more first candidate beams and the threshold-B; For instance, if a (differential) L1-RSRP/L1-SINR value computed with respect to or regarding or for a first candidate beam is x dBm, and the threshold-B is y dBm, a difference delta_diff_B=|x−y|dBm could be reported in the UEI report as a report content/quantity, and a corresponding one-bit sign indicator indicating either positive or negative of the difference could also be reported in the same UEI report. Or, the difference delta_diff_B=(x−y) and/or (y−x) dBm could be reported in the UEI report as a report content/quantity. Optionally, the value of delta_diff_B could be quantized to a u-bit value with a v dB step size with respect to the threshold-B.
Component-2k: difference(s) between the beam metric(s) such as L1-RSRP(s)/L1-SINR(s) for the one or more second candidate beams and the threshold-B; For instance, if a (differential) L1-RSRP/L1-SINR value computed with respect to or regarding or for a second candidate beam is x′dBm, and the threshold-B is y dBm, a difference delta_diff_B′=|x′−y|dBm could be reported in the UEI report as a report content/quantity, and a corresponding one-bit sign indicator indicating either positive or negative of the difference could also be reported in the same UEI report. Or, the difference delta_diff_B′=(x′−y) and/or (y−x′) dBm could be reported in the UEI report as a report content/quantity. Optionally, the value of delta_diff_B′ could be quantized to a u-bit value with a v dB step size with respect to the threshold-B.
Component-21: indicator(s) indicating presence or absent of Component-2a in the UEI report(s); e.g., the indicator(s) could be a one-bit indicator with ‘1’ (or ‘0’) indicating presence and ‘0’ (or ‘1’) indicating absence of Component-2a in the UEI report(s).
Component-2m: indicator(s) indicating presence or absent of Component-2b in the UEI report(s); e.g., the indicator(s) could be a one-bit indicator with ‘1’ (or ‘0’) indicating presence and ‘0’ (or ‘1’) indicating absence of Component-2b in the UEI report(s).
Component-2n: indicator(s) indicating presence or absent of Component-2c in the UEI report(s); e.g., the indicator(s) could be a one-bit indicator with ‘1’ (or ‘0’) indicating presence and ‘0’ (or ‘1’) indicating absence of Component-2c in the UEI report(s).
Component-2o: indicator(s) indicating presence or absent of Component-2d in the UEI report(s); e.g., the indicator(s) could be a one-bit indicator with ‘1’ (or ‘0’) indicating presence and ‘0’ (or ‘1’) indicating absence of Component-2d in the UEI report(s).
Component-2p: indicator(s) indicating presence or absence of Component-2j in the UEI report(s); e.g., the indicator(s) could be a one-bit indicator with ‘1’ (or ‘0’) indicating presence and ‘0’ (or ‘1’) indicating absence of Component-2j in the UEI report(s).
Component-2q: indicator(s) indicating presence or absence of Component-2k in the UEI report(s); e.g., the indicator(s) could be a one-bit indicator with ‘1’ (or ‘0’) indicating presence and ‘0’ (or ‘1’) indicating absence of Component-2k in the UEI report(s).

The value(s) of threshold-B, threshold-B′, Nc, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In one example, Nc>1. In another example, Nc≥1.

In one example, a UE (e.g., the UE 116) could send or transmit a first UEI report comprising one or more (or a subset) of Component-2a-Component-2q according to those specified herein in the present disclosure, and a second UEI report comprising one or more (or a subset) of Component-2a-Component-2q according to those specified herein in the present disclosure. The first and second UEI reports could be in two separate or different CSI reports (denoted by CSI-Reports) or reporting instances. In this case, the first and second UEI reports (and therefore, their corresponding CSI-Reports and/or reporting instances) could be correlated or associated to each other: for example, the first and second UEI reports as specified/defined herein in the present disclosure could comprise, contain, provide or include a/the same reporting (or event) ID/index; for another example, the first and second UEI reports could be sent/transmitted within a time window/period (e.g., in number of symbols/slots/etc.) according to (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For instance, a/the first UEI report transmitted or sent in a first CSI-Report or reporting instance could comprise at least Component-2a, a/the second UEI report transmitted or sent in a second CSI-Report or reporting instance (different from or other than the first CSI-Report or reporting instance) could comprise at least Component-2c, and the first UEI report is associated to the second UEI report such that they would contain, provide, comprise, include or indicate a same reporting (or event) ID.

In another example, a UE could send or transmit to the network, in a same CSI-Report/reporting instance, a UEI report comprising two parts (e.g., a two-part UCI), wherein part 1 of the UEI report (or UCI) could comprise one or more (or a subset) of Component-2a-Component-2q according to those specified herein in the present disclosure, and part 2 of the UEI report (or UCI) could comprise one or more (or a subset) of Component-2a-Component-2q according to those specified herein in the present disclosure. Furthermore, part 1 of the UEI report (or UCI) could be of fixed payload size and/or could indicate presence/absence of part 2 of the UEI report (or UCI)—e.g., part 1 of the UEI report (or UCI) could comprise, indicate or provide a one-bit indicator with ‘1’ (or ‘0’) indicating presence and ‘0’ (or ‘1’) indicating absence of part 2 of the UEI report (or UCI)—and/or payload size of the part 2 (if present). For example, part 1 of the UEI report (or UCI) could comprise at least Component-2i, and part 2 of the UEI report (or UCI) could comprise at least Component-2j. For another example, part 1 of the UEI report (or UCI) could comprise at least Component-2p, and part 2 of the UEI report (or UCI) could comprise at least Component-2j. For another example, part 1 of the UEI report (or UCI) could comprise at least Component-2i, and part 2 of the UEI report (or UCI) could comprise at least Component-2c. For another example, part 1 of the UEI report (or UCI) could comprise at least Component-2n, and part 2 of the UEI report (or UCI) could comprise at least Component-2c. For another example, part 1 of the UEI report (or UCI) could comprise at least Component-2c and/or Component-2j, and part 2 of the UEI report (or UCI) could be absent. For another example, part 1 of the UEI report (or UCI) could comprise at least Component-2i, and part 2 of the UEI report (or UCI) could be absent.

Whether the UE could separately send or transmit the first and second UEI reports in two separate CSI reports/CSI reporting instances according to those specified herein in the present disclosure or a joint UEI report comprising part 1 and/or part 2 according to those specified herein in the present disclosure could be determined according to (i) fixed rule(s) in system specifications or per RRC configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals through, e.g., a CSI/beam report and/or UE's capability signaling(s).

In another example, a UE could send or transmit, in a first CSI-Report or CSI reporting instance, a current UEI report providing, indicating or comprising an incremental or decremental value with respect to a previous radio link/beam quality or a previous quality metric for a (first/second) candidate beam as specified/defined herein in the present disclosure reported in a previous UEI report or derived/calculated from the report content(s)/quantity(s) reported in a previous UEI report, wherein the previous UEI report could be transmitted or sent in a second CSI-Report or CSI reporting instance. In this case, a current radio link/beam quality or a current quality metric for the same (first/second) candidate beam as specified/defined herein in the present disclosure could be determined, identified, obtained, calculated or derived from the incremental/decremental value reported in the current UEI report and the previous radio link/beam quality or the previous quality metric for the (first/second) candidate beam reported in the previous UEI report. For instance, a current UEI report could provide, indicate, comprise, contain or include a delta_q value (or an absolute |delta_q| value along with a one-bit sign indicator indicating positive or negative of the absolute |delta_q| value) with respect to a previous L1-RSRP value denoted by previous_q for a (first/second) candidate beam as specified/defined herein in the present disclosure reported in a previous UEI report or derived/calculated from the report content(s)/quantity(s) reported in a previous UEI report. In this case, a current L1-RSRP value denoted by current_q could correspond to or could be derived/calculated as current_q=previous_q+delta_q. Furthermore, the previous and current UEI reports (and therefore, their corresponding first and second CSI-Reports and/or reporting instances) could be correlated or associated to each other: for example, the previous and current UEI reports as specified/defined herein in the present disclosure could comprise, contain, provide or include a/the same reporting (or event) ID/index; for another example, the previous and current UEI reports could be sent/transmitted within a time window/period (e.g., in number of symbols/slots/etc.) according to (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In addition, whether a UEI report, transmitted or sent by a UE, could provide, indicate or comprise (1) an incremental or decremental value with respect to a previous UEI report according to or following those specified herein in the present disclosure or (2) one or more of Component-2a to Component-2q according to or following those specified herein in the present disclosure could be determined according to: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

For a third event, wherein the radio link or beam quality(s) of one or more current serving beams is below or less than or equal to a threshold-A (an instance for the third event), and the radio link or beam quality(s) of one or more candidate beams is beyond or greater than or equal to a threshold-B, a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-A for the current serving beam(s), and/or information related to presence or absence of one or more of the report contents/quantities as described/specified herein in the present disclosure for the current serving beam(s), and/or report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-B for the candidate beam(s), and/or information related to presence or absence of one or more of the report contents/quantities as described/specified herein in the present disclosure for the candidate beam(s). In this case, when a UE detects the third event, the UE could also identify or determine the one or more current serving beams with their associated/corresponding radio link or beam quality(s) including L1-RSRP(s) and/or L1-SINR(s) below or less than or equal to the threshold-A, wherein the one or more identified or determined current serving beams could be denoted by the current serving beam(s) that satisfies the condition of the third event or in general the beam(s) that satisfies the condition of a/the given event, and the one or more candidate beams with their associated/corresponding radio link or beam quality(s) including L1-RSRP(s) and/or L1-SINR(s) beyond or greater than or equal to the threshold-B, wherein the one or more identified or determined candidate beams could be denoted by the candidate beam(s) that satisfies the condition of the third event or in general the beam(s) that satisfies the condition of a/the given event. Furthermore, a/the UEI report, e.g., for the third event, could comprise one or more of the Component-1a to Component-1q as specified/defined herein in the present disclosure for one or more first current serving beams with their associated/corresponding radio link/beam quality(s) less than or below or equal to the threshold-A according to those specified/defined herein in the present disclosure, wherein the one or more first current serving beams—denoted by the current serving beam(s) that satisfies the condition of the third event or in general the beam(s) that satisfies the condition of a/the given event—could comprise one or more (e.g., Ns) second current serving beams with their associated/corresponding radio link/beam quality(s) greater than or equal to or beyond a threshold-A′ or with their associated/corresponding radio link/beam quality(s) corresponding to the highest (or lowest) Ns radio link/beam quality(s) among the one or more first current serving beams as defined/specified herein in the present disclosure, and one or more of the Component-2a to Component-2q for one or more first candidate beams with their associated/corresponding radio link/beam quality(s) greater than or beyond or equal to the threshold-B according to those specified/defined herein in the present disclosure, wherein the one or more first candidate beams—denoted by the candidate beam(s) that satisfies the condition of the third event or in general the beam(s) that satisfies the condition of a/the given event—could comprise one or more (e.g., Nc) second candidate beams with their associated/corresponding radio link/beam quality(s) greater than or equal to or beyond a threshold-B′ or with their associated/corresponding radio link/beam quality(s) corresponding to the highest (or lowest) Nc radio link/beam quality(s) among the one or more first candidate beams as defined/specified herein in the present disclosure, and/or Component-3: indicator(s) indicating occurrence of the third event and/or an event index/ID associated/specific/corresponding to the third event.

In one example, a UE could send or transmit a first UEI report comprising one or more (or a subset) of Component-1a-Component-1q and Component-2a-Component-2q and Component-3 according to those specified herein in the present disclosure, and a second UEI report comprising one or more (or a subset) of Component-1a-Component-1q and Component-2a-Component-2q and Component-3 according to those specified herein in the present disclosure. The first and second UEI reports could be in two separate or different CSI reports (denoted by CSI-Reports) or reporting instances. In this case, the first and second UEI reports (and therefore, their corresponding CSI-Reports and/or reporting instances) could be correlated or associated to each other: for example, the first and second UEI reports as specified/defined herein in the present disclosure could comprise, contain, provide or include a/the same reporting (or event) ID/index; for another example, the first and second UEI reports could be sent/transmitted within a time window/period (e.g., in number of symbols/slots/etc.) according to (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For instance, a/the first UEI report transmitted or sent in a first CSI-Report or reporting instance could comprise one or more of Component-1a-Component-1q and Component-3, a/the second UEI report transmitted or sent in a second CSI-Report or reporting instance (different from or other than the first CSI-Report or reporting instance) could comprise one or more of Component-2a-Component-2q, and the first UEI report is associated to the second UEI report such that they would contain, provide, comprise, include or indicate a same reporting (or event) ID. For another example, a/the first UEI report transmitted or sent in a first CSI-Report or reporting instance could comprise one or more of Component-2a-Component-2q and Component-3, a/the second UEI report transmitted or sent in a second CSI-Report or reporting instance (different from or other than the first CSI-Report or reporting instance) could comprise one or more of Component-1a-Component-1q, and the first UEI report is associated to the second UEI report such that they would contain, provide, comprise, include or indicate a same reporting (or event) ID.

In another example, a UE could send or transmit to the network (e.g., the network 130), in a same CSI-Report/reporting instance, a UEI report comprising two parts (e.g., a two-part UCI), wherein part 1 of the UEI report (or UCI) could comprise one or more (or a subset) of Component-1a-Component-1q and Component-2a-Component-2q and Component-3 according to those specified herein in the present disclosure, and part 2 of the UEI report (or UCI) could comprise one or more (or a subset) of Component-1a-Component-1q and Component-2a-Component-2q and Component-3 according to those specified herein in the present disclosure. Furthermore, part 1 of the UEI report (or UCI) could be of fixed payload size and/or could indicate presence/absence of part 2 of the UEI report (or UCI)—e.g., part 1 of the UEI report (or UCI) could comprise, indicate or provide a one-bit indicator with ‘1’ (or ‘0’) indicating presence and ‘0’ (or ‘1’) indicating absence of part 2 of the UEI report (or UCI)—and/or payload size of the part 2 (if present). For example, part 1 of the UEI report (or UCI) could comprise one or more of Component-1a-Component-1q and Component-3, and part 2 of the UEI report (or UCI) could comprise one or more of Component-2a-Component-2q and Component-3. For another example, part 1 of the UEI report (or UCI) could comprise one or more of Component-2a-Component-2q and Component-3, and part 2 of the UEI report (or UCI) could comprise one or more of Component-1a-Component-1q and Component-3. For another example, part 1 of the UEI report (or UCI) could comprise at least one or more of Component-2a-Component-2q and Component-3, and part 2 of the UEI report (or UCI) could be absent. For another example, part 1 of the UEI report (or UCI) could comprise at least one or more of Component-1a-Component-1q and Component-3, and part 2 of the UEI report (or UCI) could be absent. For another example, part 1 of the UEI report (or UCI) could comprise one or more of Component-1a-Component-1q, Component-2a-Component-2q and Component-3, and part 2 of the UEI report (or UCI) could be absent.

Whether the UE could separately send or transmit the first and second UEI reports in two separate CSI reports/CSI reporting instances according to those specified herein in the present disclosure or a joint UEI report comprising part 1 and/or part 2 according to those specified herein in the present disclosure could be determined according to (i) fixed rule(s) in system specifications or per RRC configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals through, e.g., a CSI/beam report and/or UE's capability signaling(s).

In another example, a UE could send or transmit, in a first CSI-Report or CSI reporting instance, a current UEI report providing, indicating or comprising a first incremental or decremental value with respect to a previous radio link/beam quality or a previous quality metric for a (first/second) current serving beam as specified/defined herein in the present disclosure reported in a previous UEI report or derived/calculated from the report content(s)/quantity(s) reported in a previous UEI report, and/or a second incremental or decremental value with respect to a previous radio link/beam quality or a previous quality metric for a (first/second) candidate beam as specified/defined herein in the present disclosure reported in a previous UEI report or derived/calculated from the report content(s)/quantity(s) reported in a previous UEI report, wherein the previous UEI report could be transmitted or sent in a second CSI-Report or CSI reporting instance. In this case, a current radio link/beam quality or a current quality metric for the same (first/second) current serving beam as specified/defined herein in the present disclosure could be determined, identified, obtained, calculated or derived from the first incremental/decremental value reported in the current UEI report and the previous radio link/beam quality or the previous quality metric for the (first/second) current serving beam reported in the previous UEI report, and/or a current radio link/beam quality or a current quality metric for the same (first/second) candidate beam as specified/defined herein in the present disclosure could be determined, identified, obtained, calculated or derived from the second incremental/decremental value reported in the current UEI report and the previous radio link/beam quality or the previous quality metric for the (first/second) candidate beam reported in the previous UEI report. For instance, a current UEI report could provide, indicate, comprise, contain or include a delta_p value (or an absolute |delta_p| value along with a one-bit sign indicator indicating positive or negative of the absolute |delta_p| value) with respect to aprevious L1-RSRP value denoted by previous_p for a (first/second) current serving beam as specified/defined herein in the present disclosure reported in a previous UEI report or derived/calculated from the report content(s)/quantity(s) reported in a previous UEI report, and/or a delta_q value (or an absolute |delta_q| value along with a one-bit sign indicator indicating positive or negative of the absolute |delta_q| value) with respect to aprevious L1-RSRP value denoted by previous_q for a (first/second) candidate beam as specified/defined herein in the present disclosure reported in a previous UEI report or derived/calculated from the report content(s)/quantity(s) reported in a previous UEI report. In this case, a current L1-RSRP value for the (first/second) current serving beam denoted by current_p could correspond to or could be derived/calculated as current_p=previous_p+delta_p, and/or a current L1-RSRP value for the (first/second) candidate beam denoted by current_q could correspond to or could be derived/calculated as current_q=previous_q+delta_q. Furthermore, the previous and current UEI reports (and therefore, their corresponding first and second CSI-Reports and/or reporting instances) could be correlated or associated to each other: for example, the previous and current UEI reports as specified/defined herein in the present disclosure could comprise, contain, provide or include a/the same reporting (or event) ID/index; for another example, the previous and current UEI reports could be sent/transmitted within a time window/period (e.g., in number of symbols/slots/etc.) according to (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In addition, whether a UEI report, transmitted or sent by a UE, could provide, indicate or comprise (1) a (first/second) incremental or decremental value with respect to a previous UEI report according to or following those specified herein in the present disclosure or (2) one or more of Component-1a to Component-1q, Component-2a to Component-2q and Component-3 according to or following those specified herein in the present disclosure could be determined according to: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

For a fourth event, wherein the radio link or beam quality(s) of one or more (or at least one) candidate beams is beyond or greater than the radio link or beam quality(s) of one or more current serving beams by a threshold-C (an instance for the fourth event), a/the UEI report could comprise report content(s)/quantity(s) including resource indicator(s) such as SSBRI(s)/CRI(s) and/or beam metric(s) such as L1-RSRP(s)/L1-SINR(s) for the current serving beam(s), and/or report content(s)/quantity(s) including resource indicator(s) such as SSBRI(s)/CRI(s) and/or beam metric(s) such as L1-RSRP(s)/L1-SINR(s) for the candidate beam(s), and/or information related to presence or absence of one or more of the report contents/quantities as described/specified herein in the present disclosure for the current serving beam(s), and/or information related to presence or absence of one or more of the report contents/quantities as described/specified herein in the present disclosure for the candidate beam(s), and/or quality metric(s) such as first difference(s) between the beam metric(s) such as L1-RSRP(s)/L1-SINR(s) for the current serving beam(s) and the beam metric(s) such as L1-RSRP(s)/L1-SINR(s) for the candidate beam(s), second difference(s) between the first difference(s) and the threshold-C. In this case, when a UE detects the fourth event, the UE could also identify or determine the one or more (or at least one) candidate beams and the one or more current serving beams, wherein the identified or determined one or more candidate beams could have their associated/corresponding radio link or beam quality(s) including L1-RSRP(s) and/or L1-SINR(s) beyond or greater than the radio link or beam quality(s) including L1-RSRP(s) and/or L1-SINR(s) of the identified or determined one or more current serving beams by the threshold-C, wherein the identified or determined one or more current serving beams could be denoted by the current serving beam(s) that satisfies the condition of the fourth event or in general the beam(s) that satisfies the condition of a/the given event, and the identified or determined one or more candidate beams could be denoted by the candidate beam(s) that satisfies the condition of the fourth event or in general the beam(s) that satisfies the condition of a/the given event. Furthermore, a/the UEI report, e.g., for the fourth event, could comprise one or more of the following components for one or more first current serving beams, wherein the one or more first current serving beams—denoted by the current serving beam(s) that satisfies the condition of the fourth event or in general the beam(s) that satisfies the condition of a/the given event—could comprise one or more (e.g., Ns) second current serving beams with their associated/corresponding radio link/beam quality(s) greater than or equal to or beyond a threshold-C′ or with their associated/corresponding radio link/beam quality(s) corresponding to the highest (or lowest) Ns radio link/beam quality(s) among the one or more first current serving beams as defined/specified herein in the present disclosure, and/or for one or more first candidate beams, wherein the one or more first candidate beams—denoted by the candidate beam(s) that satisfies the condition of the fourth event or in general the beam(s) that satisfies the condition of a/the given event—could comprise one or more (e.g., Nc) second candidate beams with their associated/corresponding radio link/beam quality(s) greater than or equal to or beyond a threshold-C″ or with their associated/corresponding radio link/beam quality(s) corresponding to the highest (or lowest) Nc radio link/beam quality(s) among the one or more first candidate beams as defined/specified herein in the present disclosure; in this case, as specified/described herein in the present disclosure, the radio link or beam quality(s) of the first candidate beam(s) is beyond or greater than the radio link or beam quality(s) of the first current serving beam(s) by the threshold-C.
Component-4a: resource indicator(s) such as SSBRI(s)/CRI(s) for the one or more first current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more first current serving beams.
Component-4b: resource indicator(s) such as SSBRI(s)/CRI(s) for the one or more first candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more first candidate beams.
Component-4c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4a for the one or more first current serving beams; differential RSRP/SINR reporting could be applied to Component-4c according to those specified herein in the present disclosure.
Component-4d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4b for the one or more first candidate beams; differential RSRP/SINR reporting could be applied to Component-4c according to those specified herein in the present disclosure.
Component-4e: first difference(s) between the beam metric(s) such as L1-RSRP(s)/L1-SINR(s) for the one or more first current serving beams and the beam metric(s) such as L1-RSRP(s)/L1-SINR(s) for the one or more first candidate beams; For instance, if a (differential) L1-RSRP/L1-SINR value computed with respect to or regarding or for a first current serving beam is x1 dBm, and a (differential) L1-RSRP/L1-SINR value computed with respect to or regarding or for a first candidate beam is x2 dBm, a first difference delta_diff_C=|x2−x1| dBm could be reported in the UEI report as a report content/quantity, and a corresponding one-bit sign indicator indicating either positive or negative of the first difference could also be reported in the same UEI report. Or, the first difference delta_diff_C=(x1−x2) and/or (x2−x1) dBm could be reported in the UEI report as a report content/quantity. Optionally, the value of delta_diff_C could be quantized to a u-bit value with a v dB step size with respect to the threshold-C.
Component-4f: second difference(s) between the first difference(s) in Component-4e and the threshold-C; For instance, for a first difference delta_diff_C (or |delta_diff_C|) specified/defined or obtained in Component-4e and if the threshold-C is z dBm, a second difference delta_diff_C′=|delta_diff_C−z| dBm could be reported in the UEI report as a report content/quantity, and a corresponding one-bit sign indicator indicating either positive or negative of the second difference could also be reported in the same UEI report. Or the second difference delta_diff_C′=(delta_diff_C−z) and/or (z−delta_diff_C) dBm could be reported in the UEI report as a report content/quantity. Optionally, the value of delta_diff_C′ could be quantized to a u-bit value with a v dB step size with respect to the threshold-C and/or the first difference delta_diff_C in this design example.
Component-4g: indicator(s) or bitmap(s) indicating the one or more first current serving beams—e.g., out of the current serving beams
Component-4h: indicator(s) or bitmap(s) indicating the one or more first candidate beams—e.g., out of the candidate beams.
Component-4i: a number of the one or more first current serving beams in the UEI report(s)
Component-4j: a number of the one or more first candidate beams in the UEI report(s)
Component-4k: resource indicator(s) such as SSBRI(s)/CRI(s) for the one or more second current serving beams; resource ID(s)/index(es) and/or RS ID(s)/index(es) of the (QCL source) RS(s) provided in one or more indicated joint/DL/UL TCI states that the UE (e.g., the UE 116) uses/applies for assessing or monitoring the radio link/beam quality(s) of the one or more second current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more second current serving beams.
Component-4l: resource indicator(s) such as SSBRI(s)/CRI(s) for the one or more second candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more second candidate beams.
Component-4m: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4k for the one or more second current serving beams; differential RSRP/SINR reporting could be applied to Component-4m according to those specified herein in the present disclosure.
Component-4n: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-41 for the one or more second candidate beams; differential RSRP/SINR reporting could be applied to Component-4n according to those specified herein in the present disclosure.
Component-4o: first difference(s) between the beam metric(s) such as L1-RSRP(s)/L1-SINR(s) for the one or more second current serving beams and the beam metric(s) such as L1-RSRP(s)/L1-SINR(s) for the one or more second candidate beams; For instance, if a (differential) L1-RSRP/L1-SINR value computed with respect to or regarding or for a second current serving beam is x1 dBm, and a (differential) L1-RSRP/L1-SINR value computed with respect to or regarding or for a second candidate beam is x2 dBm, a first difference delta_diff_C=|x2−x1| dBm could be reported in the UEI report as a report content/quantity, and a corresponding one-bit sign indicator indicating either positive or negative of the first difference could also be reported in the same UEI report. Or the first difference delta_diff_C=(x1−x2) and/or (x2−x1) dBm could be reported in the UEI report as a report content/quantity. Optionally, the value of delta_diff_C could be quantized to a u-bit value with a v dB step size with respect to the threshold-C.
Component-4p: second difference(s) between the first difference(s) in Component-4o and the threshold-C; For instance, for a first difference delta_diff_C (or |delta_diff_C|) specified/defined or obtained in Component-4o and if the threshold-C is z dBm, a second difference delta_diff_C′=delta_diff_C−z| dBm could be reported in the UEI report as a report content/quantity, and a corresponding one-bit sign indicator indicating either positive or negative of the second difference could also be reported in the same UEI report. Or the second difference delta_diff_C′=(delta_diff_C−z) and/or (z−delta_diff_C) dBm could be reported in the UEI report as a report content/quantity. Optionally, the value of delta_diff_C′ could be quantized to a u-bit value with a v dB step size with respect to the threshold-C and/or the first difference delta_diff_C in this design example.
Component-4q: indicator(s) or bitmap(s) indicating the one or more second current serving beams—e.g., out of the current serving beams or out of the first current serving beam(s)
Component-4r: indicator(s) or bitmap(s) indicating the one or more second candidate beams—e.g., out of the candidate beams or out of the first candidate beam(s).
Component-4s: a number of the one or more second current serving beams in the UEI report(s)
Component-4t: a number of the one or more second candidate beams in the UEI report(s)
Component-4u: indicator(s) indicating occurrence of the fourth event and/or an event index/ID associated/specific/corresponding to the fourth event
Component-5a: indicator(s) indicating presence or absent of Component-4a in the UEI report(s); e.g., the indicator(s) could be a one-bit indicator with ‘1’ (or ‘0’) indicating presence and ‘0’ (or ‘1’) indicating absence of Component-4a in the UEI report(s).
Component-5b: indicator(s) indicating presence or absent of Component-4b in the UEI report(s); e.g., the indicator(s) could be a one-bit indicator with ‘1’ (or ‘0’) indicating presence and ‘0’ (or ‘1’) indicating absence of Component-4b in the UEI report(s).
Component-5c: indicator(s) indicating presence or absent of Component-4c in the UEI report(s); e.g., the indicator(s) could be a one-bit indicator with ‘1’ (or ‘0’) indicating presence and ‘0’ (or ‘1’) indicating absence of Component-4c in the UEI report(s).
Component-5d: indicator(s) indicating presence or absent of Component-4d in the UEI report(s); e.g., the indicator(s) could be a one-bit indicator with ‘1’ (or ‘0’) indicating presence and ‘0’ (or ‘1’) indicating absence of Component-4d in the UEI report(s).
Component-5e: indicator(s) indicating presence or absence of Component-4e in the UEI report(s); e.g., the indicator(s) could be a one-bit indicator with ‘1’ (or ‘0’) indicating presence and ‘0’ (or ‘1’) indicating absence of Component-4e in the UEI report(s).
Component-5f: indicator(s) indicating presence or absence of Component-4f in the UEI report(s); e.g., the indicator(s) could be a one-bit indicator with ‘1’ (or ‘0’) indicating presence and ‘0’ (or ‘1’) indicating absence of Component-4f in the UEI report(s).
Component-5g: indicator(s) indicating presence or absent of Component-4k in the UEI report(s); e.g., the indicator(s) could be a one-bit indicator with ‘1’ (or ‘0’) indicating presence and ‘0’ (or ‘1’) indicating absence of Component-4k in the UEI report(s).
Component-5h: indicator(s) indicating presence or absent of Component-41 in the UEI report(s); e.g., the indicator(s) could be a one-bit indicator with ‘1’ (or ‘0’) indicating presence and ‘0’ (or ‘1’) indicating absence of Component-41 in the UEI report(s).
Component-5i: indicator(s) indicating presence or absent of Component-4m in the UEI report(s); e.g., the indicator(s) could be a one-bit indicator with ‘1’ (or ‘0’) indicating presence and ‘0’ (or ‘1’) indicating absence of Component-4m in the UEI report(s).
Component-5j: indicator(s) indicating presence or absent of Component-4n in the UEI report(s); e.g., the indicator(s) could be a one-bit indicator with ‘1’ (or ‘0’) indicating presence and ‘0’ (or ‘1’) indicating absence of Component-4n in the UEI report(s).
Component-5k: indicator(s) indicating presence or absence of Component-4o in the UEI report(s); e.g., the indicator(s) could be a one-bit indicator with ‘1’ (or ‘0’) indicating presence and ‘0’ (or ‘1’) indicating absence of Component-4o in the UEI report(s).
Component-51: indicator(s) indicating presence or absence of Component-4p in the UEI report(s); e.g., the indicator(s) could be a one-bit indicator with ‘1’ (or ‘0’) indicating presence and ‘0’ (or ‘1’) indicating absence of Component-4p in the UEI report(s).

The value(s) of threshold-C, threshold-C′, threshold-C″, Ns, Nc, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In one example, Nc>1 and/or Ns>1. In another example, Nc≥1 and/or Ns≥1.

In one example, a UE could send or transmit a first UEI report comprising one or more (or a subset) of Component-4a-Component-4u and Component-5a-Component-51 according to those specified herein in the present disclosure, and a second UEI report comprising one or more (or a subset) of Component-4a-Component-4u and Component-5a-Component-51 according to those specified herein in the present disclosure. The first and second UEI reports could be in two separate or different CSI reports (denoted by CSI-Reports) or reporting instances. In this case, the first and second UEI reports (and therefore, their corresponding CSI-Reports and/or reporting instances) could be correlated or associated to each other: for example, the first and second UEI reports as specified/defined herein in the present disclosure could comprise, contain, provide or include a/the same reporting (or event) ID/index; for another example, the first and second UEI reports could be sent/transmitted within a time window/period (e.g., in number of symbols/slots/etc.) according to (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For example, a/the first UEI report transmitted or sent in a first CSI-Report or reporting instance could comprise one or more of Component-4a, Component-4c, Component-4e, Component-4f, Component-4h, Component-4j, Component-4u and Component-5a-Component-5l, a/the second UEI report transmitted or sent in a second CSI-Report or reporting instance (different from or other than the first CSI-Report or reporting instance) could comprise one or more of Component-4b, Component-4d, Component-4e and Component-4f, and the first UEI report is associated to the second UEI report such that they would contain, provide, comprise, include or indicate a same reporting (or event) ID. For another example, a/the first UEI report transmitted or sent in a first CSI-Report or reporting instance could comprise one or more of Component-4b, Component-4d, Component-4e, Component-4f, Component-4g, Component-4i, Component-4u, and Component-5a-Component-5l, a/the second UEI report transmitted or sent in a second CSI-Report or reporting instance (different from or other than the first CSI-Report or reporting instance) could comprise one or more of Component-4a, Component-4c, Component-4e and Component-4f, and the first UEI report is associated to the second UEI report such that they would contain, provide, comprise, include or indicate a same reporting (or event) ID. For another example, a/the first UEI report transmitted or sent in a first CSI-Report or reporting instance could comprise one or more of Component-4k, Component-4m, Component-4o, Component-4p, Component-4r, Component-4t, Component-4u and Component-5a-Component-5l, a/the second UEI report transmitted or sent in a second CSI-Report or reporting instance (different from or other than the first CSI-Report or reporting instance) could comprise one or more of Component-4l, Component-4n, Component-4o and Component-4p, and the first UEI report is associated to the second UEI report such that they would contain, provide, comprise, include or indicate a same reporting (or event) ID. For another example, a/the first UEI report transmitted or sent in a first CSI-Report or reporting instance could comprise one or more of Component-4l, Component-4n, Component-4o, Component-4p, Component-4q, Component-4s, Component-4u and Component-5a-Component-5l, a/the second UEI report transmitted or sent in a second CSI-Report or reporting instance (different from or other than the first CSI-Report or reporting instance) could comprise one or more of Component-4k, Component-4m, Component-4o and Component-4p, and the first UEI report is associated to the second UEI report such that they would contain, provide, comprise, include or indicate a same reporting (or event) ID.

In another example, a UE could send or transmit to the network, in a same CSI-Report/reporting instance, a UEI report comprising two parts (e.g., a two-part UCI), wherein part 1 of the UEI report (or UCI) could comprise one or more (or a subset) of Component-4a-Component-4u and Component-5a-Component-51 according to those specified herein in the present disclosure, and part 2 of the UEI report (or UCI) could comprise one or more (or a subset) of Component-4a-Component-4u and Component-5a-Component-51 according to those specified herein in the present disclosure. Furthermore, part 1 of the UEI report (or UCI) could be of fixed payload size and/or could indicate presence/absence of part 2 of the UEI report (or UCI)—e.g., part 1 of the UEI report (or UCI) could comprise, indicate or provide a one-bit indicator with ‘1’ (or ‘0’) indicating presence and ‘0’ (or ‘1’) indicating absence of part 2 of the UEI report (or UCI)—and/or payload size of the part 2 (if present). For example, part 1 of the UEI report (or UCI) could comprise one or more of Component-4a, Component-4c, Component-4e, Component-4f, Component-4h, Component-4j, Component-4u and Component-5a-Component-5l, and part 2 of the UEI report (or UCI) could comprise one or more of Component-4b, Component-4d, Component-4e and Component-4f. For another example, part 1 of the UEI report (or UCI) could comprise one or more of Component-4b, Component-4d, Component-4e, Component-4f, Component-4g, Component-4i, Component-4u, and Component-5a-Component-5l, and part 2 of the UEI report (or UCI) could comprise one or more of Component-4a, Component-4c, Component-4e and Component-4f. For another example, part 1 of the UEI report (or UCI) could comprise one or more of Component-4k, Component-4m, Component-4o, Component-4p, Component-4r, Component-4t, Component-4u and Component-5a-Component-5l, and part 2 of the UEI report (or UCI) could comprise one or more of Component-4l, Component-4n, Component-4o and Component-4p. For another example, part 1 of the UEI report (or UCI) could comprise one or more of Component-4l, Component-4n, Component-4o, Component-4p, Component-4q, Component-4s, Component-4u and Component-5a-Component-5l, and part 2 of the UEI report (or UCI) could comprise one or more of Component-4k, Component-4m, Component-4o and Component-4p.

In one embodiment, the UE could be configured or provided or indicated by the network, e.g., via higher layer RRC signaling(s)/parameter(s) and/or MAC CE command(s) and/or dynamic DCI based L1 signaling(s) based on or according to a corresponding first UE's capability or capability signaling, a minimum number/value (denoted by N_min) of beam(s) and/or a minimum number/value (denoted by N_min) of report content(s)/quantity(s) for one or more beams as specified/defined herein in the present disclosure that can or need to or should be reported in a UEI beam report or a reporting instance for a UEI beam report and/or a value M_min (as defined herein). For instance, the higher layer RRC signaling(s)/parameter(s) could comprise a CSI reporting setting denoted by CSI-ReportConfig and/or a CSI resource setting denoted by CSI-ResourceConfig and/or a UEI reporting setting denoted by UEI-ReportConfig and/or etc. configured or provided or enabled for or associated to the UEI beam reporting as specified herein in the present disclosure. Furthermore, the first UE's capability or capability signaling could indicate or comprise their support of a minimum number/value (denoted by N_min) of beam(s) and/or a minimum number/value (denoted by N_min) of report content(s)/quantity(s) for one or more beams as specified/defined herein in the present disclosure that can or need to or should be reported in a UEI beam report or a reporting instance for a UEI beam report and/or a value M_min. Furthermore, the UE could also be configured or provided or indicated by the network, e.g., via higher layer RRC signaling(s)/parameter(s) and/or MAC CE command(s) and/or dynamic DCI based L1 signaling(s) based on or according to a corresponding second UE's capability or capability signaling, a maximum number/value (denoted by N_max) of beam(s) and/or a maximum number/value (denoted by N_max) of report content(s)/quantity(s) for one or more beams as specified/defined herein in the present disclosure that can or need to or should be reported in a UEI beam report or a reporting instance for a UEI beam report. For instance, the higher layer RRC signaling(s)/parameter(s) could comprise a CSI reporting setting denoted by CSI-ReportConfig and/or a CSI resource setting denoted by CSI-ResourceConfig and/or a UEI reporting setting denoted by UEI-ReportConfig and/or etc. configured or provided or enabled for or associated to the UEI beam reporting as specified herein in the present disclosure. Furthermore, the second UE's capability or capability signaling could indicate or comprise their support of a maximum number/value (denoted by N_max) of beam(s) and/or a maximum number/value (denoted by N_max) of report content(s)/quantity(s) for one or more beams as specified/defined herein in the present disclosure that can or need to or should be reported in a UEI beam report or a reporting instance for a UEI beam report. Additionally, the UE could also be configured or provided or indicated by the network, e.g., via higher layer RRC signaling(s)/parameter(s) and/or MAC CE command(s) and/or dynamic DCI based L1 signaling(s) based on or according to a corresponding third UE's capability or capability signaling, a number/value (denoted by N_config) of beam(s) and/or a number/value (denoted by N_config) of report content(s)/quantity(s) for one or more beams as specified/defined herein in the present disclosure that can or need to or should be reported in a UEI beam report or a reporting instance for a UEI beam report. For instance, the higher layer RRC signaling(s)/parameter(s) could comprise a CSI reporting setting denoted by CSI-ReportConfig and/or a CSI resource setting denoted by CSI-ResourceConfig and/or a UEI reporting setting denoted by UEI-ReportConfig and/or etc. configured or provided or enabled for or associated to the UEI beam reporting as specified herein in the present disclosure. Furthermore, the third UE's capability or capability signaling could indicate or comprise their support of a number/value (denoted by N_config) of beam(s) and/or a number/value (denoted by N_config) of report content(s)/quantity(s) for one or more beams as specified/defined herein in the present disclosure that can or need to or should be reported in a UEI beam report or a reporting instance for a UEI beam report. Optionally, the UE could indicate to the network, e.g., via the PN message/trigger or in part of/by the CSI/beam report and/or in part of/by the UEI beam report and/or a fourth UE's capability signaling, a number/value (denoted by N_ue) of beam(s) and/or a number/value (denoted by N_ue) of report content(s)/quantity(s) for one or more beams as specified/defined herein in the present disclosure that can or need to or should be reported in a UEI beam report or a reporting instance for a UEI beam report. The first, second, third and/or fourth UE's capabilities or capability signaling could correspond or belong to a common UE's capability or capability signaling and/or different components of a common UE's capability or capability signaling; optionally, the first, second, third and/or fourth UE's capabilities or capability signaling could correspond or belong to separate UE's capabilities or capability signaling. Example value(s) of N_min, M_min (as defined herein), N_max, N_config and/or N_ue could be one or more of {1, 2, 3, 4, 5, 6, 7, 8, 9, 10, 11, 12, 13, 14, 15, 16}, and supporting each of the values {1, 2, 3, 4, 5, 6, 7, 8, 9, 10, 11, 12, 13, 14, 15, 16} could be or could correspond to a (same/separate) UE's capability or capability signaling. One or more of the value(s) of N_min, M_min (defined herein), N_max, N_config and/or N_ue could be or could correspond to fixed value(s) in system specifications.
In one example (case A), for one or more given events or one or more given events detection, when/if the number of the determined or identified first beam(s)—denoted by N_beam—that satisfy the event(s) condition(s) and/or the number of report content(s)/quantity(s) of the determined or identified first beam(s)—denoted by N_beam—that satisfy the event(s) condition(s) as specified/defined herein in the present disclosure is less than or equal to N_min (i.e., N_beam≤N_min), the UE could send or transmit to the network a UEI report that comprises the N_beam determined or identified first beam(s) and/or the N_beam report content(s)/quantity(s) as specified/define herein in the present disclosure of the determined or identified first beam(s). In addition, the UEI report could also comprise a number of second beam(s), e.g., with the highest beam metric(s) including L1-RSRP(s) and/or L1-SINR(s)—denoted by M_beam—that may not satisfy the event(s) condition(s) and/or a number of report content(s)/quantity(s), e.g., comprising the highest beam metric(s) including L1-RSRP(s) and/or L1-SINR(s), of second beam(s)—denoted by M_beam—that may not satisfy the event(s) condition(s) according to those specified herein in the present disclosure. The first beam(s)—or the report content(s)/quantity(s) of the first beam(s)—and the second beam(s)—or the report content(s)/quantity(s) of the second beam(s)—could be the same or different. For this case, N_beam+M_beam=N_min, i.e., the UE could transmit or send to the network a UEI beam report comprising a number N_min of beam(s) or a number N_min report content(s)/quantity(s) including SSBRI(s)/CRI(s) and/or L1-RSRP(s)/L1-SINR(s) of one or more beams as specified/defined herein in the present disclosure. In addition, N_min could be greater than or equal to M_min.
In another example (case B), for one or more given events or one or more given events detection, when/if the number of the determined or identified first beam(s)—denoted by N_beam—that satisfy the event(s) condition(s) and/or the number of report content(s)/quantity(s) of the determined or identified first beam(s)—denoted by N_beam—that satisfy the event(s) condition(s) as specified/defined herein in the present disclosure is less than or equal to N_min (i.e., N_beam N_min), the UE could send or transmit to the network a UEI report that comprises the N_beam determined or identified first beam(s) and/or the N_beam report content(s)/quantity(s) as specified/defined herein in the present disclosure of the determined or identified first beam(s). In addition, N_min could be greater than or equal to M_min.
In another example (case C), for one or more given events or one or more given events detection, when/if the number of the determined or identified first beam(s)—denoted by N_beam—that satisfy the event(s) condition(s) and/or the number of report content(s)/quantity(s) of the determined or identified first beam(s) denoted by N_beam—that satisfy the event(s) condition(s) as specified/defined herein in the present disclosure is greater than or equal to N_min (i.e., N_beam≥N_min) but less than or equal to N_max, N_config and/or N_ue (i.e., N_beam≤N_max, and/or N_beam≤N_config and/or N_beam≤N_ue), the UE could send or transmit to the network a UEI report that comprises the N_beam determined or identified first beam(s) and/or the N_beam report content(s)/quantity(s) of the determined or identified first beam(s). In addition, the UEI report could also comprise a number of second beam(s), e.g., with the highest beam metric(s) including L1-RSRP(s) and/or L1-SINR(s)—denoted by M_beam—that may not satisfy the event(s) condition(s) and/or a number of report content(s)/quantity(s), e.g., comprising the highest beam metric(s) including L1-RSRP(s) and/or L1-SINR(s), of second beam(s)—denoted by M_beam—that may not satisfy the event(s) condition(s) according to those specified herein in the present disclosure. The first beam(s)—or the report content(s)/quantity(s) of the first beam(s)—and the second beam(s)—or the report content(s)/quantity(s) of the second beam(s)—could be the same or different. For this case, N_beam+M_beam could be less than or equal to N_max, N_config and/or N_ue, i.e., the UE could transmit or send to the network a UEI report comprising a number (N_beam+M_beam) or N_max of beam(s) or a number (N_beam+M_beam) or N_max report content(s)/quantity(s) including SSBRI(s)/CRI(s) and/or L1-RSRP(s)/L1-SINR(s) of one or more beams as specified/defined herein in the present disclosure. In addition, N_min could be greater than or equal to M_min.
In another example (case D), for one or more given events or one or more given events detection, when/if the number of the determined or identified first beam(s)—denoted by N_beam—that satisfy the event(s) condition(s) and/or the number of report content(s)/quantity(s) of the determined or identified first beam(s) denoted by N_beam—that satisfy the event(s) condition(s) as specified/defined herein in the present disclosure is greater than or equal to N_min (i.e., N_beam≥N_min) but less than or equal to N_max, N_config and/or N_ue (i.e., N_beam≤N_max, and/or N_beam≤N_config and/or N_beam≤N_ue), the UE could send or transmit to the network a UEI report that comprises the N_beam determined or identified first beam(s) and/or the N_beam report content(s)/quantity(s) as specified/defined herein in the present disclosure of the determined or identified first beam(s). In addition, N_min could be greater than or equal to M_min.
In another example (case E), for one or more given events or one or more given events detection, when/if the number of the determined or identified first beam(s)—denoted by N_beam—that satisfy the event(s) condition(s) and/or the number of report content(s)/quantity(s) of the determined or identified first beam(s) denoted by N_beam—that satisfy the event(s) condition(s) as specified/defined herein in the present disclosure is less than or equal to N_min (i.e., N_beam N_min), the UE could send or transmit to the network a UEI report that comprises one or more of the N_beam determined or identified first beam(s)—denoted by N_beam′, e.g., with the highest beam metric(s) including L1-RSRP(s)/L1-SINR(s) among the N_beam determined or identified first beam(s), and/or one or more of the N_beam report content(s)/quantity(s) as specified/define herein in the present disclosure of the determined or identified first beam(s)—denoted by N_beam′, e.g., with the highest beam metric(s) including L1-RSRP(s)/L1-SINR(s) among the N_beam determined or identified first beam(s). In addition, the UEI report could also comprise a number of second beam(s), e.g., with the highest beam metric(s) including L1-RSRP(s) and/or L1-SINR(s)—denoted by M_beam—that may not satisfy the event(s) condition(s) and/or a number of report content(s)/quantity(s), e.g., comprising the highest beam metric(s) including L1-RSRP(s) and/or L1-SINR(s), of second beam(s)—denoted by M_beam—that may not satisfy the event(s) condition(s) according to those specified herein in the present disclosure. The first beam(s)—or the report content(s)/quantity(s) of the first beam(s)—and the second beam(s)—or the report content(s)/quantity(s) of the second beam(s)—could be the same or different. For this case, N_beam′+M_beam=N_min, i.e., the UE could transmit or send to the network a UEI beam report comprising a number N_min of beam(s) or a number N_min report content(s)/quantity(s) including SSBRI(s)/CRI(s) and/or L1-RSRP(s)/L1-SINR(s) of one or more beams as specified/defined herein in the present disclosure. In addition, N_min could be greater than or equal to M_min.
In another example (case F), for one or more given events or one or more given events detection, when/if the number of the determined or identified first beam(s)—denoted by N_beam—that satisfy the event(s) condition(s) and/or the number of report content(s)/quantity(s) of the determined or identified first beam(s) denoted by N_beam—that satisfy the event(s) condition(s) as specified/defined herein in the present disclosure is greater than or equal to N_min (i.e., N_beam≥N_min) but less than or equal to N_max, N_config and/or N_ue (i.e., N_beam≤N_max, and/or N_beam≤N_config and/or N_beam≤N_ue), the UE could send or transmit to the network a UEI report that comprises one or more of the N_beam determined or identified first beam(s)—denoted by N_beam′, e.g., with the highest beam metric(s) including L1-RSRP(s)/L1-SINR(s) among the N_beam determined or identified first beam(s), and/or one or more of the N_beam report content(s)/quantity(s) as specified/define herein in the present disclosure of the determined or identified first beam(s)—denoted by N_beam′, e.g., with the highest beam metric(s) including L1-RSRP(s)/L1-SINR(s) among the N_beam determined or identified first beam(s). In addition, the UEI report could also comprise a number of second beam(s), e.g., with the highest beam metric(s) including L1-RSRP(s) and/or L1-SINR(s)—denoted by M_beam—that may not satisfy the event(s) condition(s) and/or a number of report content(s)/quantity(s), e.g., comprising the highest beam metric(s) including L1-RSRP(s) and/or L1-SINR(s), of second beam(s)—denoted by M_beam—that may not satisfy the event(s) condition(s) according to those specified herein in the present disclosure. The first beam(s)—or the report content(s)/quantity(s) of the first beam(s)—and the second beam(s)—or the report content(s)/quantity(s) of the second beam(s)—could be the same or different. For this case, N_beam′+M_beam could be less than or equal to N_max, N_config and/or N_ue, i.e., the UE could transmit or send to the network a UEI report comprising a number (N_beam′+M_beam) or N_max of beam(s) or a number (N_beam′+M_beam) or N_max report content(s)/quantity(s) including SSBRI(s)/CRI(s) and/or L1-RSRP(s)/L1-SINR(s) of one or more beams as specified/defined herein in the present disclosure. In addition, N_min could be greater than or equal to M_min.
In another example (case G), for one or more given events or one or more given events detection, when/if the number of the determined or identified first beam(s)—denoted by N_beam—that satisfy the event(s) condition(s) and/or the number of report content(s)/quantity(s) of the determined or identified first beam(s) denoted by N_beam—that satisfy the event(s) condition(s) as specified/defined herein in the present disclosure is greater than or equal to N_max, N_config and/or N_ue (i.e., N_beam N_max and/or N_beam N_config and/or N_beam N_ue), where N_max, N_config and/or N_ue are defined/specified herein in the present disclosure, the UE could send or transmit to the network a UEI (beam) report comprising K_beam≥1 determined or identified first beam(s), and/or report content(s)/quantity(s) corresponding/associated/specific to K_beam≥1 determined or identified first beam(s), and/or K_beam 1 report content(s)/quantity(s) as specified/defined herein in the present disclosure corresponding/associated/specific to one or more of the determined or identified first beam(s), wherein K_beam could be or could correspond to N_max and/or N_config and/or N_ue. For example, the reported K_beam determined or identified first beam(s)—or the corresponding/associated report content(s)/quantity(s)—could be associated with or could have, include, provide, comprise or contain the K_beam highest beam metric(s) including L1-RSRP(s)/L1-SINR(s) among the N_beam determined or identified first beam(s)—or the corresponding/associated report content(s)/quantity(s), wherein K_beam N_beam, and K_beam=N_max and/or K_beam=N_config and/or K_beam=N_ue according to those specified herein in the present disclosure. For another example, the reported K_beam report content(s)/quantity(s) corresponding/associated/specific to one or more of the determined or identified first beam(s) could be associated with or could have, include, provide, comprise or contain the K_beam highest beam metric(s) including L1-RSRP(s)/L1-SINR(s) among the N_beam report content(s)/quantity(s) corresponding/associated/specific to the determined or identified first beam(s) as defined/specified herein in the present disclosure, wherein K_beam N_beam, and K_beam=N_max and/or K_beam=N_config and/or K_beam=N_ue according to those specified herein in the present disclosure. For another example, which K_beam determined or identified first beam(s), and therefore, the corresponding/associated report content(s)/quantity(s), out of the N_beam determined or identified first beam(s), and therefore, the corresponding/associated report content(s)/quantity(s)—i.e., K_beam N_beam, and K_beam=N_max and/or K_beam=N_config and/or K_beam=N_ue according to those specified herein in the present disclosure, and/or which K_beam report content(s)/quantity(s) corresponding/associated/specific to one or more of the determined or identified first beam(s) out of the N_beam report content(s)/quantity(s) corresponding/associated/specific to the determined or identified first beam(s) as defined/specified herein in the present disclosure—i.e., K_beam N_beam, and K_beam=N_max and/or K_beam=N_config and/or K_beam=N_ue according to those specified herein in the present disclosure, could be determined according to (i) fixed value(s)/rule(s) in system specification(s) and/or per RRC (re)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination or decision, which could be further sent to the network via various UL channels/signals including PUCCH(s), PUSCH(s), MAC CE(s), PRACH(s), CSI/beam report(s) and/or UE's capability signaling(s).

A UE could be indicated or provided or configured or enabled by the network, e.g., via higher layer RRC signaling(s)/parameter(s) and/or MAC CE command(s) and/or dynamic DCI based L1 signaling(s) according to or based on a corresponding UE's capability or capability signaling, one or more of case A, case B, case C, case D, case E, case F and case G such that the UE could transmit or send a UEI report comprising report content(s)/quantity(s) following those specified in case A, case B, case C, case D, case E, case F and case G. For instance, a UE could be indicated or provided or configured or enabled by the network, e.g., via/in the higher layer RRC signaling(s)/parameter(s), e.g., of a CSI reporting setting denoted by CSI-ReportConfig and/or a CSI resource setting denoted by CSI-ResourceConfig and/or a UEI reporting setting denoted by UEI-ReportConfig and/or etc. configured or provided or enabled for or associated to the UEI beam reporting as specified herein in the present disclosure, a higher layer parameter denoted by ‘ueiReportMode’ set to value(s) related to or corresponding to or associated to one or more of ‘case A’, ‘case B’, ‘case C’, ‘case D’, case ‘E’ and/or ‘case F’. In one example, when/if the higher layer parameter ‘ueiReportMode’ is set to value(s) related to or corresponding to or associated to ‘case A’, the UE could transmit or send a UEI report comprising report content(s)/quantity(s) determined according to those specified in case A. For another example, when/if the higher layer parameter ‘ueiReportMode’ is set to value(s) related to or corresponding to or associated to ‘case A’ and ‘case C’, the UE could transmit or send a UEI report comprising report content(s)/quantity(s) determined according to those specified in case A and case C. The number(s)/value(s) of N_beam (for the first beam(s) that satisfy the corresponding event(s) condition(s) as specified/defined herein in the present disclosure), M_beam (for the second beam(s) that may not satisfy the corresponding event(s) condition(s)), N_beam′ (for a subset of the first beam(s) that satisfy the corresponding event(s) condition(s) as specified/defined herein in the present disclosure), N_beam_min, N_beam_max, M_beam_min and/or M_beam_max could be determined according to: (i) fixed value(s) in system specification(s), (ii) network's configuration(s)/indication(s) via higher layer RRC signaling(s)/parameter(s)—e.g., via/in CSI-ReportConfig and/or CSI-ResourceConfig and/or resource/report setting(s) that provides or configures the corresponding UEI beam report(s)—and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, wherein N_beam_min and N_beam_max could respectively represent the minimum and maximum numbers of first beam(s) that satisfy the corresponding event(s) condition(s) as defined/specified herein in the present disclosure—and therefore the corresponding report content(s)/quantity(s) including SSBRI(s)/CRI(s) and/or L1-RSRP(s)/L1-SINR(s)—that can or are allowed to be reported in a/same UEI (beam) report, and M_beam_min and M_beam_max could respectively represent the minimum and maximum numbers of second beam(s) that may not satisfy the corresponding event(s) condition(s) as defined/specified herein in the present disclosure—and therefore the corresponding report content(s)/quantity(s) including SSBRI(s)/CRI(s) and/or L1-RSRP(s)/L1-SINR(s)—that can or are allowed to be reported in a/same UEI (beam) report. In addition, as specified/defined herein in the present disclosure, for one or more given events or one or more given events detection, the UE (e.g., the UE 116) could first identify or determine N_beam first beam(s) that could satisfy the corresponding event(s) condition(s), and indicate or provide or include or send or transmit a subset of the N_beam first beam(s)—denoted by N_beam′ (N_beam′≤N_beam) first beam(s)—and therefore the corresponding report content(s)/quantity(s) including SSBRI(s)/CRI(s) and/or L1-RSRP(s)/L1-SINR(s) in a/the UEI beam report. In this case, the UE could send or transmit or indicate to the network, e.g., via/in part of a/the (same) UEI report, the value(s) of N_beam′; optionally, the value(s) of N_beam′ could be determined according to: (i) fixed value(s) in system specification(s) and/or per RRC (re)configuration and/or (ii) network's configuration(s)/indication(s) via higher layer RRC signaling(s)/parameter(s)—e.g., via/in CSI-ReportConfig and/or CSI-ResourceConfig and/or resource/report setting(s) that provides or configures the corresponding UEI beam report(s)—and/or MAC CE command(s) and/or dynamic DCI based L1 signaling(s) according to or based on a corresponding UE's capability or capability signaling. The UE could also send or transmit or indicate to the network, e.g., via/in part of the same UEI beam report, which one or more of the N_beam first beams—i.e., the subset of N_beam′ first beam(s) as defined/specified herein in the present disclosure, and therefore the associated/corresponding report content(s)/quantity(s) including SSBRI(s)/CRI(s) and/or L1-RSRP(s)/L1-SINR(s), and/or which one or more of the N_beam report content(s)/quantity(s) including SSBRI(s)/CRI(s) and/or L1-RSRP(s)/L1-SINR(s) corresponding/associated/specific to the first beams according to those specified herein in the present disclosure—i.e., the subset of N_beam′ report content(s)/quantity(s) including SSBRI(s)/CRI(s) and/or L1-RSRP(s)/L1-SINR(s) corresponding/associated/specific to one or more of the first beams according to those specified herein in the present disclosure could be conveyed or provided or indicated or contained or included or comprised or carried by the UEI beam report.
In one example, the UEI beam report could provide, indicate, contain, comprise or include a bitmap with each entry/bit position of the bitmap corresponding/associated to one of the N_beam first beams—and therefore the associated/corresponding report content(s)/quantity(s) including SSBRI(s)/CRI(s) and/or L1-RSRP(s)/L1-SINR(s), and/or one of the N_beam report content(s)/quantity(s) including SSBRI(s)/CRI(s) and/or L1-RSRP(s)/L1-SINR(s) corresponding/associated/specific to the first beams according to those specified herein in the present disclosure. For this design example, when/if a bit position/entry of the bitmap is set to ‘1’ (or ‘0’), the first beam—out of the N_beam first beams, and therefore the associated/corresponding report content(s)/quantity(s) including SSBRI(s)/CRI(s) and/or L1-RSRP(s)/L1-SINR(s)—associated/corresponding to the bit position/entry could be conveyed or provided or indicated or contained or included or comprised or carried by/in the UEI beam report, and/or the report content(s)/quantity(s) including SSBRI(s)/CRI(s) and/or L1-RSRP(s)/L1-SINR(s)—out of the N_beam report content(s)/quantity(s) including SSBRI(s)/CRI(s) and/or L1-RSRP(s)/L1-SINR(s) corresponding/associated/specific to the first beams according to those specified herein in the present disclosure—associated/corresponding to the bit position/entry could be conveyed or provided or indicated or contained or included or comprised or carried by/in the UEI beam report.
In another example, the UEI beam report could provide, indicate, contain, comprise or include one or more (e.g., N_beam) indicators with each indicator corresponding/associated to one of the N_beam first beams—and therefore the associated/corresponding report content(s)/quantity(s) including SSBRI(s)/CRI(s) and/or L1-RSRP(s)/L1-SINR(s), and/or one of the N_beam report content(s)/quantity(s) including SSBRI(s)/CRI(s) and/or L1-RSRP(s)/L1-SINR(s) corresponding/associated/specific to the first beams according to those specified herein in the present disclosure. For this design example, when/if an indicator is set to ‘1’ (or ‘0’), the first beam—out of the N_beam first beams, and therefore the associated/corresponding report content(s)/quantity(s) including SSBRI(s)/CRI(s) and/or L1-RSRP(s)/L1-SINR(s)—associated/corresponding to the indicator could be conveyed or provided or indicated or contained or included or comprised or carried by/in the UEI beam report, and/or the report content(s)/quantity(s) including SSBRI(s)/CRI(s) and/or L1-RSRP(s)/L1-SINR(s)—out of the N_beam report content(s)/quantity(s) including SSBRI(s)/CRI(s) and/or L1-RSRP(s)/L1-SINR(s) corresponding/associated/specific to the first beams according to those specified herein in the present disclosure—associated/corresponding to the indicator could be conveyed or provided or indicated or contained or included or comprised or carried by/in the UEI beam report.
In another example, the UEI beam report could provide, indicate, contain, comprise or include a set of one or more beam indexes, wherein each beam index could correspond/point to or represent one of the N_beam first beams—and therefore the associated/corresponding report content(s)/quantity(s) including SSBRI(s)/CRI(s) and/or L1-RSRP(s)/L1-SINR(s). For this design example, the first beam(s)—out of the N_beam first beams, and therefore the associated/corresponding report content(s)/quantity(s) including SSBRI(s)/CRI(s) and/or L1-RSRP(s)/L1-SINR(s)—that correspond to or that is represented or pointed by the beam index(es) in the set could be conveyed or provided or indicated or contained or included or comprised or carried by/in the UEI beam report.
In another example, the UEI beam report could provide, indicate, contain, comprise or include a set of one or more indexes, wherein each index could correspond to or represent one of the N_beam report content(s)/quantity(s) including SSBRI(s)/CRI(s) and/or L1-RSRP(s)/L1-SINR(s) corresponding/associated/specific to the first beams according to those specified herein in the present disclosure. For this design example, the report content(s)/quantity(s) including SSBRI(s)/CRI(s) and/or L1-RSRP(s)/L1-SINR(s)—out of the N_beam report content(s)/quantity(s) including SSBRI(s)/CRI(s) and/or L1-RSRP(s)/L1-SINR(s) corresponding/associated/specific to the first beams according to those specified herein in the present disclosure—that correspond to or that is presented or pointed by the index(es) in the set could be conveyed or provided or indicated or contained or included or comprised or carried by/in the UEI beam report.

For the described design examples/cases herein, the determined or identified first beam(s) could correspond to or could be one or more current serving beams and/or one or more candidate beams as specified/defined herein in the present disclosure. Furthermore, when/if a UEI beam report comprises one or more first beams (or one or more report contents/quantities for the first beam(s)) and one or more second beams (or one or more report contents/quantities for the second beam(s)) as specified/defined herein in the present disclosure, the UE could indicate to the network, e.g., via/in part of the same UEI beam report, which one or more of the reported beam(s) and/or report quantity(s)/content(s) in/of the UEI beam report could correspond to or could be associated to or for the beam(s)—i.e., the first beam(s)—that satisfies the event(s) condition(s) as specified/defined herein in the present disclosure, and which one or more of the reported beam(s) and/or report quantity(s)/content(s) in/of the UEI beam report could correspond to or could be associated to or for the beam(s)—i.e., the second beam(s)—that does not satisfy the event(s) condition(s) as specified/defined herein in the present disclosure.
In one example (mode A), a UEI beam report could indicate, provide or comprise a bitmap with each entry/bit position of the bitmap associated/corresponding to one or more report contents/quantities in the UEI beam report; when/if an entry/bit position of the bitmap is set to ‘1’ (or ‘0’), the report content(s)/quantity(s) associated/corresponding to the entry/bit position of the bitmap could correspond to or could be associated to or for the beam(s)—i.e., the first beam(s)—that satisfies the event(s) condition(s) as specified/defined herein in the present disclosure, and when/if an entry/bit position of the bitmap is set to ‘0’ (or ‘1’), the report content(s)/quantity(s) associated/corresponding to the entry/bit position of the bitmap could correspond to or could be associated to or for the beam(s)—i.e., the second beam(s)—that do not satisfy the event(s) condition(s) as specified/defined herein in the present disclosure.
In another example (mode B), a UEI beam report could indicate, provide or comprise one or more indicators with each indicator associated/corresponding to one or more report contents/quantities in the UEI beam report; when/if an indicator is set to ‘1’ (or ‘0’), the report content(s)/quantity(s) associated/corresponding to the indicator could correspond to or could be associated to or for the beam(s)—i.e., the first beam(s)—that satisfies the event(s) condition(s) as specified/defined herein in the present disclosure, and when/if an indicator is set to ‘0’ (or ‘1’), the report content(s)/quantity(s) associated/corresponding to the indicator could correspond to or could be associated to or for the beam(s)—i.e., the second beam(s)—that do not satisfy the event(s) condition(s) as specified/defined herein in the present disclosure.
In another example (mode C), a UEI beam report could indicate, provide or comprise a/the number of the report content(s)/quantity(s), e.g., value of N_beam, for the first beam(s) that satisfies the event(s) condition(s) as specified/defined herein in the present disclosure, and/or a/the number of the report content(s)/quantity(s), e.g., value of M_beam, for the second beam(s) that does not satisfy the event(s) condition(s) as specified/defined herein in the present disclosure. In this case, the first (or last) N_beam report content(s)/quantity(s) and/or the first (or last) N_beam CSI report numbers/fields/indexes in the UEI report could correspond to the first beam(s) that satisfies the event(s) condition(s) as specified/defined herein in the present disclosure, and/or the first (or last) M_beam report content(s)/quantity(s) and/or the first (or last) M_beam CSI report numbers/fields/indexes in the UEI report could correspond to the second beam(s) that does not satisfy the event(s) condition(s) as specified/defined herein in the present disclosure.
In another example (mode D), when/if the UEI report does not provide, indicate, comprise or contain information related to which one or more of the reported beam(s) and/or report quantity(s)/content(s) in/of the UEI beam report could correspond to or could be associated to or for the beam(s)—i.e., the first beam(s)—that satisfies the event(s) condition(s) as specified/defined herein in the present disclosure, and/or information related to which one or more of the reported beam(s) and/or report quantity(s)/content(s) in/of the UEI beam report could correspond to or could be associated to or for the beam(s)—i.e., the second beam(s)—that does not satisfy the event(s) condition(s) as specified/defined herein in the present disclosure, the UEI report could only comprise or contain or include or provide the report content(s)/quantity(s) corresponding to or associated to or for the beam(s)—i.e., the first beam(s)—that satisfies the event(s) condition(s) as specified/defined herein in the present disclosure.
In another example (mode E), when/if the UEI report does not provide, indicate, comprise or contain information related to which one or more of the reported beam(s) and/or report quantity(s)/content(s) in/of the UEI beam report could correspond to or could be associated to or for the beam(s)—i.e., the first beam(s)—that satisfies the event(s) condition(s) as specified/defined herein in the present disclosure, and/or information related to which one or more of the reported beam(s) and/or report quantity(s)/content(s) in/of the UEI beam report could correspond to or could be associated to or for the beam(s)—i.e., the second beam(s)—that does not satisfy the event(s) condition(s) as specified/defined herein in the present disclosure, the UEI report could only comprise or contain or include or provide the report content(s)/quantity(s) corresponding to or associated to or for the beam(s)—i.e., the second beam(s)—that does not satisfy the event(s) condition(s) as specified/defined herein in the present disclosure.
In another example (mode F), when/if the UEI (beam) report comprises one or more first beams (or one or more report contents/quantities for the first beam(s)) and one or more second beams (or one or more report contents/quantities for the second beam(s)) as specified/defined herein in the present disclosure), the UE could be expected to or could send or transmit to the network, in the (same) UEI beam report, the one or more current serving beams (or report quantity(s)/content(s) including L1-RSRP(s) for the one or more current serving beams) as specified/defined herein in the present disclosure. In this case, one or more beams or one or more report contents/quantities of one or more beams reported in the UEI (beam) report that satisfy the event(s) condition(s)—with respect to or regarding the current serving beam(s) or report quantity(s)/content(s) corresponding/associated/specific to the current serving beam(s) as specified/defined herein in the present disclosure, e.g., for the fourth event, the report quantity(s)/content(s) including L1-RSRP(s) corresponding/associated/specific to the one or more beams is beyond or greater than the report quantity(s)/content(s) including L1-RSRP(s) corresponding/associated/specific to the one or more current serving beams by a threshold-C according to or following those specified herein in the present disclosure—could be identified or determined as the first beam(s) or the report quantity(s)/content(s) for the first beam(s), and one or more beams (e.g., other than the identified or determined first beam(s)) or one or more report contents/quantities of one or more beams (e.g., other than the identified or determined first beam(s)) reported in the UEI (beam) report that do not satisfy the event(s) condition(s)—with respect to or regarding the current serving beam(s) or report quantity(s)/content(s) corresponding/associated/specific to the current serving beam(s) as specified/defined herein in the present disclosure, e.g., for the fourth event, the report quantity(s)/content(s) including L1-RSRP(s) corresponding/associated/specific to the one or more beams is not beyond or greater than the report quantity(s)/content(s) including L1-RSRP(s) corresponding/associated/specific to the one or more current serving beams by a threshold-C according to or following those specified herein in the present disclosure—could be identified or determined as the second beam(s) or the report quantity(s)/content(s) for the second beam(s). In addition, (1) it could be expected that the UE could report or transmit to the network, in a/the UEI (beam) report, a/the number Nserv≥1 of the current serving beam(s) or report content(s)/quantity(s) of the current serving beam(s) and/or (2) the UE could be configured/indicated by the network, e.g., via higher layer RRC signaling(s)/parameter(s) and/or MAC CE command(s) and/or dynamic DCI based L1 signaling(s), to transmit or report to the network, in a/the UEI (beam) report, a/the number Nserv≥1 of the current serving beam(s) or report content(s)/quantity(s) of the current serving beam(s) according to or following those specified herein in the present disclosure. For (1) and/or (2): (a) the position(s), ordering(s), CSI field(s), CSI field index(es), CSI field number(s) and/or etc. in the UEI (beam) report that could comprise, carry, provide, contain or include the current serving beam(s) or the report quantity(s)/content(s) associated/corresponding/specific to the current serving beam(s) as specified/defined herein in the present disclosure could be fixed; for instance, the first Nserv≥1 (or the 1-st when Nserv=1) position(s), ordering(s), CSI field(s), CSI field index(es), CSI field number(s) and/or etc. in the UEI (beam) report could comprise, carry, provide, contain or include the Nserv current serving beam(s) or the Nserv report quantity(s)/content(s) associated/corresponding/specific to the current serving beam(s) as specified/defined herein in the present disclosure, wherein the value of Nserv could be determined according to: (i) a fixed value, e.g., Nserv=1, in system specification(s) or per RRC (re)configuration, (ii) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (iii) UE's autonomous decision or selection, which could be further sent to the network via various UL channels/signals including PUCCH(s), PUSCH(s), MAC CE(s), PRACH(s), CSI/beam report(s) and/or UE's capability signaling(s), (b) the UE could indicate or provide or send to the network, in the (same) UEI beam report, the value/number Nserv and/or position(s), ordering(s), CSI field(s), CSI field index(es), CSI field number(s) and/or etc. in the UEI (beam) report that could comprise, carry, provide, contain or include the Nserv current serving beam(s) or the Nserv report quantity(s)/content(s) associated/corresponding/specific to the current serving beam(s) as specified/defined herein in the present disclosure,
For example, the UEI beam report could indicate, provide or comprise a bitmap with each entry/bit position of the bitmap associated/corresponding to one or more report contents/quantities in the UEI beam report; when/if an entry/bit position of the bitmap is set to ‘1’ (or ‘0’), the report content(s)/quantity(s) associated/corresponding to the entry/bit position of the bitmap could correspond to or could be associated to or for a current serving beam as defined/specified herein in the present disclosure.
For another example, the UEI beam report could indicate, provide or comprise one or more indicators with each indicator associated/corresponding to one or more report contents/quantities in the UEI beam report; when/if an indicator is set to ‘1’ (or ‘0’), the report content(s)/quantity(s) associated/corresponding to the indicator could correspond to or could be associated to or for a current serving beam as defined/specified herein in the present disclosure.
For another example, as discussed herein, the UEI beam report could indicate, provide or comprise a/the number of the report content(s)/quantity(s), e.g., the number/value of Nserv, for the current serving beam(s).
   and/or (c) the value/number Nserv and/or position(s), ordering(s), CSI field(s), CSI field index(es), CSI field number(s) and/or etc. in the UEI (beam) report that could comprise, carry, provide, contain or include the Nserv current serving beam(s) or the Nserv report quantity(s)/content(s) associated/corresponding/specific to the current serving beam(s) as specified/defined herein in the present disclosure could be indicated, configured or provided by the network, e.g., via higher layer RRC signaling(s)/parameter(s) and/or MAC CE command(s) and/or dynamic DCI based L1 signaling(s)—e.g., via bitmap(s), indicator(s) and/or etc. similar to those defined/specified in one or more examples described herein—according to or based on a corresponding UE's capability or capability signaling.

The UE could be indicated or configured or provided or enabled by the network, e.g., via higher layer RRC signaling(s)/parameter(s) and/or MAC CE command(s) and/or dynamic DCI based L1 signaling(s) based on or according to a corresponding UE's capability or capability signaling, which one or more of the design modes (e.g., mode A, mode B, mode C, mode D, mode E and mode F) to use for determining the order(s) the UEI report content(s)/quantity(s) for the first and second beams as defined/specified herein in the present disclosure. For instance, a UE could be indicated or provided or configured or enabled by the network, e.g., via/in the higher layer RRC signaling(s)/parameter(s), e.g., of a CSI reporting setting denoted by CSI-ReportConfig and/or a CSI resource setting denoted by CSI-ResourceConfig and/or a UEI reporting setting denoted by UEI-ReportConfig and/or etc. configured or provided or enabled for or associated to the UEI beam reporting as specified herein in the present disclosure, a higher layer parameter denoted by ‘ueiReportOderMode′ set to value(s) related to or corresponding to or associated to one or more of ‘mode A’, ‘mode B’, ‘mode C’, ‘mode D’ and/or case ‘D’. In one example, when/if the higher layer parameter ‘ueiReportOrderMode′ is set to value(s) related to or corresponding to or associated to ‘mode A’, the UE could use those specified/defined in mode A in the present disclosure for determining the order(s) the UEI report content(s)/quantity(s) for the first and second beams as defined/specified herein in the present disclosure. For another example, when/if the higher layer parameter ‘ueiReportOrderMode′ is set to value(s) related to or corresponding to or associated to ‘mode A’ and ‘mode C’, the UE could use those specified/defined in mode A and mode B in the present disclosure for determining the order(s) the UEI report content(s)/quantity(s) for the first and second beams as defined/specified herein in the present disclosure.

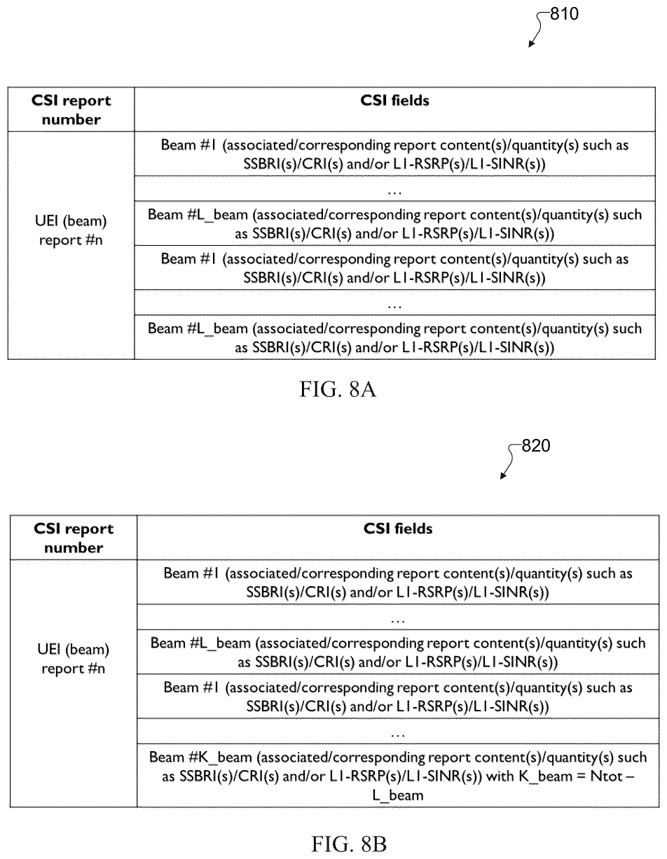

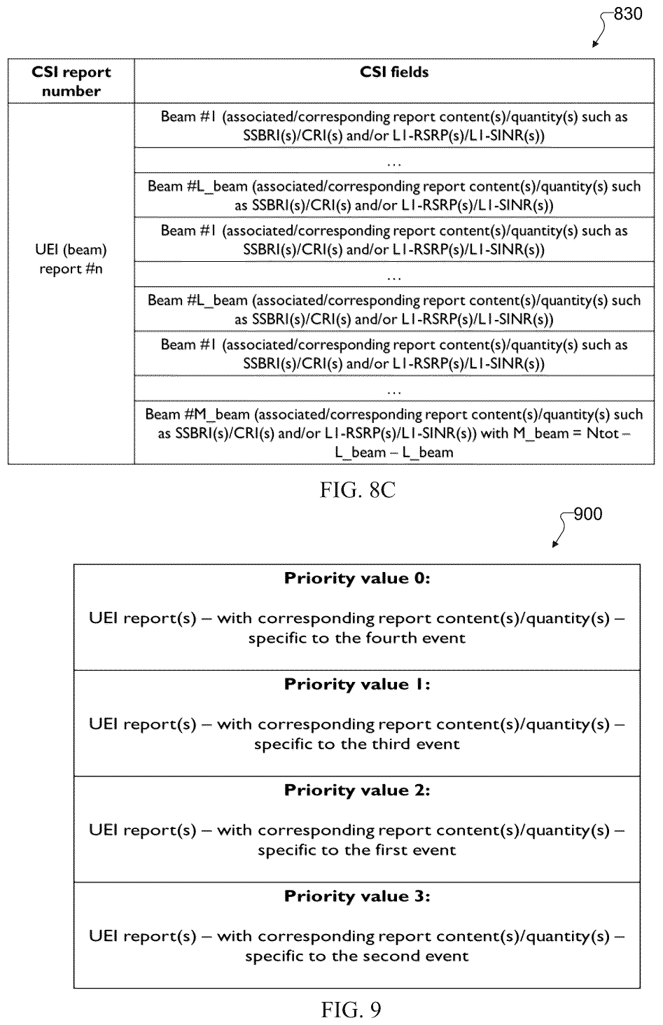

FIGS. 8A, 8B, and 8C illustrate examples of report contents and formats 810, 820, and 830, respectively, according to embodiments of the present disclosure. For example, report contents and formats 810, 820, and 830, respectively, can be reported by the UE 116 of FIG. 3. This example is for illustration only and other embodiments can be used without departing from the scope of the present disclosure.

Throughout the present disclosure, a beam/“beam” reported in a UEI (beam) report or a CSI report or a beam report in general can also be referred to as or equivalent to a report content/quantity—including SSBRI/CRI, L1-RSRP/L1-SINR and/or etc.—corresponding/associated/specific to a beam reported in a UEI (beam) report or a CSI report or a beam report in general, and/or one or more report contents/quantities—including SSBRI(s)/CRI(s), L1-RSRP(s)/L1-SINR(s) and/or etc.—corresponding/associated/specific to abeam reported in a UEI (beam) report or a CSI report or a beam report in general, and/or a resource indicator such as a SSBRI or a CRI reported in a UEI (beam) report or a CSI report or a beam report in general, and/or a beam metric such as a L1-RSRP or a L1-SINR reported in a UEI (beam) report or a CSI report or a beam report in general.

As specified herein in the present disclosure, a UEI (beam) report could comprise one or more (denoted by L_beam≥1, e.g., L_beam=1, 2, 3, 4, . . . ) beams—and therefore their associated/corresponding report content(s)/quantity(s) including SSBRI(s)/CRI(s) and/or L1-RSRP(s)/L1-SINR(s), and/or one or more (denoted by L_beam≥1, e.g., L_beam=1, 2, 3, 4, . . . ) report content(s)/quantity(s) including SSBRI(s)/CRI(s) and/or L1-RSRP(s)/L1-SINR(s) corresponding/associated/specific to one or more beams according to those specified herein in the present disclosure, wherein the one or more beams in the UEI (beam) report—and therefore their corresponding/associated report content(s)/quantity(s)—could comprise or correspond to one or more of:
One or more first beams as specified/defined herein in the present disclosure that satisfy the corresponding event(s) condition(s)—and therefore their corresponding/associated report content(s)/quantity(s)
One or more second beams as specified/defined herein in the present disclosure that may not satisfy the corresponding event(s) condition(s)—and therefore their corresponding/associated report content(s)/quantity(s)
One or more first beams that satisfy the corresponding event(s) condition(s) according to/following those specified herein in the present disclosure and one or more second beams that may not satisfy the corresponding event(s) condition(s)—and therefore their corresponding/associated report content(s)/quantity(s)
One or more current serving beams as defined/specified herein in the present disclosure—and therefore their corresponding/associated report content(s)/quantity(s)
One or more candidate/new beams as defined/specified herein in the present disclosure—and therefore their corresponding/associated report content(s)/quantity(s)
One or more current serving beams as defined/specified herein in the present disclosure and one or more candidate/new beams as defined/specified herein in the present disclosure—and therefore their corresponding/associated report content(s)/quantity(s)

In this case, the value of L_beam could be or could correspond to a fixed value per RRC (re)configuration—e.g., L_beam=1. Alternatively, the value of L_beam could be fixed in system specification(s)—e.g., L_beam=1. In addition, the value of L_beam could be provided or indicated or configured by the network, e.g., via higher layer RRC signaling(s)/parameter(s)—e.g., in CSI-ReportConfig or reporting setting(s)/configuration(s) that provides or configures the corresponding UEI beam report(s)—and/or MAC CE command(s) and/or dynamic DCI based L1 signaling(s) according to or based on a corresponding UE's capability or capability signaling—in this case, the value of L_beam could still be or could still correspond to a fixed value per RRC (re)configuration especially when the value of L_beam is provided or indicated or configured by the network via higher layer RRC signaling(s)/parameter(s); i.e., the value of L_beam would not change across different reporting instances/CSI reports/beam reports/UEI beam reports/CSI-Reports. Optionally, the value of L_beam could change or vary across different reporting instances/CSI reports/beam reports/UEI beam reports/CSI-Reports depending on, e.g., the number of first beam(s) as specified/defined herein in the present disclosure that satisfy the corresponding event(s) condition(s) in the UEI report; i.e., the value of L_beam is a variable for a given RRC (re)configuration. For instance, the value of L_beam for a first reporting instance or UEI (beam) report or CSI report (e.g., L_beam=2) could be different from that for a second reporting instance or UEI (beam) report or CSI report (e.g., L_beam=4). In this case, the value of L_beam or information related to the value of L_beam could be indicated or provided or transmitted or sent by the UE to the network, e.g., via/in part of the (same) UEI beam report. Furthermore, as discussed or specified herein in the present disclosure, for one or more given events or one or more given events detection, when/if the number of the reported beam(s) in the UEI beam report—i.e., L_beam as specified herein in the present disclosure—is less than or equal to N_max, N_config and/or N_ue (i.e., L_beam N_max and/or L_beam N_config and/or L_beam N_ue), wherein N_max, N_config and/or N_ue could be defined or specified according to or following those specified herein in the present disclosure,
In one example, the UEI (beam) report could have or comprise or contain or include a total of Ntot CSI field(s), wherein Ntot could correspond to or could be N_max, N_config or N_ue depending on, e.g., network's configuration(s)/indication(s) via higher layer RRC signaling(s)/parameter(s) and/or MAC CE command(s) and/or dynamic DCI based L1 signaling(s) based on or according to a corresponding UE's capability or capability signaling. For this design example, the first L_beam CSI field(s) or the L_beam CSI field(s) with the lowest field index(es) in the UEI (beam) report could be used to convey or provide or indicate or contain or include or comprise or carry the L_beam beams, and therefore their associated/corresponding report content(s)/quantity(s) including SSBRI(s)/CRI(s) and/or L1-RSRP(s)/L1-SINR(s), and/or the L_beam report content(s)/quantity(s) including SSBRI(s)/CRI(s) and/or L1-RSRP(s)/L1-SINR(s) corresponding/associated/specific to one or more beams according to those specified herein in the present disclosure. The remaining (Ntot−L_beam) CSI field(s) in the UEI beam report could be padded with zeros.
In another example, the UEI (beam) report could have or comprise or contain or include a total of Ntot CSI field(s), wherein Ntot could correspond to or could be N_max, N_config or N_ue depending on, e.g., network's configuration(s)/indication(s) via higher layer RRC signaling(s)/parameter(s) and/or MAC CE command(s) and/or dynamic DCI based L1 signaling(s) based on or according to a corresponding UE's capability or capability signaling. For this design example, the first L_beam CSI field(s) or the L_beam CSI field(s) with the lowest field index(es) in the UEI (beam) report could be used to convey or provide or indicate or contain or include or comprise or carry the L_beam beams, and therefore their associated/corresponding report content(s)/quantity(s) including SSBRI(s)/CRI(s) and/or L1-RSRP(s)/L1-SINR(s), and/or the L_beam report content(s)/quantity(s) including SSBRI(s)/CRI(s) and/or L1-RSRP(s)/L1-SINR(s) corresponding/associated/specific to one or more beams according to those specified herein in the present disclosure. The remaining (Ntot−L_beam) CSI field(s) in the UEI beam report could be reserved or could correspond to reserved (‘R’) field(s) or special (‘S’) field(s) that could comprise, provide, include, comprise, contain, carry or convey special value(s) or indicator(s) or codepoint(s).
In another example, the UEI (beam) report could have or comprise or contain or include a total of Ntot CSI field(s), wherein Ntot could correspond to or could be N_max, N_config or N_ue depending on, e.g., network's configuration(s)/indication(s) via higher layer RRC signaling(s)/parameter(s) and/or MAC CE command(s) and/or dynamic DCI based L1 signaling(s) based on or according to a corresponding UE's capability or capability signaling. For this design example, the first L_beam CSI field(s) or the L_beam CSI field(s) with the lowest field index(es) in the UEI (beam) report could be used to convey or provide or indicate or contain or include or comprise or carry the L_beam beams, and therefore their associated/corresponding report content(s)/quantity(s) including SSBRI(s)/CRI(s) and/or L1-RSRP(s)/L1-SINR(s), and/or the L_beam report content(s)/quantity(s) including SSBRI(s)/CRI(s) and/or L1-RSRP(s)/L1-SINR(s) corresponding/associated/specific to one or more beams according to those specified herein in the present disclosure. The remaining (Ntot−L_beam) CSI field(s) in the UEI beam report could be used to convey or provide or indicate or contain or include or comprise or carry one or more of the L_beam beams, and therefore their associated/corresponding report content(s)/quantity(s) including SSBRI(s)/CRI(s) and/or L1-RSRP(s)/L1-SINR(s), and/or one or more of the L_beam report content(s)/quantity(s) including SSBRI(s)/CRI(s) and/or L1-RSRP(s)/L1-SINR(s) corresponding/associated/specific to one or more beams according to those specified herein in the present disclosure. For this design example, the first CSI field or the CSI field with the lowest field index—out of or among the remaining (Ntot−L_beam) CSI field(s) in the UEI report—could be used to convey or provide or indicate or contain or include or comprise or carry the first beam or the beam with the lowest/highest beam metric such as L1-RSRP/L1-SINR or the beam with the lowest/highest resource indicator such as SSBRI/CRI—out of or among the L_beam beams—and therefore the associated/corresponding report content(s)/quantity(s) including SSBRI(s)/CRI(s) and/or L1-RSRP(s)/L1-SINR(s), and/or the first of the L_beam report content(s)/quantity(s) including SSBRI(s)/CRI(s) and/or L1-RSRP(s)/L1-SINR(s) corresponding/associated/specific to one or more beams according to those specified herein in the present disclosure, and/or one of the L_beam report content(s)/quantity(s) including SSBRI(s)/CRI(s) and/or L1-RSRP(s)/L1-SINR(s) corresponding/associated/specific to one or more beams according to those specified herein in the present disclosure that has the lowest/highest resource indicator such as SSBRI/CRI and/or the lowest/highest beam metric such as L1-RSRP/L1-SINR, the second CSI field or the CSI field with the second lowest field index—out of or among the remaining (Ntot−L_beam) CSI field(s) in the UEI report—could be used to convey or provide or indicate or contain or include or comprise or carry the second beam or the beam with the second lowest/highest beam metric such as L1-RSRP/L1-SINR or the beam with the second lowest/highest resource indicator such as SSBRI/CRI—out of or among the L_beam beams—and therefore the associated/corresponding report content(s)/quantity(s) including SSBRI(s)/CRI(s) and/or L1-RSRP(s)/L1-SINR(s), and/or the second of the L_beam report content(s)/quantity(s) including SSBRI(s)/CRI(s) and/or L1-RSRP(s)/L1-SINR(s) corresponding/associated/specific to one or more beams according to those specified herein in the present disclosure, and/or one of the L_beam report content(s)/quantity(s) including SSBRI(s)/CRI(s) and/or L1-RSRP(s)/L1-SINR(s) corresponding/associated/specific to one or more beams according to those specified herein in the present disclosure that has the second lowest/highest resource indicator such as SSBRI/CRI and/or the second lowest/highest beam metric such as L1-RSRP/L1-SINR, and so on.
For example, when/if (Ntot−L_beam) is equal to L_beam, the remaining (Ntot−L_beam) CSI field(s) in the UEI beam report could be used to convey or provide or indicate or contain or include or comprise or carry the L_beam beams, and therefore their associated/corresponding report content(s)/quantity(s) including SSBRI(s)/CRI(s) and/or L1-RSRP(s)/L1-SINR(s), and/or the L_beam report content(s)/quantity(s) including SSBRI(s)/CRI(s) and/or L1-RSRP(s)/L1-SINR(s) corresponding/associated/specific to one or more beams according to those specified herein in the present disclosure, following those specified, described or discussed herein in the present disclosure. One conceptual example is provided in FIG. 8A.
For another example, when/if (Ntot−L_beam) is less than L_beam, the remaining (Ntot−L_beam) CSI field(s) in the UEI report could be used to convey or provide or indicate or contain or include or comprise or carry the first (Ntot−L_beam) beams or the (Ntot−L_beam) beams with the lowest/highest beam metrics such as L1-RSRPs/L1-SINRs or the (Ntot−L_beam) beams with the lowest/highest resource indicators such as SSBRIs/CRIs—out of or among the L_beam beams—and therefore the associated/corresponding report content(s)/quantity(s) including SSBRI(s)/CRI(s) and/or L1-RSRP(s)/L1-SINR(s), and/or the first (Ntot−L_beam) of the L_beam report content(s)/quantity(s) including SSBRI(s)/CRI(s) and/or L1-RSRP(s)/L1-SINR(s) corresponding/associated/specific to one or more beams according to those specified herein in the present disclosure, and/or (Ntot−L_beam) of the L_beam report content(s)/quantity(s) including SSBRI(s)/CRI(s) and/or L1-RSRP(s)/L1-SINR(s) corresponding/associated/specific to one or more beams according to those specified herein in the present disclosure that has the lowest/highest resource indicators such as SSBRIs/CRIs and/or the lowest/highest beam metrics such as L1-RSRPs/L1-SINRs, following those specified herein in the present disclosure. One conceptual example is provided in FIG. 8B with K_beam=Ntot−L_beam.
For another example, when/if (Ntot−L_beam) is greater than L_beam, the first L_beam CSI field(s) or the L_beam CSI field(s) with the lowest field index(es)—out of or among the remaining (Ntot −L_beam) CSI field(s) in the UEI beam report—could be used to convey or provide or indicate or contain or include or comprise or carry the L_beam beams, and therefore their associated/corresponding report content(s)/quantity(s) including SSBRI(s)/CRI(s) and/or L1-RSRP(s)/L1-SINR(s), and/or the L_beam report content(s)/quantity(s) including SSBRI(s)/CRI(s) and/or L1-RSRP(s)/L1-SINR(s) corresponding/associated/specific to one or more beams according to those specified herein in the present disclosure, following those specified, described or discussed herein in the present disclosure. In this case, the remaining (Ntot−L_beam—L_beam) CSI field(s) in the UEI beam report could be used to convey or provide or indicate or contain or include or comprise or carry one or more of the L_beam beams, and therefore their associated/corresponding report content(s)/quantity(s) including SSBRI(s)/CRI(s) and/or L1-RSRP(s)/L1-SINR(s), and/or one or more of the L_beam report content(s)/quantity(s) including SSBRI(s)/CRI(s) and/or L1-RSRP(s)/L1-SINR(s) corresponding/associated/specific to one or more beams according to those specified herein in the present disclosure, following those specified herein in the present disclosure. One conceptual example is provided in FIG. 8C with M_beam=Ntot−L_beam—L_beam.

In this design example, the UE (e.g., the UE 116) could send or transmit or indicate to the network, e.g., via/in part of the same UEI beam report, the value(s) of L_beam and/or (Ntot−L_beam). Optionally, the UE could also send or transmit or indicate to the network, e.g., via/in part of the same UEI beam report, which one or more of the L_beam beams, and therefore their associated/corresponding report content(s)/quantity(s) including SSBRI(s)/CRI(s) and/or L1-RSRP(s)/L1-SINR(s), and/or which one or more of the L_beam report content(s)/quantity(s) including SSBRI(s)/CRI(s) and/or L1-RSRP(s)/L1-SINR(s) corresponding/associated/specific to one or more beams according to those specified herein in the present disclosure could be conveyed or provided or indicated or contained or included or comprised or carried by the remaining (Ntot−L_beam) CSI field(s) in the UEI beam report.
For example, the UEI beam report could provide, indicate, contain, comprise or include a bitmap with each entry/bit position of the bitmap corresponding/associated to one of the L_beam beams—and therefore the associated/corresponding report content(s)/quantity(s) including SSBRI(s)/CRI(s) and/or L1-RSRP(s)/L1-SINR(s), and/or one of the L_beam report content(s)/quantity(s) including SSBRI(s)/CRI(s) and/or L1-RSRP(s)/L1-SINR(s) corresponding/associated/specific to one or more beams according to those specified herein in the present disclosure. For this design example, when/if a bit position/entry of the bitmap is set to ‘1’ (or ‘0’), the beam—out of the L_beam beams, and therefore the associated/corresponding report content(s)/quantity(s) including SSBRI(s)/CRI(s) and/or L1-RSRP(s)/L1-SINR(s)—associated/corresponding to the bit position/entry could be conveyed or provided or indicated or contained or included or comprised or carried by one or more of the remaining (Ntot−L_beam) CSI field(s) in the UEI beam report, and/or the report content(s)/quantity(s) including SSBRI(s)/CRI(s) and/or L1-RSRP(s)/L1-SINR(s)—out of the L_beam report content(s)/quantity(s) including SSBRI(s)/CRI(s) and/or L1-RSRP(s)/L1-SINR(s) corresponding/associated/specific to one or more beams according to those specified herein in the present disclosure—associated/corresponding to the bit position/entry could be conveyed or provided or indicated or contained or included or comprised or carried by one or more of the remaining (Ntot−L_beam) CSI field(s) in the UEI beam report.
For another example, the UEI beam report could provide, indicate, contain, comprise or include one or more (e.g., L_beam) indicators with each indicator corresponding/associated to one of the L_beam beams—and therefore the associated/corresponding report content(s)/quantity(s) including SSBRI(s)/CRI(s) and/or L1-RSRP(s)/L1-SINR(s), and/or one of the L_beam report content(s)/quantity(s) including SSBRI(s)/CRI(s) and/or L1-RSRP(s)/L1-SINR(s) corresponding/associated/specific to one or more beams according to those specified herein in the present disclosure. For this design example, when/if an indicator is set to ‘1’ (or ‘0’), the beam—out of the L_beam beams, and therefore the associated/corresponding report content(s)/quantity(s) including SSBRI(s)/CRI(s) and/or L1-RSRP(s)/L1-SINR(s)—associated/corresponding to the indicator could be conveyed or provided or indicated or contained or included or comprised or carried by one or more of the remaining (Ntot−L_beam) CSI field(s) in the UEI beam report, and/or the report content(s)/quantity(s) including SSBRI(s)/CRI(s) and/or L1-RSRP(s)/L1-SINR(s)—out of the L_beam report content(s)/quantity(s) including SSBRI(s)/CRI(s) and/or L1-RSRP(s)/L1-SINR(s) corresponding/associated/specific to one or more beams according to those specified herein in the present disclosure—associated/corresponding to the indicator could be conveyed or provided or indicated or contained or included or comprised or carried by one or more of the remaining (Ntot −L_beam) CSI field(s) in the UEI beam report.
For another example, the UEI beam report could provide, indicate, contain, comprise or include a set of one or more beam indexes, wherein each beam index could correspond/point to or represent one of the L_beam beams—and therefore the associated/corresponding report content(s)/quantity(s) including SSBRI(s)/CRI(s) and/or L1-RSRP(s)/L1-SINR(s). For this design example, the beam(s)—out of the L_beam beams, and therefore the associated/corresponding report content(s)/quantity(s) including SSBRI(s)/CRI(s) and/or L1-RSRP(s)/L1-SINR(s)—that correspond to or that is represented or pointed by the beam index(es) in the set could be conveyed or provided or indicated or contained or included or comprised or carried by one or more of the remaining (Ntot−L_beam) CSI field(s) in the UEI beam report.
For another example, the UEI beam report could provide, indicate, contain, comprise or include a set of one or more indexes, wherein each index could correspond to or represent one of the L_beam report content(s)/quantity(s) including SSBRI(s)/CRI(s) and/or L1-RSRP(s)/L1-SINR(s) corresponding/associated/specific to one or more beams according to those specified herein in the present disclosure. For this design example, the report content(s)/quantity(s) including SSBRI(s)/CRI(s) and/or L1-RSRP(s)/L1-SINR(s)—out of the L_beam report content(s)/quantity(s) including SSBRI(s)/CRI(s) and/or L1-RSRP(s)/L1-SINR(s) corresponding/associated/specific to one or more beams according to those specified herein in the present disclosure—that correspond to or that is presented or pointed by the index(es) in the set could be conveyed or provided or indicated or contained or included or comprised or carried by one or more of the remaining (Ntot−L_beam) CSI field(s) in the UEI beam report.

Additionally, as discussed or specified herein in the present disclosure, for one or more given events or one or more given events detection, when/if the number of the reported beam(s) in the UEI beam report—i.e., L_beam as specified herein in the present disclosure—is greater than or equal to N_max, N_config and/or N_ue (i.e., L_beam≥N_max and/or L_beam≥N_config and/or L_beam≥N_ue), wherein N_max, N_config and/or N_ue could be defined or specified according to or following those specified herein in the present disclosure, the UEI (beam) report could have or comprise or contain or include a total of Ntot CSI field(s), wherein Ntot could correspond to or could be N_max, N_config or N_ue depending on, e.g., network's configuration(s)/indication(s) via higher layer RRC signaling(s)/parameter(s) and/or MAC CE command(s) and/or dynamic DCI based L1 signaling(s) based on or according to a corresponding UE's capability or capability signaling. In this case, the remaining Ntot CSI field(s) in the UEI report could be used to convey or provide or indicate or contain or include or comprise or carry the first Ntot beams or the Ntot beams with the lowest/highest beam metrics such as L1-RSRPs/L1-SINRs or the Ntot beams with the lowest/highest resource indicators such as SSBRIs/CRIs—out of or among the L_beam beams—and therefore the associated/corresponding report content(s)/quantity(s) including SSBRI(s)/CRI(s) and/or L1-RSRP(s)/L1-SINR(s), and/or the first Ntot of the L_beam report content(s)/quantity(s) including SSBRI(s)/CRI(s) and/or L1-RSRP(s)/L1-SINR(s) corresponding/associated/specific to one or more beams according to those specified herein in the present disclosure, and/or Ntot of the L_beam report content(s)/quantity(s) including SSBRI(s)/CRI(s) and/or L1-RSRP(s)/L1-SINR(s) corresponding/associated/specific to one or more beams according to those specified herein in the present disclosure that has the lowest/highest resource indicators such as SSBRIs/CRIs and/or the lowest/highest beam metrics such as L1-RSRPs/L1-SINRs, following those specified herein in the present disclosure. Furthermore, the UE could send or transmit or indicate to the network, e.g., via/in part of the same UEI beam report, which one or more of the L_beam beams, and therefore their associated/corresponding report content(s)/quantity(s) including SSBRI(s)/CRI(s) and/or L1-RSRP(s)/L1-SINR(s), and/or which one or more of the L_beam report content(s)/quantity(s) including SSBRI(s)/CRI(s) and/or L1-RSRP(s)/L1-SINR(s) corresponding/associated/specific to one or more beams according to those specified herein in the present disclosure could be conveyed or provided or indicated or contained or included or comprised or carried by the Ntot CSI field(s) in the UEI beam report.
In one example, the UEI beam report could provide, indicate, contain, comprise or include a bitmap with each entry/bit position of the bitmap corresponding/associated to one of the L_beam beams—and therefore the associated/corresponding report content(s)/quantity(s) including SSBRI(s)/CRI(s) and/or L1-RSRP(s)/L1-SINR(s), and/or one of the L_beam report content(s)/quantity(s) including SSBRI(s)/CRI(s) and/or L1-RSRP(s)/L1-SINR(s) corresponding/associated/specific to one or more beams according to those specified herein in the present disclosure. For this design example, when/if a bit position/entry of the bitmap is set to ‘1’ (or ‘0’), the beam—out of the L_beam beams, and therefore the associated/corresponding report content(s)/quantity(s) including SSBRI(s)/CRI(s) and/or L1-RSRP(s)/L1-SINR(s)—associated/corresponding to the bit position/entry could be conveyed or provided or indicated or contained or included or comprised or carried by one or more of the Ntot CSI field(s) in the UEI beam report, and/or the report content(s)/quantity(s) including SSBRI(s)/CRI(s) and/or L1-RSRP(s)/L1-SINR(s)—out of the L_beam report content(s)/quantity(s) including SSBRI(s)/CRI(s) and/or L1-RSRP(s)/L1-SINR(s) corresponding/associated/specific to one or more beams according to those specified herein in the present disclosure—associated/corresponding to the bit position/entry could be conveyed or provided or indicated or contained or included or comprised or carried by one or more of the Ntot CSI field(s) in the UEI beam report.
In another example, the UEI beam report could provide, indicate, contain, comprise or include one or more (e.g., L_beam) indicators with each indicator corresponding/associated to one of the L_beam beams—and therefore the associated/corresponding report content(s)/quantity(s) including SSBRI(s)/CRI(s) and/or L1-RSRP(s)/L1-SINR(s), and/or one of the L_beam report content(s)/quantity(s) including SSBRI(s)/CRI(s) and/or L1-RSRP(s)/L1-SINR(s) corresponding/associated/specific to one or more beams according to those specified herein in the present disclosure. For this design example, when/if an indicator is set to ‘1’ (or ‘0’), the beam—out of the L_beam beams, and therefore the associated/corresponding report content(s)/quantity(s) including SSBRI(s)/CRI(s) and/or L1-RSRP(s)/L1-SINR(s)—associated/corresponding to the indicator could be conveyed or provided or indicated or contained or included or comprised or carried by one or more of the Ntot CSI field(s) in the UEI beam report, and/or the report content(s)/quantity(s) including SSBRI(s)/CRI(s) and/or L1-RSRP(s)/L1-SINR(s)—out of the L_beam report content(s)/quantity(s) including SSBRI(s)/CRI(s) and/or L1-RSRP(s)/L1-SINR(s) corresponding/associated/specific to one or more beams according to those specified herein in the present disclosure—associated/corresponding to the indicator could be conveyed or provided or indicated or contained or included or comprised or carried by one or more of the Ntot CSI field(s) in the UEI beam report.
In another example, the UEI beam report could provide, indicate, contain, comprise or include a set of one or more beam indexes, wherein each beam index could correspond/point to or represent one of the L_beam beams—and therefore the associated/corresponding report content(s)/quantity(s) including SSBRI(s)/CRI(s) and/or L1-RSRP(s)/L1-SINR(s). For this design example, the beam(s)—out of the L_beam beams, and therefore the associated/corresponding report content(s)/quantity(s) including SSBRI(s)/CRI(s) and/or L1-RSRP(s)/L1-SINR(s)—that correspond to or that is represented or pointed by the beam index(es) in the set could be conveyed or provided or indicated or contained or included or comprised or carried by one or more of the Ntot CSI field(s) in the UEI beam report.
In another example, the UEI beam report could provide, indicate, contain, comprise or include a set of one or more indexes, wherein each index could correspond to or represent one of the L_beam report content(s)/quantity(s) including SSBRI(s)/CRI(s) and/or L1-RSRP(s)/L1-SINR(s) corresponding/associated/specific to one or more beams according to those specified herein in the present disclosure. For this design example, the report content(s)/quantity(s) including SSBRI(s)/CRI(s) and/or L1-RSRP(s)/L1-SINR(s)—out of the L_beam report content(s)/quantity(s) including SSBRI(s)/CRI(s) and/or L1-RSRP(s)/L1-SINR(s) corresponding/associated/specific to one or more beams according to those specified herein in the present disclosure—that correspond to or that is presented or pointed by the index(es) in the set could be conveyed or provided or indicated or contained or included or comprised or carried by one or more of the Ntot CSI field(s) in the UEI beam report.

In one embodiment, when/if a UEI (beam) report comprises or includes or contains or provides report content(s)/quantity(s) for the current serving beam(s) following those specified herein in the present disclosure, the report content(s)/quantity(s) for the current serving beam(s) (1) could only contain, include, provide or comprise beam metric(s) including L1-RSRP(s) and/or L1-SINR(s), and/or (2) may not contain, include, provide or comprise any resource indicator(s) including SSBRI(s) or CRI(s). Furthermore,
In one example, the first CSI field or the CSI field with the lowest field index—e.g., among the CSI field(s) in a/the UEI beam report and/or among the CSI field(s) in a/the UEI beam report that convey or carry or provide or indicate beam metric(s) including at least L1-RSRP(s)/L1-SINR(s)—could be used to indicate, convey, carry, provide, include, comprise or contain the report content(s)/quantity(s) for the current serving beam(s). In this case, when/if the first CSI field or the CSI field with the lowest field index as specified/defined herein is set to ‘0’ (or ‘1’) or a special value or reserved, the UEI (beam) report may not contain, provide, include, comprise or indicate any report content(s)/quantity(s) for or specific to the current serving beam(s); otherwise, the report content(s)/quantity(s) including L1-RSRP(s)/L1-SINR(s) provided, indicated, comprised, contained or included by/in the first CSI field or the CSI field with the lowest field index as specified/defined herein could be for or specific to the current serving beam(s).
In another example, a/the UEI (beam) report as specified/defined herein in the present disclosure could provide, include, contain, indicate or comprise an indicator to indicate whether or not the report content(s)/quantity(s) for or specific to the current serving beam(s) could be present in a/the UEI (beam) report. For instance, the indicator could be a one-bit indicator with ‘1’ (or ‘0’) indicating that the current serving beam(s)—and therefore the corresponding/associated report content(s)/quantity(s)—is present in the UEI beam report, and ‘0’ (or ‘1’) indicating that the current serving beam(s)—and therefore the corresponding/associated report content(s)/quantity(s)—is absent or not present in the UEI (beam) report. In this case, when/if the one-bit indicator is set to ‘1’ (‘0’), the first CSI field or the CSI field with the lowest field index—e.g., among the CSI field(s) excluding the CSI field that carries, conveys, provides or indicates the indicator in a/the UEI beam report and/or among the CSI field(s) excluding the CSI field that carries, conveys, provides or indicates the indicator that convey or carry or provide or indicate beam metric(s) including at least L1-RSRP(s)/L1-SINR(s) in a/the UEI beam report—could be used to indicate, convey, carry, provide, include, comprise or contain the report content(s)/quantity(s) for or specific to the current serving beam(s).

Whether the UE could separately send or transmit the first and second UEI reports in two separate CSI reports/CSI reporting instances according to those specified herein in the present disclosure or a joint UEI report comprising part 1 and/or part 2 according to those specified herein in the present disclosure could be determined according to (i) fixed rule(s) in system specifications or per RRC configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals through, e.g., a CSI/beam report and/or UE's capability signaling(s).

In another example, a UE could send or transmit, in a first CSI-Report or CSI reporting instance, a current UEI report providing, indicating or comprising a first incremental or decremental value with respect to a previous first difference for a (first/second) current serving beam and a (first/second) candidate beam as specified/defined herein in the present disclosure reported in a previous UEI report or derived/calculated from the report content(s)/quantity(s) reported in a previous UEI report, and/or a second incremental or decremental value with respect to a previous second difference as specified/defined herein in the present disclosure reported in a previous UEI report or derived/calculated from the report content(s)/quantity(s) reported in a previous UEI report, wherein the previous UEI report could be transmitted or sent in a second CSI-Report or CSI reporting instance. In this case, a current first difference for the same (first/second) current serving beam and the same (first/second) candidate beam as specified/defined herein in the present disclosure could be determined, identified, obtained, calculated or derived from the first incremental/decremental value reported in the current UEI report and the previous first difference for the (first/second) current serving beam and the (first/second) candidate beam reported in the previous UEI report, and/or a current second difference could be determined, identified, obtained, calculated or derived from the second incremental/decremental value reported in the current UEI report and the previous second difference reported in the previous UEI report. For instance, a current UEI report could provide, indicate, comprise, contain or include a delta_first value (or an absolute |delta_first| value along with a one-bit sign indicator indicating positive or negative of the absolute |delta_first| value) with respect to a previous first difference denoted by previous_first for a (first/second) current serving beam and a (first/second) current beam as specified/defined herein in the present disclosure reported in a previous UEI report or derived/calculated from the report content(s)/quantity(s) reported in a previous UEI report, and/or a delta_second value (or an absolute |delta_secondl value along with a one-bit sign indicator indicating positive or negative of the absolute |delta_secondl value) with respect to a previous second difference denoted by previous_second as specified/defined herein in the present disclosure reported in a previous UEI report or derived/calculated from the report content(s)/quantity(s) reported in a previous UEI report. In this case, a current first difference for the (first/second) current serving beam and the (first/second) candidate beam denoted by current_first could correspond to or could be derived/calculated as current first=previous_first+delta_first, and/or a current second difference denoted by current_second could correspond to or could be derived/calculated as current_second=previous_second+delta_second. Furthermore, the previous and current UEI reports (and therefore, their corresponding first and second CSI-Reports and/or reporting instances) could be correlated or associated to each other: for example, the previous and current UEI reports as specified/defined herein in the present disclosure could comprise, contain, provide or include a/the same reporting (or event) ID/index; for another example, the previous and current UEI reports could be sent/transmitted within a time window/period (e.g., in number of symbols/slots/etc.) according to (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In addition, whether a UEI report, transmitted or sent by a UE, could provide, indicate or comprise (1) a (first/second) incremental or decremental value with respect to a previous UEI report according to or following those specified herein in the present disclosure or (2) one or more of Component-4a-Component-4u and Component-5a-Component-51 according to or following those specified herein in the present disclosure could be determined according to: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

For each (or one or more) of the first, second, third and fourth events, and/or for a UE to declare each (or one or more) of the first, second, third and fourth events, and/or for a UE to formulate, construct, transmit and/or send the UEI report(s) with the report content(s)/quantity(s) corresponding to each (or one or more) of the first, second, third and fourth events according to or following those specified herein in the present disclosure, and/or for a UE to use/apply each (or one or more) of the first, second, third and fourth events for triggering or initiating the UEI reporting according to or following those specified herein in the present disclosure, the corresponding MAC entity could or shall for each Serving Cell configured for UEI reporting according to those specified herein in the present disclosure:
1> to initiate or trigger a UEI reporting based on or according to detection or declaration of one or each of the first, second, third and fourth events, individually:
   2> if an indication for an instance for an event (e.g., the first, second, third or fourth event) has been received from lower layers:
      3> start or restart the firstEventInstanceDetectionTimer, secondEventInstanceDetectionTimer; thirdEventInstanceDetectionTimer or fourthEventInstanceDetectionTimer (higher layer configured respectively for the first, second, third or fourth event—when/if applicable)
      3> increment firstEvent_COUNTER, secondEvent_COUNTER, thirdEvent_COUNTER or fourthEvent_COUNTER (higher layer configured respectively for the first, second, third or fourth event—when/if applicable) by 1;
      3> if firstEvent_COUNTER>=JfrstEventInstanceMaxCount, secondEvent_COUNTER>=secondEventInstanceMaxCount, thirdEvent_COUNTER>=thirdEventInstanceMaxCount or fourthEvent_COUNTER>=fourthEventInstanceMaxCount (respectively for the first, second, third or fourth event—when/if applicable), wherein the firstEventInstanceMaxCount, secondEventInstanceMaxCount, thirdEventInstanceMaxCount or fourthEventInstanceMaxCount is higher layer configured respectively for the first, second, third or fourth event—when/if applicable:
         4> trigger a UEI (beam) reporting specific to the first, second, third or fourth event—when/if applicable—for this Serving Cell, wherein the report content(s)/quantity(s) in the UEI report(s) is specific to the first, second, third or fourth event—when/if applicable—according to or following those specified herein in the present disclosure.
   2> if the frstEventInstanceDetectionTimer, secondEventInstanceDetectionTimer; thirdEventInstanceDetectionTimer or fourthEventInstanceDetectionTimer (respectively for the first, second, third or fourth event—when/if applicable) expires; or
   2> if the frstEventInstanceDetectionTimer, secondEventInstanceDetectionTimer; thirdEventInstanceDetectionTimer or fourthEventInstanceDetectionTimer (respectively for the first, second, third or fourth event—when/if applicable), firstEvent_COUNTER, secondEvent_COUNTER, thirdEvent_COUNTER or fourthEvent_COUNTER (respectively for the first, second, third or fourth event—when/if applicable), or any of the reference signals used for UEI reporting—e.g., including that/those specific to/for the current serving beam(s) and/or the candidate beam(s) as specified or defined herein in the present disclosure specific to/for the first, second, third or fourth event—is reconfigured by upper layers associated with this Serving Cell; or
   2> if the reference signal(s) associated with this Serving Cell used for detection/declaration/indication for the first, second, third or fourth event as specified/defined herein in the present disclosure is changed and/or reconfigured by upper layers associated with this Serving Cell:
      3> setfirstEvent_COUNTER, secondEvent_COUNTER, thirdEvent_COUNTER or fourthEvent_COUNTER (respectively for the first, second, third or fourth event—when/if applicable) to 0; and/or
      3> stop the ueiReportingTimer, if configured; and/or
      3> regard the UE-initiated (UEI) reporting procedure triggered or initiated with respect to the first, second, third or fourth event successfully completed, and/or cancel the UEI report(s) triggered or initiated with respect to the first, second, third or fourth event for this Serving Cell.

The described or specified MAC entity herein and the corresponding operation(s)/procedure(s) are for triggering or initiating one or more UEI report(s) according to or based on detection or declaration of one of the first, second, third and fourth events according to or following those specified herein in the present disclosure. To trigger or initiate a UEI reporting based on or according to detection or declaration of more than one or multiple events—e.g., the third and fourth events—jointly or simultaneously, the corresponding MAC entity—e.g., for the third and fourth events—could or shall for each Serving Cell configured for UEI reporting according to those specified herein in the present disclosure:
1> to initiate or trigger a UEI reporting based on or according to detection or declaration of the third and fourth events, jointly or simultaneously:
   2> if an indication for an instance for the third event has been received from lower layers, and/or if an indication for an instance for the fourth event has been received from lower layers:
      3> start or restart the thirdEventInstanceDetectionTimer and/or fourthEventInstanceDetectionTimer (higher layer configured for the third and/or fourth event(s)—when/if applicable)
      3> increment thirdEvent_COUNTER and/or fourthEvent_COUNTER (higher layer configured for the third and/or fourth event(s)—when/if applicable) by 1;
      3> if both thirdEvent_COUNTER>=thirdEventInstanceMaxCount and fourthEvent_COUNTER>=fourthEventInstanceMaxCount (for the third and fourth events—when/if applicable), wherein the thirdEventInstanceMaxCount and fourthEventInstanceMaxCount are higher layer configured respectively for the third and fourth events—when/if applicable:
         4> trigger a UEI (beam) reporting specific to the third and fourth events for this Serving Cell, wherein the report content(s)/quantity(s) in the UEI report(s) is specific to the third and fourth events—when/if applicable—according to or following those specified herein in the present disclosure.
   2> if the thirdEventInstanceDetectionTimer and/or fourthEventInstanceDetectionTimer (respectively for the third and/or fourth event(s)—when/if applicable) expires; or
   2> if the thirdEventInstanceDetectionTimer and/or fourthEventInstanceDetectionTimer (respectively for the third and/or fourth event(s)—when/if applicable), thirdEvent_COUNTER and/or fourthEvent_COUNTER (respectively for the third and/or fourth event(s)—when/if applicable), or any of the reference signals used for UEI reporting—e.g., including that/those specific to/for the current serving beam(s) and/or the candidate beam(s) as specified or defined herein in the present disclosure for the third and/or fourth event(s)—is reconfigured by upper layers associated with this Serving Cell; or
   2> if the reference signal(s) associated with this Serving Cell used for detection/declaration/indication for the third and/or fourth event(s) as specified/defined herein in the present disclosure is changed and/or reconfigured by upper layers associated with this Serving Cell:
      3> set thirdEvent_COUNTER and/or fourthEvent_COUNTER (respectively for the third and/or fourth event(s)—when/if applicable) to 0; and/or
      3> stop the ueiReportingTimer, if configured; and/or
      3> regard the UE-initiated (UEI) reporting procedure triggered or initiated with respect to both the third and fourth events successfully completed, and/or cancel the UEI report(s) triggered or initiated with respect to the third and fourth events for this Serving Cell.

The described/specified MAC entity(s) herein and the corresponding operation(s)/procedure(s) could be applied or extended to when/if more than two events could be configured and/or enabled by the network and/or applied or used by the UE for initiating or triggering the UEI reporting.

In one example, a UE could be indicated, configured or provided by the network, e.g., via higher layer RRC signaling(s)/parameter(s) and/or MAC CE command(s) and/or dynamic DCI based L1 signaling(s) based on a corresponding UE's capability or capability signaling, one or more of the first, second, third and fourth events as defined/specified herein in the present disclosure for the UEI (beam) reporting. For instance, a higher layer parameter eventType could be provided in higher layer parameter(s), e.g., CSI-ReportConfig, UEI-ReportConfig and etc., that configures or enables the UE-initiated (UEI) beam reporting. In this case, for example, when/if the eventType is set to ‘first’, the first event as specified/defined herein in the present disclosure could be used/applied for triggering or initiating the UEI reporting, when/if the eventType is set to ‘second’, the second event as specified/defined herein in the present disclosure could be used/applied for triggering or initiating the UEI reporting, when/if the eventType is set to ‘third’, the third event as specified/defined herein in the present disclosure could be used/applied for triggering and initiating the UEI reporting, and when/if the eventType is set to ‘fourth’, the fourth event as specified/defined herein in the present disclosure could be used/applied for triggering or initiating the UEI reporting; for another example, when/if the eventType is set to ‘second and fourth’, both the second and fourth events as specified/defined herein in the present disclosure could be used/applied for triggering or initiating the UEI reporting.

In another example, as discussed herein in the present disclosure, a UE could be provided, indicated or configured by the network, e.g., via higher layer RRC signaling(s)/parameter(s) and/or MAC CE command(s) and/or dynamic DCI based L1 signaling(s) according to or based on a corresponding UE's capability or capability signaling, one or more of the threshold-A, threshold-A′, threshold-B, threshold-B′, threshold-C, threshold-C′ and threshold-C″. For instance, the value(s) of the threshold-A, threshold-A′, threshold-B, threshold-B′, threshold-C, threshold-C′ and/or threshold-C″ could be provided in higher layer parameter(s), e.g., CSI-ReportConfig, UEI-ReportConfig and etc., that configures or enables the UE-initiated (UEI) beam reporting. In this case, for example, when/if the threshold-A and/or threshold-A′ is provided or configured, at least the first event as specified/defined herein in the present disclosure could be used/applied for triggering or initiating the UEI reporting, when/if the threshold-B and/or threshold-B′ is provided or configured, at least the second event as specified/defined herein in the present disclosure could be used/applied for triggering or initiating the UEI reporting, when/if both the threshold-A (and/or threshold-A′) and the threshold-B (and/or threshold-B′) are provided or configured, at least the third event as specified/defined herein in the present disclosure could be used/applied for triggering or initiating the UEI reporting, and when/if the threshold-C, threshold-C′ and/or threshold-C″ is provided or configured, at least the fourth event as specified/defined herein in the present disclosure could be used/applied for triggering or initiating the UEI reporting.

In another example, a UE (e.g., the UE 116) could be indicated, configured or provided by the network, e.g., via higher layer RRC signaling(s)/parameter(s) and/or MAC CE command(s) and/or dynamic DCI based L1 signaling(s) based on a corresponding UE's capability or capability signaling, that one or more of the first, second, third and fourth events as defined/specified herein in the present disclosure are enabled for the UEI (beam) reporting. For instance, higher layer parameter(s) reportQuantity or reportType or reportConfigType provided/configured in higher layer parameter(s), e.g., CSI-ReportConfig, UEI-ReportConfig and etc., that configures or enables the UE-initiated (UEI) beam reporting could be set to ‘servBeamOnly’, ‘candBeamOnly’, ‘bothServCandBeam’ and/or ‘diffServCandBeam’. For this design example, when/if the higher layer parameter(s) reportQuantity or reportType or reportConfigType is set to ‘servBeamOnly’, at least the first event as specified/defined herein in the present disclosure could be used/applied for triggering or initiating the UEI reporting, when/if the higher layer parameter(s) reportQuantity or reportType or reportConfigType is set to ‘candBeamOnly’, at least the second event as specified/defined herein in the present disclosure could be used/applied for triggering or initiating the UEI reporting, when/if the higher layer parameter(s) reportQuantity or reportType or reportConfgType is set to ‘bothServCandBeam’, at least the third event as specified/defined herein in the present disclosure could be used/applied for triggering or initiating the UEI reporting, and when/if the higher layer parameter(s) reportQuantity or reportType or reportConfigType is set to ‘diffServCandBeam’, at least the fourth event as specified/defined herein in the present disclosure could be used/applied for triggering or initiating the UEI reporting.

FIG. 9 illustrates examples of priority values/orders of different UEI reports 900 according to embodiments of the present disclosure. For example, priority values/orders of different UEI reports 900 can be identified and implemented by any of the UEs 111-116 of FIG. 1, such as the UE 111. This example is for illustration only and other embodiments can be used without departing from the scope of the present disclosure.

One or more of the events including the first, second, third and fourth events as specified herein in the present disclosure could have the same priority for triggering or initiating the UEI reporting, and/or one or more of the events including the first, second, third and fourth events as specified herein in the present disclosure could have different priorities or priority orders for triggering or initiating the UEI reporting.
In one example, for an event A and an event B, wherein the event A could correspond to or comprise one or more of the first, second, third and fourth events as specified herein in the present disclosure, the event B could correspond to or comprise one or more of the first, second, third and fourth events as specified herein in the present disclosure, and the event A and the event B could be different and have a/the same priority or priority order for triggering or initiating the UEI reporting, when/if a UE could trigger or initiate a UEI reporting according to the event A following those specified herein in the present disclosure wherein the corresponding report content(s)/quantity(s) could be associated/specific to the event A according to those specified herein in the present disclosure, and the UE could also trigger or initiate a UEI reporting according to the event B following those specified herein in the present disclosure wherein the corresponding report content(s)/quantity(s) could be associated/specific to the event B according to those specified herein in the present disclosure,
   For example, the UE could send or transmit a UEI report comprising report content(s)/quantity(s) associated or specific or corresponding to both the event A and event B according to or following those specified herein in the present disclosure. In one case, the event A could correspond to the first event, and the event B could correspond to the fourth event. In another case, the event A could correspond to the second event, and the event B could correspond to the fourth event. In another case, the event A could correspond to the third event, and the event B could correspond to the fourth event. And so on.
   For another example, the UE could send or transmit a UEI report comprising report content(s)/quantity(s) associated or specific or corresponding to either the event A or event B according to or following: (i) fixed rule(s) in system specification(s), (ii) network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals and/or a CSI/beam report and/or UE's capability signaling(s).
In another example, for an event A and an event B, wherein the event A could correspond to or comprise one or more of the first, second, third and fourth events as specified herein in the present disclosure, the event B could correspond to or comprise one or more of the first, second, third and fourth events as specified herein in the present disclosure, and the event A and the event B could be different and have different priorities or priority orders for triggering or initiating the UEI reporting, when/if a UE could trigger or initiate a UEI reporting according to the event A following those specified herein in the present disclosure wherein the corresponding report content(s)/quantity(s) could be associated/specific to the event A according to those specified herein in the present disclosure, and the UE could also trigger or initiate a UEI reporting according to the event B following those specified herein in the present disclosure wherein the corresponding report content(s)/quantity(s) could be associated/specific to the event B according to those specified herein in the present disclosure,
   For example, regardless of the priority order(s) between the event A and the event B, the UE could send or transmit a UEI report comprising report content(s)/quantity(s) associated or specific or corresponding to both the event A and event B according to or following those specified herein in the present disclosure. In one case, the event A could correspond to the first event, and the event B could correspond to the fourth event. In another case, the event A could correspond to the second event, and the event B could correspond to the fourth event. In another case, the event A could correspond to the third event, and the event B could correspond to the fourth event. And so on.
   For another example, regardless of the priority order(s) between the event A and the event B, the UE could send or transmit a UEI report comprising report content(s)/quantity(s) associated or specific or corresponding to either the event A or event B according to or following: (i) fixed rule(s) in system specification(s), (ii) network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals and/or a CSI/beam report and/or UE's capability signaling(s).
   For another example, when/if the event A has a higher priority or priority order than the event B, the UE could send or transmit a (first) UEI report comprising report content(s)/quantity(s) associated or specific or corresponding to the event A according to or following those specified herein in the present disclosure. For the two-part UEI report/UCI design as defined/specified herein in the present disclosure, the report content(s)/quantity(s) associated or specific or corresponding to the event A could be in part 1 of the two-part UCI report (or UCI). Furthermore,
      In one case, the UE could drop or not transmit/send report content(s)/quantity(s) specific or corresponding or associated to the event B—that has a lower priority or priority order than the event A—according to or following those specified herein in the present disclosure.
      In another case, the UE could send or transmit a second UEI report comprising report content(s)/quantity(s) associated or specific or corresponding to the event B according to or following those specified herein in the present disclosure; for this case, the second UEI report could be multiplexed with the first UEI report.
      In another case, e.g., after sending the (first) UEI report for the event A, when/if there are still available and/or enough and/or additional UL resource(s) for transmitting or sending report content(s)/quantity(s) corresponding or associated or specific to the event B, the UE could send or transmit one or more of the report contents/quantities corresponding or associated or specific to the event B according to or following those specified herein in the present disclosure via or on or over the available UL resource(s). For this case, the transmitted/sent report content(s)/quantity(s) corresponding or specific or associated to the event B could be in a different CSI report or UEI report or CSI reporting instance from that of the event A.
      In another case, e.g., after sending the (first) UEI report for the event A, when/if there are still available and/or enough and/or additional UL resource(s) for transmitting or sending report content(s)/quantity(s) corresponding or associated or specific to the event B, the UE could send or transmit one or more of the report contents/quantities corresponding or associated or specific to the event B according to or following those specified herein in the present disclosure via or on or over the available UL resource(s). For this case, the transmitted/sent report content(s)/quantity(s) corresponding or specific or associated to the event B could be in a/the same CSI report or UEI report or CSI reporting instance as that of the event A; e.g., for the two-part UEI report/UCI design as defined/specified herein in the present disclosure, the report content(s)/quantity(s) associated or specific or corresponding to the event B—that has a lower priority or priority order than that of the event A—could be in part 2 of the two-part UCI report (or UCI).
      In another case, the UE could send or transmit the report content(s)/quantity(s) corresponding or associated or specific to the event B—that has a lower priority or priority order than that of the event A—in the next available transmission occasion(s) (TO(s)) for the UEI reporting according to those specified herein in the present disclosure.
   For another example, when/if the event A has a higher priority or priority order than the event B, the UE could send or transmit to the network a first PN message to indicate or initiate a (potential) transmission of a UEI report conveying or carrying or providing or containing or including the report content(s)/quantity(s) corresponding or specific or associated to the event A and/or to request first UL resource(s) for transmitting or sending the report content(s)/quantity(s) corresponding or specific or associated to the event A, and a second PN message to indicate or initiate a (potential) transmission of a UEI report conveying or carrying or providing or containing or including the report content(s)/quantity(s) corresponding or specific or associated to the event B and/or to request second UL resource(s) for transmitting or sending the report content(s)/quantity(s) corresponding or specific or associated to the event B. For this design example, the first PN message could have a higher priority or priority order than the second PN message, and/or the first PN message could indicate, provide, convey, contain or include information indicating a higher priority or priority order than the event B.
      In one case, the UE could transmit or send a (first) UEI report conveying, carrying, providing, containing, including or comprising the report content(s)/quantity(s) associated or corresponding or specific to the event A in the next available TO(s) or (pre-configured/scheduled/assigned/granted) UL resource(s) with respect to the first PN message t_0 symbols/slots/etc. after transmission of the first PN message, and a (second) UEI report conveying, carrying, providing, containing, including or comprising the report content(s)/quantity(s) associated or corresponding or specific to the event B in the next available TO(s) or (pre-configured/scheduled/assigned/granted) UL resource(s) with respect to the second PN message t_1 symbols/slots/etc. after transmission of the second PN message, wherein t_1 could be greater than or equal to t_0, or t_1 could be delta_t symbols/slots/etc. greater than t_0. The value(s) of t_0, t_1 and/or delta_t could be determined according to (i) fixed value(s) in system specification(s), (ii) network's configuration(s) and/or indication(s), e.g., via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination or selection, which could be further sent to the network via various UL channels/signals and/or a CSI/beam report and/or UE's capability signaling(s).
      In another case, the UE could transmit or send a (first) UEI report conveying, carrying, providing, containing, including or comprising the report content(s)/quantity(s) associated or corresponding or specific to the event A in the next available TO(s) or (pre-configured/scheduled/assigned/granted) UL resource(s) with respect to the first PN message t_a symbols/slots/etc. after receiving a first acknowledgement (ACK) for the first PN message transmission, and a (second) UEI report conveying, carrying, providing, containing, including or comprising the report content(s)/quantity(s) associated or corresponding or specific to the event B in the next available TO(s) or (pre-configured/scheduled/assigned/granted) UL resource(s) with respect to the second PN message t_b symbols/slots/etc. after receiving a second ACK for the second PN message transmission, wherein the UE could expect to receive the first ACK before or within t_a′ symbols/slot/etc. after the first/last symbol/slot/etc. of the first PN message transmission, and the second ACK before or within t_b′ symbols/slots/etc. after the first/last symbol/slot/etc. of the second PN message transmission. Here, t_a could be greater than or less than or equal to t_b, t_b′ could be greater than or equal to t_a′ or t_b′ could be delta_t symbols/slots/etc. greater than t_a′, wherein the value(s) of t_a, t_b, t_a′, t_b′ and/or delta_t could be determined according to (i) fixed value(s) in system specification(s), (ii) network's configuration(s) and/or indication(s), e.g., via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination or selection, which could be further sent to the network via various UL channels/signals and/or a CSI/beam report and/or UE's capability signaling(s).

In this design example, when/if the first UEI report specific to the event A and the second UEI report specific to the event B as specified/defined herein in the present disclosure collide (e.g., the time occupancy of the physical channels to carry the first and second UEI reports overlap in at least one OFDM symbol and are transmitted on the same carrier), the first and second UEI reports could be multiplexed or the UE could drop the second UEI report (and therefore, the corresponding report content(s)/quantity(s) conveyed therein) specific to the event B having a lower priority or priority order than the event A. Furthermore, when/if the next available TO(s) or (pre-configured/scheduled/assigned/granted) UL resource(s) specific to the first and second PN messages are the same or identical,
In one case, the UE could drop or not transmit/send the second UEI report (and therefore, the corresponding report content(s)/quantity(s) conveyed therein) specific or corresponding or associated to the event B—that has a lower priority or priority order than the event A—according to or following those specified herein in the present disclosure.
In another case, the UE could send or transmit the second UEI report comprising report content(s)/quantity(s) associated or specific or corresponding to the event B according to or following those specified herein in the present disclosure; for this case, the second UEI report could be multiplexed with the first UEI report.
In another case, e.g., after sending the (first) UEI report for the event A, when/if there are still available and/or enough and/or additional UL resource(s) for transmitting or sending report content(s)/quantity(s) corresponding or associated or specific to the event B, the UE could send or transmit one or more of the report contents/quantities corresponding or associated or specific to the event B according to or following those specified herein in the present disclosure via or on or over the available UL resource(s). For this case, the transmitted/sent report content(s)/quantity(s) corresponding or specific or associated to the event B could be in a different CSI report or UEI report or CSI reporting instance from that of the event A.
In another case, e.g., after sending the (first) UEI report for the event A, when/if there are still available and/or enough and/or additional UL resource(s) for transmitting or sending report content(s)/quantity(s) corresponding or associated or specific to the event B, the UE could send or transmit one or more of the report contents/quantities corresponding or associated or specific to the event B according to or following those specified herein in the present disclosure via or on or over the available UL resource(s). For this case, the transmitted/sent report content(s)/quantity(s) corresponding or specific or associated to the event B could be in a/the same CSI report or UEI report or CSI reporting instance as that of the event A; e.g., for the two-part UEI report/UCI design as defined/specified herein in the present disclosure, the report content(s)/quantity(s) associated or specific or corresponding to the event B—that has a lower priority or priority order than that of the event A—could be in part 2 of the two-part UCI report (or UCI).
In another case, the UE could send or transmit the report content(s)/quantity(s) corresponding or associated or specific to the event B—that has a lower priority or priority order than that of the event A—in the next available transmission occasion(s) (TO(s)) for the UEI reporting according to those specified herein in the present disclosure.

Or in general, for this design example, the UE could transmit or send the first and/or the second UEI report(s)—and therefore, the corresponding report content(s)/quantity(s) conveyed therein—following those specified herein in the present disclosure, e.g., following or according to the design procedure(s) described or specified in one or more of the design examples including one or more examples described herein presented in the present disclosure.
For another example, a UE could generate, formulate, transmit and/or send a first UEI report conveying, carrying, providing, containing, including or comprising the report content(s)/quantity(s) associated or corresponding or specific to the event A, wherein the first UEI report could be associated with a priority value Pri_{iUEI}(y, k, c, s, e)=2·N_{cells}·Mₛ·y+N_{cells}·Mₛ·k+Mₛ·c+s+Mₑ·e, wherein
y=0 for aperiodic UEI reports to be carried on PUSCH, y=1 for semi-persistent UEI reports to be carried on PUSCH, y=2 for semi-persistent UEI reports to be carried on PUCCH and y=3 for periodic UEI reports to be carried on PUCCH
k=0 for UEI reports carrying L1-RSRP or L1-SINR and k=1 for UEI reports not carrying L1-RSRP or L1-SINR
c is the serving cell index and N_{cells} is the value of the higher layer parameter maxNrofServingCells;
s is the reportConfigID and Mₛ is the value of the higher layer parameter maxNrofCSI-ReportConfigurations;
e could correspond to the event ID and Mₑ could correspond to a higher layer parameter, e.g., related to a number or quantity of events specific to the serving cell.

In addition, the UE could also generate, formulate, transmit and/or send a second UEI report conveying, carrying, providing, containing, including or comprising the report content(s)/quantity(s) associated or corresponding or specific to the event B, wherein the second UEI report could also be associated with a priority value Pri_{iUEI}(y, k, c, s, e)=2·N_{cells}·Mₛ·y+N_{cells}·Mₛ·k+Mₛ·c+s+Mₑ·e. In this design example, when/if the event A has a higher priority or priority order than the event B, the value(s) of e for the first UEI report could be smaller than or equal to the value(s) of e for the second UEI report as specified/defined herein in the present disclosure, and therefore, the value(s) of Pri_{iUEI}(y, k, c, s, e) for the first UEI report could be smaller than or equal to the value(s) of Pri_{iUEI} (y, k, c, s, e) for the second UEI report—i.e., the first UEI report (and therefore, the event A) has a higher priority or priority order than or priority over the second UEI report (and therefore, the event B). In this case, the UE could transmit or send the first and/or the second UEI report(s)—and therefore, the corresponding report content(s)/quantity(s) conveyed therein—following those specified herein in the present disclosure, e.g., following or according to the design procedure(s) described or specified in one or more of the design examples including one or more examples described herein presented in the present disclosure.

The described/specified design examples herein including one or more examples described herein can be extended or applied to when/if the event B has a higher priority or priority order than or priority over the event A.

The described/specified design examples herein including one or more examples described herein (and therefore, the sub-examples described or specified or discussed therein) could be applied or extended to when/if more than two events could be configured and/or enabled by the network and/or applied or used by the UE for initiating or triggering the UEI reporting.

Throughout the present disclosure, a higher priority or priority order could be associated with or specific to a lower or smaller priority value. In FIG. 9, a conceptual example characterizing different priorities, priority orders and priority values for different events including the first, second, third and fourth events as specified/defined herein in the present disclosure (and therefore, their corresponding UEI reports with the corresponding report content(s)/quantity(s)) is presented. A UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, whether one or more of the events including the first, second, third and fourth events as defined or specified herein in the present disclosure could have a/the same priority (or priority order/value) or different priorities (or priority orders/values) for triggering or initiating the UEI reporting. Optionally, the UE could also be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information related to the priorities (or priority orders/values) for one or more of the events including the first, second, third or fourth events as specified/defined herein in the present disclosure for triggering or initiating the UEI reporting. For instance, a UE could be first provided or configured by the network, e.g., via higher layer RRC signaling(s)/parameter(s), the priority(s), priority order(s) and/or priority value(s) for one or more of the first, second, third and fourth events as defined/specified herein in the present disclosure. The UE could then receive from the network a MAC CE command that could update the priority(s), priority order(s) and/or priority value(s) of one or more of the first, second, third and fourth events. In addition,
In one example, when/if a UE has triggered or initiated a UEI reporting for an event according to or following those specified herein in the present disclosure, but does not transmit or send the corresponding UEI report(s)—and therefore the corresponding report content(s)/quantity(s)—specific to the event, on or over the corresponding/associated TO(s) and/or the UL resource(s) and/or within a time duration/window and/or after a timer has expired—e.g., the UE could have dropped the UEI report(s) because of the resource collision(s) and/or the priority rule(s) for the UEI reporting, the priority value for the event could be reduced by 1 (or equivalently, the level of priority or priority order for the event could be increased, e.g., by 1) for the next possible or potential triggering and/or transmitting of a UEI report with the corresponding report content(s)/quantity(s) specific to the event according to or following those specified herein in the present disclosure.
In another example, when/if a UE has transmitted or sent the UEI report(s)—and therefore the corresponding report content(s)/quantity(s)—specific to an event, on or over the corresponding/associated TO(s) and/or the UL resource(s) and/or within a time duration/window and/or before a timer has expired—e.g., the UEI report or the event could have higher priority/priority order or lower/smaller priority value than the other UEI reports or events, the priority value for the event could be increased by 1 (or equivalently, the level of priority or priority order for the event could be reduced, e.g., by 1) for the next possible or potential triggering and/or transmitting of a UEI report with the corresponding report content(s)/quantity(s) specific to the event according to or following those specified herein in the present disclosure.

The value(s) of the time duration/window and/or the timer could be determined according to: (1) fixed value(s) in system specification(s), (2) network's configuration(s) and/or indication(s), e.g., via higher layer RRC signaling(s)/parameter(s) and/or MAC CE command(s) and/or dynamic DCI based L1 signaling(s) according to a corresponding UE's capability or capability signaling, and/or (3) UE's autonomous determination/selection, which could be further sent to the network via various UL channels/signals and/or a CSI/beam report and/or UE's capability signaling(s).

As specified/defined herein in the present disclosure, one or more of the events (e.g., the first, second, third and fourth events) could be used/applied for triggering or initiating the UEI reporting such that a UE could send or transmit one or more UEI reports comprising report content(s)/quantity(s) specific to the one or more of the events according to or following those specified herein in the present disclosure. When/if more than one or multiple events—e.g., event A and event B—are configured and/or enabled by the network and/or used/applied by the UE to trigger or initiate the UEI reporting (the event A could correspond to or comprise one or more of the first, second, third and fourth events as specified herein in the present disclosure, and the event B could correspond to or comprise one or more of the first, second, third and fourth events as specified herein in the present disclosure, wherein the event A and the event B could be different),
In one example, when/if the UE has triggered or initiated a UEI reporting for the event A and the event B according to or following those specified herein in the present disclosure, a UEI report could comprise one or more of the report contents/quantities corresponding/specific to the event A and one or more of the report contents/quantities corresponding/specific to the event B according to or following those specified herein in the present disclosure.
   For example, position(s)/ordering(s)/CSI report number(s)/CSI report index(es)/CSI report field(s) of the report content(s)/quantity(s) specific to the event A and the event B in the UEI report could be fixed/predetermined/predefined. For instance, denote the number of the report content(s)/quantity(s) specific to the event A by Na, the first (or last) Na position(s)/ordering(s)/CSI report number(s)/CSI report index(es)/CSI report field(s) in the UEI report could be used to carry or convey the report content(s)/quantity(s) specific to the event A, and the rest of the position(s)/ordering(s)/CSI report number(s)/CSI report index(es)/CSI report field(s) in the same UEI report could be used to carry or convey the report content(s)/quantity(s) specific to the event B. Alternatively, denote the number of the report content(s)/quantity(s) specific to the event B by Nb, the first (or last) Nb position(s)/ordering(s)/CSI report number(s)/CSI report index(es)/CSI report field(s) in the UEI report could be used to carry or convey the report content(s)/quantity(s) specific to the event B, and the rest of the position(s)/ordering(s)/CSI report number(s)/CSI report index(es)/CSI report field(s) in the same UEI report could be used to carry or convey the report content(s)/quantity(s) specific to the event A.
   For another example, a first indicator and/or a second indicator could be provided, reported, sent, comprised, included, contained or transmitted in the UEI report as specified herein in the present disclosure. For this design example, the first indicator could be specific/associated/corresponding to or could be used to indicate the event A, and/or the second indicator could be specific/associated/corresponding to or could be used to indicate the event B. In particular, the first indicator could correspond to an event ID/index for the event A; optionally or alternatively, the first indicator could correspond to a one-bit indicator with ‘0’ (or ‘1’ or ‘2’) corresponding to/indicating the event A. Furthermore, the second indicator could correspond to an event ID/index for the event B; optionally or alternatively, the second indicator could correspond to a one-bit indicator with ‘1’ (or ‘0‘or’2’) corresponding to/indicating the event B. Denote the number of the report content(s)/quantity(s) specific to the event A in the UEI report by Na, the first Na CSI fields in the UEI report following the CSI field that provides, carries or conveys the first indicator could be used to provide, carry or convey the Na report content(s)/quantity(s) specific to/for the event A according to or following those specified herein in the present disclosure. In addition, denote the number of the report content(s)/quantity(s) specific to the event B in the UEI report by Nb, the first Nb CSI fields in the UEI report following the CSI field that provides, carries or conveys the second indicator could be used to provide, carry or convey the Nb report content(s)/quantity(s) specific to/for the event B according to or following those specified herein in the present disclosure. The CSI field that provides, carries or conveys the first indicator in the UEI report, and/or the CSI field that provides, carries or conveys the second indicator in the UEI report, could be fixed—e.g., the CSI field that provides, carries or conveys the first (or second) indicator could correspond to the first (or 1^{st}) CSI field in the UEI report, and/or the CSI field that provides, carries or conveys the second (or first) indicator could correspond the first (or 1^{st}) CSI field that follows or is after the last CSI field that provides, carries or conveys the report content(s)/quantity(s) specific to/for the event A (or the event B). Furthermore, the CSI field that provides, carries or conveys the first indicator in the UEI report, and/or the CSI field that provides, carries or conveys the second indicator in the UEI report, could be determined according to/based on (i) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (ii) UE's autonomous determination/selection, which could be further sent to the network via various UL channels/signals including PUCCH, PUSCH, PRACH, and/or etc.
   For another example, each of the report contents/quantities in the UEI report could be associated/corresponding/specific to an indicator, which could be conveyed, provided, indicated, contained, included or comprised in the (same) UEI report. For example, the indicator could correspond to an event ID/index for the event A or the event B according to those specified herein in the present disclosure. For another example, the indicator could correspond to a one-bit indicator with ‘0’ (or ‘1’ or ‘2’) corresponding to/indicating the event A, and ‘1’ (or ‘0’ or ‘2’) corresponding to/indicating the event B. In this case, when/if an indicator associated/corresponding/specific to a report content/quantity as specified/defined herein in the present disclosure in the UEI report is set to ‘0’ (or ‘1’ or ‘2’) and/or the event ID/index for the event A, the report content/quantity could be associated/corresponding/specific to the event A, and when/if an indicator associated/corresponding/specific to a report content/quantity as specified/defined herein in the present disclosure in the UEI report is set to ‘1’ (or ‘0’ or ‘2’) and/or the event ID/index for the event B, the report content/quantity could be associated/corresponding/specific to the event B.
   For another example, the two events, i.e., the event A and the event B, could have different priorities or priority orders or priority values according to those specified herein in the present disclosure. When/if the event A has a higher priority or priority order (or equivalently, a lower/smaller priority value) than the event B, denote the number of the report content(s)/quantity(s) specific to the event A by Na, the first (or last) Na position(s)/ordering(s)/CSI report number(s)/CSI report index(es)/CSI report field(s) in the UEI report could be used to carry or convey the report content(s)/quantity(s) specific to the event A, and the rest of the position(s)/ordering(s)/CSI report number(s)/CSI report index(es)/CSI report field(s) in the same UEI report could be used to carry or convey the report content(s)/quantity(s) specific to the event B. Alternatively, when/if the event B has a higher priority or priority order (or equivalently, a lower/smaller priority value) than the event A, denote the number of the report content(s)/quantity(s) specific to the event B by Nb, the first (or last) Nb position(s)/ordering(s)/CSI report number(s)/CSI report index(es)/CSI report field(s) in the UEI report could be used to carry or convey the report content(s)/quantity(s) specific to the event B, and the rest of the position(s)/ordering(s)/CSI report number(s)/CSI report index(es)/CSI report field(s) in the same UEI report could be used to carry or convey the report content(s)/quantity(s) specific to the event A.
   For another example, a UE could transmit or send a primary UEI report that comprises common or identical component(s) of the report content(s)/quantity(s) corresponding/specific to both the event A and the event B according to or following those specified herein in the present disclosure, and/or a secondary UEI report that comprises the report content(s)/quantity(s) corresponding/specific to both the event A and the event B excluding the common or identical component(s) as reported in the primary UEI report according to or following those specified herein in the present disclosure. Furthermore, whether a secondary UEI report can be transmitted or sent could be determined according to: (i) fixed rule(s) in system specifications or per RRC configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals through, e.g., a CSI/beam report and/or UE's capability signaling(s)—for example, the UE could send to the network a PN message associated/corresponding to the primary (or secondary) UEI report to indicate whether or not a secondary UEI report is present or transmitted or sent; for another example, the primary UEI report could provide, indicate, contain, comprise or include indicator(s) to indicate whether or not a secondary UEI report is present or transmitted or sent. For instance, the report content(s)/quantity(s) corresponding/specific to the event A could comprise Component-x, Component-y and Component-z, while the report content(s)/quantity(s) corresponding/specific to the event B could comprise Component-x, Component-a and Component-b. In this case, the UE could transmit or send a primary UEI report comprising only the Component-x because the Component-x is the only common or identical component of the report content(s)/quantity(s) corresponding/specific to both the events A and B. Optionally, for this design example, the UE could transmit or send a secondary UEI report comprising differential report contents/quantities specific to the event A and the event B (if any) such that the differential report contents/quantities do not comprise or contain or include the common or identical component(s) of the report content(s)/quantity(s) corresponding/specific to both the events A and B following those specified herein in the present disclosure. For the described example herein, the secondary UEI report (if present, transmitted or sent) could comprise Component-y, Component-z, Component-a and Component-b. Furthermore, the primary UEI report and the secondary UEI report could be transmitted or sent in two separate CSI reports, CSI-Reports or CSI reporting instances, and they could be correlated or associated to each other following those specified herein in the present disclosure.
   For another example, a UE (e.g., the UE 116) could transmit or send, in a single CSI report or CSI-Report or CSI reporting instance, a UEI report comprising two parts (i.e., a two-part UEI or a two-part UCI). For this design example, part 1 of the two-part UEI report (or the two-part UCI) could be of fixed payload size, and comprise common or identical component(s) of the report content(s)/quantity(s) corresponding/specific to both the event A and the event B according to or following those specified herein in the present disclosure. Furthermore, part 1 of the two-part UEI report (or the two-part UCI) could also indicate (e.g., via/through one or more indicators) whether or not part 2 of the two-part UEI report (or the two-part UCI) is present, transmitted or sent, and/or payload size of the part 2—if present, transmitted or sent. If present, transmitted or sent, part 2 of the two-part UEI report (or the two-part UCI) could be of flexible payload size, and comprise the report content(s)/quantity(s) corresponding/specific to both the event A and the event B excluding the common or identical component(s) as reported in part 1 according to or following those specified herein in the present disclosure. Furthermore, whether part 2 of the two-part UEI report (or the two-part UCI) can be present, transmitted or sent could be determined according to: (i) fixed rule(s) in system specifications or per RRC configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals through, e.g., a CSI/beam report and/or UE's capability signaling(s)—for example, the UE could send to the network a PN message associated/corresponding to the two-part UEI report to indicate whether or not part 2 of the two-part UEI report (or the two-part UCI) is present or transmitted or sent; for another example, part 1 of the two-part UEI report (or the two-part UCI) could provide, indicate, contain, comprise or include indicator(s) to indicate whether or not part 2 of the two-part UEI report is present or transmitted or sent. For instance, the report content(s)/quantity(s) corresponding/specific to the event A could comprise Component-x, Component-y and Component-z, while the report content(s)/quantity(s) corresponding/specific to the event B could comprise Component-x, Component-a and Component-b. In this case, the UE could transmit or send a two-part UEI report, wherein part 1 of the two-part UEI report could comprise only the Component-x because the Component-x is the only common or identical component of the report content(s)/quantity(s) corresponding/specific to both the events A and B. Optionally, for this design example, part 2 of the two-part UEI report could be present, transmitted or sent, which could comprise differential report contents/quantities specific to the event A and the event B (if any) such that the differential report contents/quantities do not comprise or contain or include the common or identical component(s) of the report content(s)/quantity(s) corresponding/specific to both the events A and B following those specified herein in the present disclosure. For the described example herein, part 2 of the two-part UEI report (if present, transmitted or sent) could comprise Component-y, Component-z, Component-a and Component-b.
In another example, when/if the UE has triggered or initiated a UEI reporting for the event A and the event B according to or following those specified herein in the present disclosure, the UE could transmit or send a first UEI report comprising one or more of the report contents/quantities corresponding/specific to the event A following those specified herein in the present disclosure, and a second UEI report comprising one or more of the report contents/quantities corresponding/specific to the event B following those specified herein in the present disclosure. The first UEI report and the second UEI report could be transmitted or sent in two separate CSI reports or CSI-Reports or CSI reporting instances.
   For example, the first UEI report could comprise or provide or contain or include or indicate information—e.g., an event ID/index or a one-bit indicator—that indicates the event A, and/or the second UEI report could comprise or provide or contain or include or indicate information—e.g., an event ID/index or a one-bit indicator—that indicates the event B.
   For another example, the network could identify or determine from the report content(s)/quantity(s)—specific to the event A—in the first UEI report that the first UEI report is specific to the event A, and/or identify or determine from the report content(s)/quantity(s)—specific to the event B—in the second UEI report that the second UEI report is specific to the event B.
   For another example, the transmission of the first UEI report specific to the event A could be prior to or before the transmission of the second UEI report specific to the event B, e.g., when/if the event A has a higher priority or priority order (or equivalently, a lower/smaller priority value) than the event B, and/or the first and second UEI reports as defined herein in the present disclosure could be transmitted or sent within a time window/period/duration (e.g., in symbols/slots/etc.), wherein the value(s) of the time window/period/duration could be determined according to (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
   For another example, the transmission of the second UEI report specific to the event B could be prior to or before the transmission of the first UEI report specific to the event A, e.g., when/if the event B has a higher priority or priority order (or equivalently, a lower/smaller priority value) than the event A, and/or the first and second UEI reports as defined herein in the present disclosure could be transmitted or sent within a time window/period/duration (e.g., in symbols/slots/etc.), wherein the value(s) of the time window/period/duration could be determined according to (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
   For another example, when/if the event A has a higher priority or priority order (or equivalently, a lower/smaller priority value) as specified/defined herein in the present disclosure than the event B, the first UEI report could be associated to a smaller/lower priority value (or equivalently, a higher priority or priority order) as specified/defined herein in the present disclosure than that of the second UEI report.
   For another example, when/if the event B has a higher priority or priority order (or equivalently, a lower/smaller priority value) as specified/defined herein in the present disclosure than the event A, the second UEI report could be associated to a smaller/lower priority value (or equivalently, a higher priority or priority order) as specified/defined herein in the present disclosure than that of the first UEI report.

For the described or specified design examples herein, one or more of the report content(s)/quantity(s) for an event (e.g., the event A) could be in part 1 of a two-part UEI report (or a two-part UCI)—when/if applicable—according to those specified herein in the present disclosure, and one or more of the report content(s)/quantity(s) for another event (e.g., the event B) could be in part 2 of the two-part UEI report (or the two-part UCI)—when/if applicable—according to those specified herein in the present disclosure. In the design examples specified/described herein in the present disclosure, the value(s) of Na and/or Nb could be determined according to/based on (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). For instance, the UE could send or transmit PN message(s) to indicate the value(s) of Na and/or Nb, and/or to indicate information related to the value(s) of Na and/or Nb, wherein the PN message(s) could be in part 1 of a two-part UEI report (or a two-part UCI). In addition, the described or specified design examples herein could be extended or applied to when/if more than two events could be configured and/or enabled by the network and/or applied or used by the UE for initiating or triggering the UEI reporting. Throughout the present disclosure, a UE could be provided or indicated or configured or informed or instructed by the network, e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

Whether the report contents/quantities associated or specific or corresponding to different events (e.g., the events A and B in the described design examples herein) according to those specified herein in the present disclosure could be in separate UEI (or CSI/beam) reports or a single UEI (or CSI/beam) report could be determined or identified according to or based on: (1) fixed rule(s) in system specification(s) or per RRC configuration, (2) network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling, and/or (3) UE's autonomous determination or selection, which could be further sent to the network via various UL channels/signals and/or a CSI/beam report and/or UE's capability signaling(s). Furthermore, a UE could transmit or send a PN message—defined/specified herein in the present disclosure—to indicate information related to the event(s)—e.g., event ID(s)/index(es)—configured/provided and/or enabled by the network or used/applied by the UE to initiate or trigger the UEI beam reporting according to those specified herein in the present disclosure. For instance, when/if a UE could use or apply one or more of the first, second, third and fourth events as specified herein in the present disclosure to trigger or initiate a UEI reporting, the PN message could be or could provide or indicate or contain or comprise or include a two-bit indicator. In this case,
When/if the PN or equivalently the two-bit indicator is set to ‘00’ (‘01’, ‘10’ or ‘11’), the UEI report or the report content(s)/quantity(s) associated or corresponding or specific to the PN message could be specific to/for the first event;
When/if the PN or equivalently the two-bit indicator is set to ‘01’ (‘00′, ‘10’ or ‘11’), the UEI report or the report content(s)/quantity(s) associated or corresponding or specific to the PN message could be specific to/for the second event;
When/if the PN or equivalently the two-bit indicator is set to ‘10’ (‘00′, ‘01’ or ‘11’), the UEI report or the report content(s)/quantity(s) associated or corresponding or specific to the PN message could be specific to/for the third event;
When/if the PN or equivalently the two-bit indicator is set to ‘11’ (‘00′, ‘01’ or ‘10’), the UEI report or the report content(s)/quantity(s) associated or corresponding or specific to the PN message could be specific to/for the fourth event;

Optionally, the PN message could be or could provide or indicate or contain or comprise or include one or more event IDs/indexes. In this case, the UEI report or the report content(s)/quantity(s) associated or corresponding or specific to the PN message could be specific to/for the one or more event IDs/indexes (and therefore, the corresponding events). Throughout the present disclosure, a UEI report or a report content/quantity as specified/defined herein in the present disclosure is said to be associated or specific or corresponding to a PN message when/if the UEI report or the report content/quantity is sent or transmitted in or on or over one or more TOs and/or UL channels/signals/resources including PUCCH(s)/PUCCH resource(s) and/or PUSCH(s)/PUSCH resource(s) and/or PRACH(s)/PRACH resource(s) associated or specific or corresponding to the PN message—e.g., the PN message could be associated or specific or corresponding to the one or more TOs and/or UL channels/signals/resources (pre-)configured by the network, or alternatively/optionally, the one or more TOs and/or UL channels/signals/resources could be dynamically scheduled or assigned or granted by the network based on or according to or upon detection of the PN message. In addition, the PN message could be or could provide or indicate or contain or comprise or include an indicator indicating priority(s) or priority order(s) or priority value(s) for one or more of the report contents/quantities (and therefore, their corresponding/associated events as specified/defined herein in the present disclosure) associated or specific or corresponding to the PN message.
In one example, the PN message could be or could correspond to or provide or indicate or contain or comprise or include a priority value (e.g., 0, 1, . . . ) as defined herein in the present disclosure for the report content(s)/quantity(s) or the UEI report(s) associated or specific or corresponding to the PN message.
In another example, the PN message could be or could correspond to or provide or indicate or contain or comprise or include one or more priority values (e.g., 0's, 1's, . . . ) as defined herein in the present disclosure each associated/corresponding to one or more of the report contents/quantities (and therefore, the corresponding/associated events) in the UEI report(s) associated or specific or corresponding to the PN message.
In another example, the PN message could be or could correspond to or provide or indicate or contain or comprise or include indicator(s) indicating information related to the priority(s) or priority order(s) of the report content(s)/quantity(s) for one or more events in the UEI report(s) associated or specific or corresponding to the PN message. For instance, when/if a UE could transmit or send the UEI report(s), and therefore, the corresponding report content(s)/quantity(s) conveyed therein, for the event A and the event B following those specified herein in the present disclosure, the PN message corresponding or associated or specific to the UEI report(s) could be a one-bit indicator with ‘0’ (or ‘1’) indicating that the report content(s)/quantity(s) in the UEI report(s) associated or corresponding or specific to the event A according to those specified herein in the present disclosure could have a higher priority or priority order (or equivalently, a lower/smaller priority value) than that associated or corresponding or specific to the event B, and with ‘1’ (or ‘0’) indicating that the report content(s)/quantity(s) in the UEI report(s) associated or corresponding or specific to the event B according to those specified herein in the present disclosure could have a higher priority or priority order (or equivalently, a lower/smaller priority value) than that associated or corresponding or specific to the event A.

For a two-part UEI (beam) reporting (or a two-part UCI) as specified or defined herein in the present disclosure, the described or specified PN message herein could be in part 1 of the two-part UEI report (or the two-part UCI).

Throughout the present disclosure, a SSBRI or a CRI reported in a UEI report(s) as specified herein in the present disclosure could indicate or identify a candidate beam, and the SSBRI or the CRI could be signaled by the number (index) of entries in the corresponding CSI-SSB or NZP-CSI-RS ResourceSets identified or provided by a higher layer parameter/signaling, e.g., denoted by uei-ResourcePool, that provides or configures RS resources including SSB and/or CSI-RS resources for the UEI reporting. For instance, the higher layer parameter/signaling uei-ResourcePool could provide, comprise, contain, include, configure or indicate a list of SSB/CSI-RS resources for UEI reporting; each resource is configured with a physical cell ID (PCI) (e.g., a serving cell PCI or a serving cell index or a PCI/PCI index other than the serving cell PCI/PCI index/index) where the resource is configured for the UE. Furthermore, the higher layer parameter/signaling uei-ResourcePool could also indicate, provide or configure to the UE the maximum number of RS resources including SSB and/or CSI-RS resources configured for the UEI reporting, time and/or frequency domain resource allocation(s)/behaviors of the RS resources including SSB and/or CSI-RS resources configured for the UEI reporting, corresponding SSB and/or CSI-RS resource set(s)—e.g., in terms of their resource set ID(s)/index(es)—configured for the UEI reporting. Examples of the corresponding/related higher layer parameters for configuring UEI measurement and/or reporting are provided in Table 6.

TABLE 6
UEI-Config information element

-- ASN1START
-- TAG-UEI-CONFIG-START

| | |
|---|---|
| UEI-Config ::= | SEQUENCE { |

...

| | | |
|---|---|---|
| uei-Reporting | SetupRelease { UEI-Resource-Report-Config } | OPTIONAL, -- Need |

M
...
}
...

| | |
|---|---|
| UEI-Resource-Report-Config ::= | SEQUENCE { |

...,

| | |
|---|---|
| uei-ResourcePool | SEQUENCE (SIZE(1..maxUEI-Resources)) OF UEI-Resource, |

...
}

| UEI-Resource ::= | SEQUENCE { | |
|---|---|---|
| uei-ResourceId | INTEGER (1..maxUEI-Resources), | |
| cell | ServCellIndex | OPTIONAL, -- Need R |

| | |
|---|---|
| uei-ReferenceSignal | CHOICE { |
| uei-csi-RS-Resource | NZP-CSI-RS-ResourceId, |
| uei-ssb-Resource | SSB-Index |

}
}

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

Throughout the present disclosure, a CSI/beam report can also be referred to as or equivalent to a UE-initiated (UEI) report of (report-)type (A), (report-)type (B) and/or (report-)type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 configured grant (CG) PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a physical downlink control channel (PDCCH) or a physical downlink shared channel (PDSCH). As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH dedicated PUCCH resources.

In a single-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

In one embodiment, the resource indicator(s) including SSBRI(s) and/or CRI(s) for the current serving beam(s) and the resource indicator(s) including SSBRI(s) and/or CRI(s) for the candidate beam(s), reported in the same UEI report or in different/separate UEI reports, could be determined/selected from the same RS resource set (e.g., the same SSB resource set or the same NZP CSI-RS resource set). Alternatively, the resource indicator(s) including SSBRI(s) and/or CRI(s) for the current serving beam(s) could be determined/selected from a first RS resource set (e.g., a first SSB resource set or a first NZP CSI-RS resource set) configured for reporting the serving beam(s), and the resource indicator(s) including SSBRI(s) and/or CRI(s) for the candidate beam(s), could be determined/selected from a second RS resource set (e.g., a second SSB resource set or a second NZP CSI-RS resource set) configured for reporting the candidate beam(s), wherein the resource indicators for the serving beam(s) and the candidate beam(s) could be reported in the same UEI report or in different/separate UEI reports, and the first and second RS resource sets could be the same/identical or different. If the first and second RS resource sets are different, (1) in one example, the bitwidth of the RS indexes in the first RS resource set is computed with respect to the total number K of RS resources configured in the first set, i.e., log 2 (K) or floor(log 2 (K)) or ceil(log 2 (K)) bit(s), and the bitwidth of the RS indexes in the second RS resource set is computed with respect to the total number L of RS resources configured in the second set, i.e., log 2 (L) or floor(log 2 (L)) or ceil(log 2 (L)) bit(s), and/or (2) in another example, the bitwidth of the RS indexes in the first RS resource set is computed with respect to the total number (K+L) of RS resources configured in both the first and second sets, i.e., log 2 (K+L) or floor(log 2 (K+L)) or ceil(log 2 (K+L)) bit(s), and the bitwidth of the RS indexes in the second RS resource set is computed with respect to the total number (K+L) of RS resources configured in both the first and second sets, i.e., log 2 (K+L) or floor(log 2 (K+L)) or ceil(log 2 (K+L)) bit(s).

The design examples and procedures specified herein in the present disclosure could be conducted/performed under the condition that the UE-initiated reporting or the UE-initiated beam management is enabled—e.g., via network's configuration(s)/indication(s) through higher layer RRC signaling(s)/parameter(s) and/or MAC CE command(s) and/or dynamic DCI based L1 signaling(s) based on or according to a corresponding UE's capability or capability signaling(s).

In one embodiment, a UE could be provided, for each bandwidth part (BWP) of a serving cell, a serving beam(s) set s̅₀ of (periodic) CSI-RS resource configuration indexes and/or synchronization signal/physical broadcast channel (SS/PBCH) block indexes by currentServBeamRSList for monitoring/assessing the radio link and/or beam qualities for the current serving beam(s) according to those specified herein in the present disclosure. The serving beam(s) set s̅₀ of (periodic) CSI-RS resource configuration indexes and/or SS/PBCH block indexes could be provided in higher layer parameter(s) CSI-ReportConfig, CSI-ResourceConfig, nzp-CSI-RS-ResourceSet, CSI-SSB-ResourceSet, and/or higher layer parameter(s) UEI-ReportConfig, UEI-ResourceConfig and/or etc. dedicated/configured for the UEI reporting as specified herein in the present disclosure. Furthermore, the UE could be provided/indicated/configured by the network, e.g., via higher layer RRC signalling(s)/parameter(s) and/or MAC CE command(s) and/or dynamic DCI based L1 signaling(s), which one or more of the RS resources in the serving beam(s) set s̅₀—i.e., a subset of the RS resources provided in the serving beam(s) set s̅₀—the UE could measure for the UEI reporting.
In one example, the UE could (or could be configured to) measure the RS resources provided/indicated/configured in the serving beam(s) set s̅₀ for the UEI beam reporting according to those specified herein in the present disclosure.
In another example, the UE could measure the first (or last) S≥1 RS resource(s) or transmission occasion(s) TO(s) among the RS resource(s)/TO(s) provided in the serving beam(s) set go. The value of S could be provided/indicated/configured to the UE, e.g., via higher layer RRC signalling(s)/parameter(s) and/or MAC CE command(s) and/or dynamic DCI based L1 signaling(s) based on or according to a corresponding UE's capability or capability signalling. Optionally, the value of S could be fixed in system specification(s).
In another example, the UE could be provided/indicated/configured by the network, e.g., via higher layer RRC signalling(s)/parameter(s) and/or MAC CE command(s) and/or dynamic DCI based L1 signaling(s), RS resource index(es) of the subset of the RS resource(s)—from/among the RS resources or RS resource indexes in the serving beam(s) set s̅₀—the UE could measure for the UEI reporting.
In another example, the UE could be provided/indicated/configured by the network, e.g., via higher layer RRC signalling(s)/parameter(s) and/or MAC CE command(s) and/or dynamic DCI based L1 signaling(s), a bitmap with each bit position/entry of the bitmap corresponding/associated to a RS/RS resource provided/configured in the serving beam(s) set s̅₀. For instance, the bitmap could be provided/configured in the same higher layer parameter(s)/signalling(s) that provides/configures the serving beam(s) set s̅₀. When/if an entry/bit position of the bitmap is set to ‘1’ (or ‘0’), the RS or RS resource or RS resource index in the serving beam(s) set s̅₀ corresponding/associated to the entry/bit position could be used for measurement for the UEI reporting.
In another example, each of the RSs, RS resources or RS resource indexes in the serving beam(s) set s̅₀ could be associated with a one-bit indicator, wherein the one-bit indicator(s) could be provided/configured in the same higher layer parameter(s)/signalling(s) that provides/configures the serving beam(s) set s̅₀. When/if a one-bit indicator is set to ‘1’ (or ‘0’), the RS or RS resource or RS resource index in the serving beam(s) set s̅₀ corresponding/associate to the one-bit indicator could be used for measurement for the UEI reporting.

In addition, the serving beam(s) set s̅₀ could be periodic, semi-persistent and/or aperiodic. For semi-persistent or aperiodic, the serving beam(s) set s̅₀ (and therefore, the corresponding RS resource indexes provided therein) could be activated or triggered via DCI (e.g., via the ‘CSI request’ field and associated to the corresponding CSI triggering state(s) and/or CSI resource setting(s) and/or CSI reporting setting(s)) after/upon (e.g., after a time window/periodic, e.g., corresponding to a fixed value in system specifications and/or configured/provided by the network) reception or detection of the PN message (or UEI report(s)) transmitted or sent from/by the UE. That is, in this case, transmission of the PN message (or the corresponding UEI report(s)) also activates or triggers the semi-persistent or aperiodic transmission(s) of the serving beam(s) set s̅₀.
In one example, after a certain time period or when a timer has expired, the semi-statically activated or aperiodically triggered measurement RSs in the serving beam(s) set s̅₀ could be deactivated or no longer used for measurement for the UEI reporting. In this case, the UE could be provided/indicated/configured by the network, e.g., via higher layer RRC signalling(s)/parameter(s) and/or MAC CE command(s) and/or dynamic DCI based L1 signaling(s) based on or according to a UE's capability or capability signalling, the time period and/or the timer.
In another example, the UE could indicate to the network (e.g., send a PN message, a UEI report(s), a scheduling request (SR) or a SR-like signal) to deactivate or turn off the transmission(s) of the semi-statically activated or aperiodically triggered measurement RSs in the serving beam(s) set go.

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s).

For the set s̅₀, the UE (e.g., the UE 116) could assess the radio link or beam qualities only according to SS/PBCH blocks on the primary cell (PCell) or the primary secondary cell (PSCell) or (periodic) CSI-RS resource configurations that are quasi co-located with the RS index(es) in the RS set(s) in one or more indicated TCI states under the unified TCI framework as specified herein in the present disclosure and/or DM-RS(s) of the PDCCH/PDSCH reception(s)—in this case, if there are two RS indexes in a TCI state, the RS index(es) configured with qcl-Type set to ‘typeD’ for the corresponding TCI state(s) is used or applied for assessing the radio link or beam quality(s) for the set go. Here, the one or more indicated TCI states could be joint, DL and/or UL TCI state(s) provided by TCI-State(s) and/or TCI-UL-State(s) depending on the UEI report content(s)/quantity(s) and/or network's configuration(s)/indication(s) via higher layer RRC signalling(s)/parameter(s) and/or MAC CE command(s) and/or dynamic DCI based L1 signaling(s) according to or based on a corresponding UE's capability or capability signalling. Optionally, the UE could receive from the network a MAC CE to update one or more of the RS resource indexes in the serving beam(s) set s̅₀, and/or to update the RS resource indexes in the serving beam(s) set s̅₀, and/or to indicate one or more RS resource indexes, e.g., from a higher layer configured set of RS resource indexes (denoted by currentServSet), for measurement for the UEI reporting. For example, the MAC CE could correspond to UEI-RS Indication MAC CE is identified by a MAC subheader with extended logical channel ID (eLCID). It could have a variable size, and includes a number of RS ID fields, e.g., a UEI-RS-ID₀ field and a UEI-RS-ID₁ field (optional) of currentServSet. It has a variable size including following fields:
Serving Cell ID: This field indicates the identity of the Serving Cell for which the MAC CE applies. The length of the field is 5 bits;
BWP ID: This field indicates a DL BWP for which the MAC CE applies as the codepoint of the DCI bandwidth part indicator field as specified in the 3GPP TS 38.213 [REF3]. The length of the BWP ID field is 2 bits;
S: This field indicates the presence of the octet containing the UEI-RS ID₁ of the same serving beam(s) RS set s̅₀. The S field set to 1 indicates that the octet containing UEI-RS ID₁ is included. The S field set to 0 indicates that the octet containing the UEI-RS ID₁ of the same serving beam(s) RS set s̅₀ is not included;
UEI-RS ID₁: This field indicates the RS resource from currentServSet as specified herein in the present disclosure;
R: Reserved bit, set to 0.

If the UE is not provided so by currentServBeamRSList for a BWP of the serving cell and/or the UEI-RS Indication MAC CE as specified herein in the present disclosure, the UE could determine the serving beam(s) set s̅₀ to include periodic CSI-RS resource configuration indexes and/or SSB indexes with same values as the RS indexes in the RS sets indicated by the one or more TCI states under the unified TCI framework and/or DM-RS(s) of the PDCCH/PDSCH reception(s)—in this case, if there are two RS indexes in a TCI state, the set s̅₀ could include RS index(es) configured with qcl-Type set to ‘typeD’ for the corresponding TCI state(s). Here, the one or more indicated TCI states could be joint, DL and/or UL TCI state(s) provided by TCI-State(s) and/or TCI-UL-State(s) depending on the UEI report content(s)/quantity(s) and/or network's configuration(s)/indication(s) via higher layer RRC signalling(s)/parameter(s) and/or MAC CE command(s) and/or dynamic DCI based L1 signaling(s) according to or based on a corresponding UE's capability or capability signalling.

The UE could expect the serving beam(s) set s̅₀ to include up to a number of N_{UEI} RS indexes indicated by maxUEI-RS-resourcesPerSetPerBWP. The UE could expect single port RS in the serving beam(s) set s̅₀. Optionally, the UE could expect single-port or two-port CSI-RS with frequency density equal to 1 or 3 REs per resource block (RB) in the serving beam(s) set s̅₀. The physical layer in the UE could assess the radio link or beam quality according to the set s̅₀ of resource configurations against a threshold Q_{out,serv}, wherein the value of the threshold Q_{out,serv} could be provided/indicated/configured to the UE by the network, e.g., via higher layer RRC signalling(s)/parameter(s) and/or MAC CE command(s) and/or dynamic DCI based L1 signaling(s). The UE could apply the Q_{out,serv} threshold to the RSRP/SINR measurement, e.g., the L1-RSRP/L1-SINR measurement, obtained from a SS/PBCH block, and the UE could apply the Q_{out,serv} threshold to the RSRP/SINR measurement, e.g., the L1-RSRP/L1-SINR measurement, obtained for a CSI-RS resource after scaling a respective CSI-RS reception power with a value provided by powerControlOffsetSS. In non-discontinuous reception (DRX) mode operation, the physical layer in the UE could provide an indication to higher layers when the radio link or beam quality(s) for corresponding resource configurations in the serving beam(s) set s̅₀ that the UE uses to assess the radio link or beam quality(s) is worse than the threshold Q_{out,serv}. The physical layer informs the higher layers when the radio link or beam quality(s) is worse than the threshold Q_{out,serv} with a periodicity determined by the maximum between the shortest periodicity among the SS/PBCH blocks on the PCell or the PSCell and/or the periodic CSI-RS configurations in the set s̅₀ that the UE uses to assess the radio link or beam quality(s) and 2 msec. In DRX mode operation, the physical layer provides an indication to higher layers when the radio link or beam quality(s) is worse than the threshold Q_{out,serv} with a predetermined periodicity. For a PCell or a PSCell or a SCell, upon request from higher layers, the UE could provide to higher layers the periodic CSI-RS configuration indexes and/or SS/PBCH block indexes from the set s̅₀ and the corresponding RSRP/SINR measurements, e.g., L1-RSRP/L1-SINR measurements, that are less than or equal to the Q_{out,serv} threshold. Optionally, for the PCell or the PSCell or the SCell, upon request from higher layers, the UE could indicate to higher layers whether there is at least one periodic CSI-RS configuration index or SS/PBCH block index from the set s̅₀ with corresponding RSRP/SINR measurements, e.g., the L1-RSRP/L1-SINR measurements, that is less than or equal to the Q_{out,serv} threshold, and provide the periodic CSI-RS configuration indexes and/or SS/PBCH block indexes from the set s̅₀ and the corresponding RSRP/SINR measurements including L1-RSRP/L1-SINR measurements that are less than or equal to the Q_{out,serv} threshold, if any. The information herein could also be sent or transmitted from the UE to the network in part of the UEI report(s)—e.g., as the UEI report content(s) or report quantity(s) as specified herein in the present disclosure, wherein the UEI report(s) could be sent via UCI or MAC CE over PUCCH and/or PUSCH and/or PRACH resource(s).

The corresponding MAC entity could or shall for each Serving Cell configured for UEI reporting according to those specified herein in the present disclosure (set A of conditions):

```
1> :
  2> if serving beam degradation instance indication has been received from lower layers:
    3> start or restart the servBeamDegradationDetectionTimer;
    3> increment serv_COUNTER by 1;
    3> if serv_COUNTER >= servBeamDegradationInstanceMaxCount:
```

| | |
|---|---|
| | 4> if the Serving Cell is SCell: |
| | 5> trigger a UEI (beam) reporting for this Serving Cell; |
| | 4> else if the Serving Cell is PSCell and, the secondary cell group (SCG) is deactivated: |
| | 5> if serving beam degradation of the PSCell has not been indicated to upper layers since the |
| | SCG was deactivated or since the deactivated SCG was last reconfigured with UEI-RS: |
| | 6> indicate serving beam(s) degradation of the PSCell to upper layers. |
| NOTE: | After serving beam(s) degradation is indicated to upper layers, the UE may stop the |
| | servBeamDegradationDetectionTimer and lower layer serving beam(s) degradation indication |
| | while serv_COUNTER >= servBeamDegradationInstanceMaxCount for the deactivated SCG. |
| | 4> else: |
| | 5> initiate a Random Access procedure on the SpCell. |

```
  2> if the servBeamDegradationDetectionTimer expires; or
  2> if servBeamDegradationDetectionTimer, servBeamDegradationInstanceMaxCount, or any of the
    reference signals used for UEI reporting is reconfigured by upper layers associated with this Serving
    Cell; or
  2> if the reference signal(s) associated with this Serving Cell used for serving beam(s) degradation
    detection is changed:
    3> set serv_COUNTER to 0.
  2> if the Serving Cell is SpCell and the Random Access procedure initiated for SpCell UEI reporting is
    successfully completed:
    3> set serv_COUNTER to 0;
    3> stop the ueiReportingTimer, if configured;
    3> regard the UE-initiated (UEI) reporting procedure successfully completed.
  2> else if the Serving Cell is SCell, and a PDCCH addressed to cell radio network temporary identifier
    (C-RNTI) indicating uplink grant for a new transmission is received for the hybrid automatic repeat
    request (HARQ) process used for the transmission of the MAC CE for UEI reporting which contains
    report content(s)/quantity(s) of this Serving Cell; or
  2> if the SCell is deactivated:
    3> set serv_COUNTER to 0;
    3> regard the UEI reporting procedure successfully completed and cancel the triggered UEI
      report(s) for this Serving Cell.
```

In the present disclosure, the serving beam(s) set s̅₀ could also correspond to a CSI resource set (including SSB resource set or NZP CSI-RS resource set provided in/associated to higher layer parameter(s) CSI-ReportConfig, CSI-ResourceConfig, nzp-CSI-RS-ResourceSet, CSI-SSB-ResourceSet, CSI-AssociatedReportConfgInfo and/or etc.) configured/provided/activated/triggered for (typical) CSI/beam reporting; optionally, one or more of the RS source indexes in the serving beam(s) set s̅₀ could correspond to one or more RS resource indexes in a CSI resource set (including SSB resource set or NZP CSI-RS resource set provided in/associated to higher layer parameter(s) CSI-ReportConfig, CSI-ResourceConfig, nzp-CSI-RS-ResourceSet, CSI-SSB-ResourceSet, CSI-AssociatedReportConfgInfo and/or etc.) configured/provided/activated/triggered for (typical) CSI/beam reporting. For example, the (typical) CSI resource set could correspond to a bidirectional forwarding detection (BFD) RS resource set, or a candidate RS resource set configured/determined in beam failure recovery procedure(s).

In one embodiment, a UE could be provided, for each BWP of a serving cell, a candidate beam(s) set s̅₁ of (periodic) CSI-RS resource configuration indexes and/or SS/PBCH block indexes by candidateBeamRSList for monitoring/assessing the radio link and/or beam qualities for one or more candidate beams according to those specified herein in the present disclosure. The candidate beam(s) set s̅₁ of (periodic) CSI-RS resource configuration indexes and/or SS/PBCH block indexes could be provided in higher layer parameter(s) CSI-ReportConfig, CSI-ResourceConfig, nzp-CSI-RS-ResourceSet, CSI-SSB-ResourceSet, and/or higher layer parameter(s) UEI-ReportConfig, UEI-ResourceConfig and/or etc. dedicated/configured for the UEI reporting as specified herein in the present disclosure. Furthermore, the UE could be provided/indicated/configured by the network, e.g., via higher layer RRC signalling(s)/parameter(s) and/or MAC CE command(s) and/or dynamic DCI based L1 signaling(s), which one or more of the RS resources in the candidate beam(s) set s̅₁—i.e., a subset of the RS resources provided in the candidate beam(s) set s̅₁—the UE could measure for the UEI reporting.
In one example, the UE could (or could be configured to) measure the RS resources provided/indicated/configured in the candidate beam(s) set s̅₁ for the UEI beam reporting according to those specified herein in the present disclosure.
In another example, the UE could measure the first (or last) S≥1 RS resource(s) or transmission occasion(s) TO(s) among the RS resource(s)/TO(s) provided in the candidate beam(s) set s̅₁. The value of S could be provided/indicated/configured to the UE, e.g., via higher layer RRC signalling(s)/parameter(s) and/or MAC CE command(s) and/or dynamic DCI based L1 signaling(s) based on or according to a corresponding UE's capability or capability signalling. Optionally, the value of S could be fixed in system specification(s).
In another example, the UE could be provided/indicated/configured by the network, e.g., via higher layer RRC signalling(s)/parameter(s) and/or MAC CE command(s) and/or dynamic DCI based L1 signaling(s), RS resource index(es) of the subset of the RS resource(s)—from/among the RS resources or RS resource indexes in the candidate beam(s) set s̅₁—the UE could measure for the UEI reporting.
In another example, the UE could be provided/indicated/configured by the network, e.g., via higher layer RRC signalling(s)/parameter(s) and/or MAC CE command(s) and/or dynamic DCI based L1 signaling(s), a bitmap with each bit position/entry of the bitmap corresponding/associated to a RS/RS resource provided/configured in the candidate beam(s) set s̅₁. For instance, the bitmap could be provided/configured in the same higher layer parameter(s)/signalling(s) that provides/configures the candidate beam(s) set s̅₁. When/if an entry/bit position of the bitmap is set to ‘1’ (or ‘0’), the RS or RS resource or RS resource index in the candidate beam(s) set s̅₁ corresponding/associated to the entry/bit position could be used for measurement for the UEI reporting.
In another example, each of the RSs, RS resources or RS resource indexes in the candidate beam(s) set s̅₁ could be associated with a one-bit indicator, wherein the one-bit indicator(s) could be provided/configured in the same higher layer parameter(s)/signalling(s) that provides/configures the candidate beam(s) set s̅₁. When/if a one-bit indicator is set to ‘1’ (or ‘0’), the RS or RS resource or RS resource index in the candidate beam(s) set s̅₁ corresponding/associate to the one-bit indicator could be used for measurement for the UEI reporting.

In addition, the candidate beam(s) set s̅₁ could be periodic, semi-persistent and/or aperiodic. For semi-persistent or aperiodic, the candidate beam(s) set s̅₁ (and therefore, the corresponding RS resource indexes provided therein) could be activated or triggered via DCI (e.g., via the ‘CSI request’ field and associated to the corresponding CSI triggering state(s) and/or CSI resource setting(s) and/or CSI reporting setting(s)) after/upon (e.g., after a time window/periodic, e.g., corresponding to a fixed value in system specifications and/or configured/provided by the network) reception or detection of the PN message (or UEI report(s)) transmitted or sent from/by the UE. That is, in this case, transmission of the PN message (or the corresponding UEI report(s)) also activates or triggers the semi-persistent or aperiodic transmission(s) of the candidate beam(s) set s̅₁.
In one example, after a certain time period or when a timer has expired, the semi-statically activated or aperiodically triggered measurement RSs in the candidate beam(s) set s̅₁ could be deactivated or no longer used for measurement for the UEI reporting. In this case, the UE could be provided/indicated/configured by the network, e.g., via higher layer RRC signalling(s)/parameter(s) and/or MAC CE command(s) and/or dynamic DCI based L1 signaling(s) based on or according to a UE's capability or capability signalling, the time period and/or the timer.
In another example, the UE could indicate to the network (e.g., send a PN message, a UEI report(s), a SR or a SR-like signal) to deactivate or turn off the transmission(s) of the semi-statically activated or aperiodically triggered measurement RSs in the candidate beam(s) set s̅₁.

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s).

For the set s̅₁, the UE could assess the radio link or beam qualities only according to SS/PBCH blocks on the PCell or the PSCell or (periodic) CSI-RS resource configurations that are quasi co-located with the RS index(es) in the RS set(s) in one or more indicated TCI states under the unified TCI framework as specified herein in the present disclosure and/or DM-RS(s) of the PDCCH/PDSCH reception(s)—in this case, if there are two RS indexes in a TCI state, the RS index(es) configured with qcl-Type set to ‘typeD’ for the corresponding TCI state(s) is used or applied for assessing the radio link or beam quality(s) for the set s̅₁. Here, the one or more indicated TCI states could be joint, DL and/or UL TCI state(s) provided by TCI-State(s) and/or TCI-UL-State(s) depending on the UEI report content(s)/quantity(s) and/or network's configuration(s)/indication(s) via higher layer RRC signalling(s)/parameter(s) and/or MAC CE command(s) and/or dynamic DCI based L1 signaling(s) according to or based on a corresponding UE's capability or capability signalling. Optionally, the UE could receive from the network a MAC CE to update one or more of the RS resource indexes in the candidate beam(s) set s̅₁, and/or to update the RS resource indexes in the candidate beam(s) set s̅₁, and/or to indicate one or more RS resource indexes, e.g., from a higher layer configured set of RS resource indexes (denoted by candidateRSsSet), for measurement for the UEI reporting. For example, the MAC CE could correspond to cand-RS Indication MAC CE is identified by a MAC subheader with eLCID. It could have a variable size, and includes a number of RS ID fields, e.g., a cand-RS-ID₀ field and a cand-RS-ID₁ field (optional) of candidateRSsSet. It has a variable size including following fields:
Serving Cell ID: This field indicates the identity of the Serving Cell for which the MAC CE applies. The length of the field is 5 bits;
BWP ID: This field indicates a DL BWP for which the MAC CE applies as the codepoint of the DCI bandwidth part indicator field as specified in the 3GPP TS 38.213 [REF3]. The length of the BWP ID field is 2 bits;
S: This field indicates the presence of the octet containing the cand-RS ID₁ of the same candidate beam(s) RS set s̅₁. The S field set to 1 indicates that the octet containing cand-RS ID₁ is included. The S field set to 0 indicates that the octet containing the cand-RS ID₁ of the same candidate beam(s) RS set s̅₁ is not included;
cand-RS IDᵢ: This field indicates the RS resource from candidateRSsSet as specified herein in the present disclosure;
R: Reserved bit, set to 0.

If the UE is not provided s̅₁ by candidateBeamRSList for a BWP of the serving cell and/or the cand-RS Indication MAC CE as specified herein in the present disclosure, the UE could determine the candidate beam(s) set s̅₁ to include periodic CSI-RS resource configuration indexes and/or SSB indexes with same values as the RS indexes in the RS sets indicated by the one or more TCI states under the unified TCI framework and/or DM-RS(s) of the PDCCH/PDSCH reception(s)—in this case, if there are two RS indexes in a TCI state, the set s̅₁ could include RS index(es) configured with qcl-Type set to ‘typeD’ for the corresponding TCI state(s). Here, the one or more indicated TCI states could be joint, DL and/or UL TCI state(s) provided by TCI-State(s) and/or TCI-UL-State(s) depending on the UEI report content(s)/quantity(s) and/or network's configuration(s)/indication(s) via higher layer RRC signalling(s)/parameter(s) and/or MAC CE command(s) and/or dynamic DCI based L1 signaling(s) according to or based on a corresponding UE's capability or capability signalling.

The UE could expect the candidate beam(s) set s̅₁ to include up to a number of N_{cand} RS indexes indicated by maxCand-RS-resourcesPerSetPerBWP. The UE could expect single port RS in the candidate beam(s) set s̅₁. Optionally, the UE could expect single-port or two-port CSI-RS with frequency density equal to 1 or 3 REs per RB in the candidate beam(s) set s̅₁. The physical layer in the UE could assess the radio link or beam quality according to the set s̅₁ of resource configurations against a threshold Q₁,cand, wherein the value of the threshold Q_{in,cand} could be provided/indicated/configured to the UE by the network, e.g., via higher layer RRC signalling(s)/parameter(s) and/or MAC CE command(s) and/or dynamic DCI based L1 signaling(s). The UE could apply the Q_{in,cand} threshold to the RSRP/SINR measurement, e.g., the L1-RSRP/L1-SINR measurement, obtained from a SS/PBCH block, and the UE could apply the Q_{in,cand} threshold to the RSRP/SINR measurement, e.g., the L1-RSRP/L1-SINR measurement, obtained for a CSI-RS resource after scaling a respective CSI-RS reception power with a value provided by powerControlOffsetSS. In non-DRX mode operation, the physical layer in the UE could provide an indication to higher layers when the radio link or beam quality(s) for corresponding resource configurations in the candidate beam(s) set s̅₁ that the UE uses to assess the radio link or beam quality(s) is larger than or equal to the threshold Q_{in,cand}. The physical layer informs the higher layers when the radio link or beam quality(s) is larger than or equal to the threshold Q_{in,cand} with a periodicity determined by the maximum between the shortest periodicity among the SS/PBCH blocks on the PCell or the PSCell and/or the periodic CSI-RS configurations in the set s̅₁ that the UE uses to assess the radio link or beam quality(s) and 2 msec. In DRX mode operation, the physical layer provides an indication to higher layers when the radio link or beam quality(s) is larger than or equal to the threshold Q_{in,cand} with a predetermined periodicity. For a PCell or a PSCell or a SCell, upon request from higher layers, the UE could provide to higher layers the periodic CSI-RS configuration indexes and/or SS/PBCH block indexes from the set s̅₁ and the corresponding RSRP/SINR measurements, e.g., L1-RSRP/L1-SINR measurements, that are larger than or equal to the Q_{in,cand} threshold. Optionally, for the PCell or the PSCell or the SCell, upon request from higher layers, the UE could indicate to higher layers whether there is at least one periodic CSI-RS configuration index or SS/PBCH block index from the set s̅₁ with corresponding RSRP/SINR measurements, e.g., the L1-RSRP/L1-SINR measurements, that is larger than or equal to the Q_{in,cand} threshold, and provide the periodic CSI-RS configuration indexes and/or SS/PBCH block indexes from the set s̅₁ and the corresponding RSRP/SINR measurements including L1-RSRP/L1-SINR measurements that are larger than or equal to the Q_{in,cand} threshold, if any. The information herein could also be sent or transmitted from the UE to the network in part of the UEI report(s)—e.g., as the UEI report content(s) or report quantity(s) as specified herein in the present disclosure, wherein the UEI report(s) could be sent via UCI or MAC CE over PUCCH and/or PUSCH and/or PRACH resource(s).

The corresponding MAC entity could or shall for each Serving Cell configured for UEI reporting according to those specified herein in the present disclosure (set B of conditions):

```
1> :
  2> if candidate beam(s) identification instance indication has been received from lower layers:
    3> start or restart the candBeamDetectionTimer;
    3> increment cand_COUNTER by 1;
    3> if cand_COUNTER >= candBeamIdentificationInstanceMaxCount:
```

| | |
|---|---|
| | 4> if the Serving Cell is SCell: |
| | 5> trigger a UEI (beam) reporting for this Serving Cell; |
| | 4> else if the Serving Cell is PSCell and, the SCG is deactivated: |
| | 5> if candidate beam(s) identification of the PSCell has not been indicated to upper layers |
| | since the SCG was deactivated or since the deactivated SCG was last reconfigured with |
| | cand-RS: |
| | 6> indicate candidate beam(s) identification of the PSCell to upper layers. |
| NOTE: | After candidate beam(s) identification is indicated to upper layers, the UE may stop the |
| | candBeamDetectionTimer and lower layer candidate beam(s) identification indication while |
| | cand_COUNTER >= candBeamIdentificationInstanceMaxCount for the deactivated SCG. |
| | 4> else: |
| | 5> initiate a Random Access procedure on the SpCell. |

```
  2> if the candBeamDetectionTimer expires; or
  2> if candBeamDetectionTimer, candBeamIdentificationInstanceMaxCount, or any of the reference
    signals used for UEI reporting is reconfigured by upper layers associated with this Serving Cell; or
  2> if the reference signal(s) associated with this Serving Cell used for candidate beam(s) identification
    is changed:
    3> set cand_COUNTER to 0.
  2> if the Serving Cell is SpCell and the Random Access procedure initiated for SpCell UEI reporting is
    successfully completed:
    3> set cand_COUNTER to 0;
    3> stop the ueiReportingTimer, if configured;
    3> regard the UE-initiated (UEI) reporting procedure successfully completed.
  2> else if the Serving Cell is SCell, and a PDCCH addressed to C-RNTI indicating uplink grant for a
    new transmission is received for the HARQ process used for the transmission of the MAC CE for
    UEI reporting which contains report content(s)/quantity(s) of this Serving Cell; or
  2> if the SCell is deactivated:
    3> set cand_COUNTER to 0;
    3> regard the UEI reporting procedure successfully completed and cancel the triggered UEI
      report(s) for this Serving Cell.
```

In the present disclosure, triggering of the UEI reporting could depend on one or more conditions in the set A of conditions and/or set B of conditions as specified/described herein in the present disclosure.

As specified herein in the present disclosure, the UEI report(s) could also comprise one or more indicators to indicate presence/absence of current serving beam(s) as specified/defined herein in the present disclosure in the UEI report(s). In one example, the indicator(s) could be one-bit indicator(s), and when/if the one-bit indicator(s) is set to ‘1’ (‘0’), report content(s)/quantity(s) such as resource indicator(s) and/or corresponding beam metric(s) for the current serving beam(s) could be present in the UEI report(s); otherwise, i.e., when/if the one-bit indicator(s) is set to ‘0’ (or ‘1’), report content(s)/quantity(s) such as resource indicator(s) and/or corresponding beam metric(s) for the current serving beam(s) could be absent from the UEI report(s). As specified herein in the present disclosure, the UEI report(s) could also comprise one or more indicators to indicate presence/absence of candidate beam(s) as specified/defined herein in the present disclosure in the UEI report(s). In one example, the indicator(s) could be one-bit indicator(s), and when/if the one-bit indicator(s) is set to ‘1’ (‘0’), report content(s)/quantity(s) such as resource indicator(s) and/or corresponding beam metric(s) for the identified candidate beam(s) could be present in the UEI report(s); otherwise, i.e., when/if the one-bit indicator(s) is set to ‘0’ (or ‘1’), report content(s)/quantity(s) such as resource indicator(s) and/or corresponding beam metric(s) for the identified candidate beam(s) could be absent from the UEI report(s).

In one example, the UEI report(s) as specified herein in the present disclosure could comprise one or more set indexes, wherein set index 0 (or 1) could correspond to the serving beam(s) set s̅₀ (or the candidate beam(s) set s̅₁), and set index 1 (or 2) could correspond to the candidate beam(s) set s̅₁ (or the serving beam(s) set s̅₀).
In one example, the UEI report(s) as specified herein in the present disclosure could comprise a set index, wherein the set index could correspond to the serving beam(s) set s̅₀ or the candidate beam(s) set s̅₁, from which the reference RSRP/SINR value or the largest measured RSRP/SINR value as specified herein in the present disclosure is determined/selected.
In another example, when/if both the serving beam(s) set s̅₀ and the candidate beam(s) set s̅₁ are configured, provided or determined, each of the report contents/report quantities in the UEI report(s) could be associated/corresponding to a set index provided/indicated in the same UEI report(s). As specified/described herein in the present disclosure, each reported set index could indicate the serving beam(s) set s̅₀ or the candidate beam(s) set s̅₁ from which the associated/corresponding report content(s)/quantity(s) including resource indicator(s) and their associated/corresponding beam metric(s) are determined or selected.

According to those specified herein in the present disclosure, the one or more indicated TCI states (and therefore, the corresponding RS resource indexes in the RS resource sets indicated/provided therein) used for determining the RS resource indexes in the serving beam(s) set s̅₀ and/or the candidate beam(s) set s̅₁ could correspond to:
The applied unified joint/DL/UL TCI state(s)—e.g., indicated by the TCI codepoint of the TCI field in the beam indication DCI format 1_1/1_2 with or without DL assignment—for various DL and/or UL channels and/or signals according to those specified herein in the present disclosure
The TCI state(s) activated in/by (unified) TCI state(s) activation/deactivation MAC CE command
The TCI state(s) higher layer configured/provided by the network, e.g., by jointDLTCIState-List and/or TCI-UL-StateList
One or more TCI states or TCI state IDs, e.g., among the higher layer configured list(s) of TCI state(s) and/or the TCI state(s) activated in the (unified) TCI state(s) activation/deactivation MAC CE command, provided/configured/indicated by the network, e.g., via higher layer RRC signalling(s)/parameter(s) and/or MAC CE command(s) and/or dynamic DCI based L1 signaling(s)

As specified herein in the present disclosure, a UE (e.g., the UE 116) could be respectively configured/provided by the network, or could (or could be configured to) respectively determine the two sets—serving beam(s) set s̅₀ and/or the candidate beam(s) set s̅₁. Alternatively, a UE could be configured/provided by the network, or could (or could be configured to) determine a single RS set comprising RS resource index(es) for serving beam(s) and/or candidate beam(s) according to those specified herein in the present disclosure. Whether two sets of serving beam(s) set and candidate beam(s) set or a single set of serving beam(s) and/or candidate beam(s) RS resources could be applied/used for the UEI measurement and reporting could be provided/configured/indicated by the network, e.g., via higher layer RRC signalling(s)/parameter(s) and/or MAC CE command(s) and/or dynamic DCI based L1 signaling(s) according to or based on a corresponding UE's capability or capability signalling.

TABLE 7
TCI-State information element

-- ASN1START
-- TAG-TCI-STATE-START

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

| | |
|---|---|
| resourcesForCandidateBeams | CHOICE { |
| nzp-CSI-RS-Resources | SEQUENCE (SIZE (1..maxNrofNZP-CSI-RS-ResourcesPerSet)) OF |

NZP-CSI-RS-ResourceId,

| | |
|---|---|
| csi-SSB-ResourceList | SEQUENCE (SIZE(1..maxNrofCSI-SSB-ResourcePerSet)) OF SSB- |

```
Index
  },
    ...,
}
```

TABLE 8
TCI-State information element

-- ASN1START
-- TAG-TCI-STATE-START

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- Need R |

| | |
|---|---|
| candidateBeamRSSet-s1 | SEQUENCE (SIZE(1..maxNrofCandidateBeamsPerSet)) OF |
| CandidateBeamRS | OPTIONAL, -- Need M |

...,
}

| | |
|---|---|
| CandidateBeamRS ::= | SEQUENCE { |
| candidateBeamConfig | CHOICE { |
| ssb | SSB-Index, |
| csi-RS | NZP-CSI-RS-ResourceId |

},

| | | |
|---|---|---|
| servingCellId | ServCellIndex | OPTIONAL -- Need R |

}

In one embodiment, as specified herein in the present disclosure, a current serving beam could correspond to or could be specific, associated or corresponding to a RS resource configuration—e.g., a periodic CSI-RS resource configuration and/or a SSB resource—provided in an indicated joint/DL/UL TCI state (e.g., as the corresponding QCL source RS resource) such that a UE could determine the serving beam(s) set s̅₀ to include periodic CSI-RS resource configuration indexes and/or SSB indexes with same values as the RS indexes in the RS sets indicated by one or more TCI states under the unified TCI framework, wherein the one or more indicated TCI states could be joint, DL and/or UL TCI state(s) provided by TCI-State(s) and/or TCI-UL-State(s) depending on the UEI report content(s)/quantity(s) and/or network's configuration(s)/indication(s) via higher layer RRC signalling(s)/parameter(s) and/or MAC CE command(s) and/or dynamic DCI based L1 signaling(s) according to or based on a corresponding UE's capability or capability signalling—in this case, if there are two RS indexes in a TCI state, the set s̅₀ could include RS index(es) configured with qcl-Type set to ‘typeD’ for the corresponding TCI state(s). Optionally, the UE could assess the radio link or beam quality(s) as specified/defined herein in the present disclosure for one or more current serving beams (e.g., from/in the serving beam(s) set s̅₀) according to SS/PBCH blocks on the PCell or the PSCell or (periodic) CSI-RS resource configurations that are quasi co-located with the RS index(es) in the RS set(s) in one or more indicated TCI states under the unified TCI framework as specified herein in the present disclosure, wherein the one or more indicated TCI states could be joint, DL and/or UL TCI state(s) provided by TCI-State(s) and/or TCI-UL-State(s) depending on the UEI report content(s)/quantity(s) and/or network's configuration(s)/indication(s) via higher layer RRC signalling(s)/parameter(s) and/or MAC CE command(s) and/or dynamic DCI based L1 signaling(s) according to or based on a corresponding UE's capability or capability signalling—in this case, if there are two RS indexes in a TCI state, the RS index(es) configured with qcl-Type set to ‘typeD’ for the corresponding TCI state(s) is or used or applied for assessing the radio link or beam quality(s) for the one or more current serving beams (e.g., from/in the serving beam(s) set 9o). In this case, the higher layer parameter(s) including TCI-State(s) and/or TCI-UL-State(s) that provides or configures the one or more indicated joint/DL/UL TCI states could provide or configure or comprise or include or contain information, configuration(s) and/or indication(s) related to RS resource configuration(s)/RS resource configuration index(es) associated or corresponding or specific to one or more candidate beams defined/specified herein in the present disclosure.
In one example, the higher layer parameter(s) including TCI-State(s) and/or TCI-UL-State(s) that provides or configures the one or more indicated joint/DL/UL TCI states could provide or configure or comprise or include or contain one or more RS resource configuration indexes/IDs including one or more (periodic) CSI-RS resource configuration indexes and/or one or more SSB indexes—one conceptual example is presented in Table 7. For this design example, the UE could assess the radio link or beam quality(s) of the RS(s) or RS resource(s) including (periodic) CSI-RS(s) or CSI-RS resource(s) and/or SSB(s) corresponding to the one or more RS resource configuration indexes/IDs provided or configured in/by the one or more indicated joint/DL/UL TCI states (via their associated/corresponding higher layer parameter(s) TCI-State(s) and/or TCI-UL-State(s)) for the candidate beam(s) or as the radio link or beam quality(s) of the candidate beam(s) for triggering or initiating a UEI reporting according to or following those specified herein in the present disclosure (e.g., for detecting and/or declaring one or more of the events specified herein in the present disclosure). In addition, when/if inter-cell beam reporting (or beam management in general) is enabled—e.g., when/if the UE is higher layer provided or configured information related to PCI(s) other than the serving cell PCI and/or RS resource configuration(s) for PCI(s) other than the serving cell PCI, the higher layer parameter(s) including TCI-State(s) and/or TCI-UL-State(s) that provides or configures the one or more indicated joint/DL/UL TCI states could also provide or configure or comprise or include or contain one or more PCI values or PCI indexes each associated or corresponding or specific to a RS resource configuration index/ID provided/configured in the same indicated joint/DL/UL TCI state(s) provided by the same higher layer parameter(s)/signalling(s) TCI-State(s) and/or TCI-UL-State(s). Here, a PCI index could point to an entry of a list of candidate PCI values higher layer configured/provided to the UE.
In another example, the higher layer parameter(s) including TCI-State(s) and/or TCI-UL-State(s) that provides or configures the one or more indicated joint/DL/UL TCI states could provide or configure or comprise or include or contain a candidate beam(s) set s̅₁ comprising one or more RS resource configuration indexes/IDs including one or more (periodic) CSI-RS resource configuration indexes and/or one or more SSB indexes—one conceptual example is provided in Table 8. For this design example, the UE could assess the radio link or beam quality(s) of the RS(s) or RS resource(s) including (periodic) CSI-RS(s) or CSI-RS resource(s) and/or SSB(s) corresponding to the one or more RS resource configuration indexes/IDs in the candidate beam(s) set s̅₁ provided or configured in/by the one or more indicated joint/DL/UL TCI states (via their associated/corresponding higher layer parameter(s) TCI-State(s) and/or TCI-UL-State(s)) for the candidate beam(s) or as the radio link or beam quality(s) of the candidate beam(s) for triggering or initiating a UEI reporting according to or following those specified herein in the present disclosure (e.g., for detecting and/or declaring one or more of the events specified herein in the present disclosure). In addition, when/if inter-cell beam reporting (or beam management in general) is enabled—e.g., when/if the UE is higher layer provided or configured information related to PCI(s) other than the serving cell PCI and/or RS resource configuration(s) for PCI(s) other than the serving cell PCI, the higher layer parameter(s) including TCI-State(s) and/or TCI-UL-State(s) that provides or configures the one or more indicated joint/DL/UL TCI states and/or the candidate beam(s) set s̅₁ could also provide or configure or comprise or include or contain one or more PCI values or PCI indexes each associated or corresponding or specific to a RS resource configuration index/ID in the same candidate beam(s) set s̅₁ provided/configured in the same indicated joint/DL/UL TCI state(s) provided by the same higher layer parameter(s)/signalling(s) TCI-State(s) and/or TCI-UL-State(s). Here, a PCI index could point to an entry of a list of candidate PCI values higher layer configured/provided to the UE.
In another example, the higher layer parameter(s) including TCI-State(s) and/or TCI-UL-State(s) that provides or configures the one or more indicated joint/DL/UL TCI states could provide or configure or comprise or include or contain one or more of the followings.
   A CSI/RS resource set index/ID: for example, the CSI/RS resource set index/ID could correspond or point to a CSI/RS resource(s) set of one or more RS resource configuration indexes/IDs including one or more (periodic) CSI-RS resource configuration indexes and/or one or more SSB indexes configured/provided for the UEI beam reporting (e.g., via/by/in a higher layer parameter UEI-ResourceSet); for another example, the CSI/RS resource set index/ID could correspond or point to a CSI/RS resource(s) set configured or provided for typical CSI/beam reporting, wherein the CSI/RS resource(s) set could correspond to a NZP CSI-RS resource set provided by nzp-CSI-RS-ResourceSet or a SSB resource set provided by CSI-SSB-ResourceSet. For this design example, the UE could assess the radio link or beam quality(s) of the RS(s) or RS resource(s) including (periodic) CSI-RS(s) or CSI-RS resource(s) and/or SSB(s) corresponding to the one or more RS resource configuration indexes/IDs in the CSI/RS resource(s) set with the corresponding CSI/RS resource set index/ID provided or configured in/by the one or more indicated joint/DL/UL TCI states (via their associated/corresponding higher layer parameter(s) TCI-State(s) and/or TCI-UL-State(s)) for the candidate beam(s) or as the radio link or beam quality(s) of the candidate beam(s) for triggering or initiating a UEI reporting according to or following those specified herein in the present disclosure (e.g., for detecting and/or declaring one or more of the events specified herein in the present disclosure). In addition, when/if inter-cell beam reporting (or beam management in general) is enabled—e.g., when/if the UE is higher layer provided or configured information related to PCI(s) other than the serving cell PCI and/or RS resource configuration(s) for PCI(s) other than the serving cell PCI, the higher layer parameter(s) including TCI-State(s) and/or TCI-UL-State(s) that provides or configures the one or more indicated joint/DL/UL TCI states and/or the CSI/RS resource(s) set could also provide or configure or comprise or include or contain one or more PCI values or PCI indexes each associated or corresponding or specific to a RS resource configuration index/ID in the same CSI/RS resource(s) set with the corresponding CSI/RS resource set index/ID provided/configured in the same indicated joint/DL/UL TCI state(s) provided by the same higher layer parameter(s)/signalling(s) TCI-State(s) and/or TCI-UL-State(s). Here, a PCI index could point to an entry of a list of candidate PCI values higher layer configured/provided to the UE, and the CSI/RS resource(s) set could be for periodic, semi-persistent or aperiodic CSI, beam or UEI reporting.
   A CSI/RS resource setting or configuration index/ID: for example, the CSI/RS resource setting or configuration index/ID could correspond or point to a CSI/RS resource(s) setting or configuration comprising one or more CSI/RS resource sets each comprising one or more RS resource configuration indexes/IDs including one or more (periodic) CSI-RS resource configuration indexes and/or one or more SSB indexes configured/provided for the UEI beam reporting (e.g., via/by/in a higher layer parameter UEI-ResourceConfig); for another example, the CSI/RS resource setting or configuration index/ID could correspond or point to a CSI/RS resource(s) setting or configuration configured or provided for typical CSI/beam reporting, wherein the CSI/RS resource(s) setting or configuration provided by CSI-ResourceConfig could comprise one or more NZP CSI-RS resource sets each provided by nzp-CSI-RS-ResourceSet or resourcesForChannel or one or more SSB resource sets each provided by CSI-SSB-ResourceSet. For this design example, the UE could assess the radio link or beam quality(s) of the RS(s) or RS resource(s) including (periodic) CSI-RS(s) or CSI-RS resource(s) and/or SSB(s) corresponding to the one or more RS resource configuration indexes/IDs in the CSI/RS resource(s) setting or configuration with the corresponding CSI/RS resource setting or configuration index/ID provided or configured in/by the one or more indicated joint/DL/UL TCI states (via their associated/corresponding higher layer parameter(s) TCI-State(s) and/or TCI-UL-State(s)) for the candidate beam(s) or as the radio link or beam quality(s) of the candidate beam(s) for triggering or initiating a UEI reporting according to or following those specified herein in the present disclosure (e.g., for detecting and/or declaring one or more of the events specified herein in the present disclosure). In addition, when/if inter-cell beam reporting (or beam management in general) is enabled—e.g., when/if the UE is higher layer provided or configured information related to PCI(s) other than the serving cell PCI and/or RS resource configuration(s) for PCI(s) other than the serving cell PCI, the higher layer parameter(s) including TCI-State(s) and/or TCI-UL-State(s) that provides or configures the one or more indicated joint/DL/UL TCI states and/or the CSI/RS resource(s) setting or configuration could also provide or configure or comprise or include or contain one or more PCI values or PCI indexes each associated or corresponding or specific to a RS resource configuration index/ID in the same CSI/RS resource(s) setting or configuration with the corresponding CSI/RS resource setting or configuration index/ID provided/configured in the same indicated joint/DL/UL TCI state(s) provided by the same higher layer parameter(s)/signalling(s) TCI-State(s) and/or TCI-UL-State(s). Here, a PCI index could point to an entry of a list of candidate PCI values higher layer configured/provided to the UE, and the CSI/RS resource(s) setting or configuration and/or the corresponding CSI/RS resource(s) set(s) could be for periodic, semi-persistent or aperiodic CSI, beam or UEI reporting.
   A CSI/RS reporting setting or configuration index/ID: for example, the CSI/RS reporting setting or configuration index/ID could correspond or point to a CSI/RS reporting setting or configuration associated to one or more CSI/RS resource(s) settings/configurations each comprising one or more CSI/RS resource sets each comprising one or more RS resource configuration indexes/IDs including one or more (periodic) CSI-RS resource configuration indexes and/or one or more SSB indexes configured/provided for the UEI beam reporting (e.g., via/by/in a higher layer parameter UEI-ReportConfig or UEI-AssociatedReportConfigInfo); for another example, the CSI/RS reporting setting or configuration index/ID could correspond or point to a CSI/RS reporting setting or configuration configured or provided for typical CSI/beam reporting, wherein the CSI/RS reporting setting or configuration provided by CSI-ReportConfig or CSI-AssociatedReportConfigInfo could comprise one or more NZP CSI-RS resource sets each provided by nzp-CSI-RS-ResourceSet or resourcesForChannel or one or more SSB resource sets each provided by CSI-SSB-ResourceSet. For this design example, the UE could assess the radio link or beam quality(s) of the RS(s) or RS resource(s) including (periodic) CSI-RS(s) or CSI-RS resource(s) and/or SSB(s) corresponding to the one or more RS resource configuration indexes/IDs in the CSI/RS resource(s) setting or configuration associated to the CSI/RS reporting setting or configuration with the corresponding CSI/RS reporting setting or configuration index/ID provided or configured in/by the one or more indicated joint/DL/UL TCI states (via their associated/corresponding higher layer parameter(s) TCI-State(s) and/or TCI-UL-State(s)) for the candidate beam(s) or as the radio link or beam quality(s) of the candidate beam(s) for triggering or initiating a UEI reporting according to or following those specified herein in the present disclosure (e.g., for detecting and/or declaring one or more of the events specified herein in the present disclosure). In addition, when/if inter-cell beam reporting (or beam management in general) is enabled—e.g., when/if the UE is higher layer provided or configured information related to PCI(s) other than the serving cell PCI and/or RS resource configuration(s) for PCI(s) other than the serving cell PCI, the higher layer parameter(s) including TCI-State(s) and/or TCI-UL-State(s) that provides or configures the one or more indicated joint/DL/UL TCI states and/or the CSI/RS reporting setting or configuration could also provide or configure or comprise or include or contain one or more PCI values or PCI indexes each associated or corresponding or specific to a RS resource configuration index/ID in the same CSI/RS resource(s) setting or configuration associated to the same CSI/RS reporting setting or configuration with the corresponding CSI/RS reporting setting or configuration index/ID provided/configured in the same indicated joint/DL/UL TCI state(s) provided by the same higher layer parameter(s)/signalling(s) TCI-State(s) and/or TCI-UL-State(s). Here, a PCI index could point to an entry of a list of candidate PCI values higher layer configured/provided to the UE, and the CSI/RS reporting setting or configuration and/or the corresponding CSI/RS resource(s) setting(s) or configuration(s) and/or the corresponding CSI/RS resource(s) set(s) could be for periodic, semi-persistent or aperiodic CSI, beam or UEI reporting.
In another example, the higher layer parameter(s) including TCI-State(s) and/or TCI-UL-State(s) that provides or configures the one or more indicated joint/DL/UL TCI states could provide or configure or comprise or include or contain one or more TCI state IDs/indexes and/or TCI codepoint indexes, wherein the TCI state(s) (referred to as candidate TCI state(s))—and therefore the corresponding higher layer parameter(s) including TCI-State(s) and/or TCI-UL-State(s)—corresponding/associated to the one or more TCI state IDs/indexes and/or the TCI codepoint indexes could provide or configure one or more RS sets each comprising one or more RS indexes (e.g., one or more CSI-RS resource configuration indexes and/or one or more SSB indexes), wherein the one or more RS indexes could be referred to or denoted by/as or regarded as candidate QCL source RS indexes in this design example. In this case, the UE could assess the radio link or beam quality(s) of the RS(s) or RS resource(s) including (periodic) CSI-RS(s) or CSI-RS resource(s) and/or SSB(s) corresponding to the one or more candidate QCL source RS indexes for the candidate beam(s) or as the radio link or beam quality(s) of the candidate beam(s) for triggering or initiating a UEI reporting according to or following those specified herein in the present disclosure (e.g., for detecting and/or declaring one or more of the events specified herein in the present disclosure). In addition, when/if inter-cell beam reporting (or beam management in general) is enabled—e.g., when/if the UE is higher layer provided or configured information related to PCI(s) other than the serving cell PCI and/or RS resource configuration(s) for PCI(s) other than the serving cell PCI, the higher layer parameter(s) including TCI-State(s) and/or TCI-UL-State(s) that provides or configures the one or more indicated joint/DL/UL TCI states could also provide or configure or comprise or include or contain one or more PCI values or PCI indexes each associated or corresponding or specific to a TCI state index/ID (and therefore, the corresponding candidate QCL source RS index(s) provided/configured therein) provided/configured in the same indicated joint/DL/UL TCI state(s) provided by the same higher layer parameter(s)/signalling(s) TCI-State(s) and/or TCI-UL-State(s). Optionally or alternatively, the higher layer parameter(s) including TCI-State(s) and/or TCI-UL-State(s) that provides or configures the one or more candidate joint/DL/UL TCI states could also provide or configure or comprise or include or contain one or more PCI values or PCI indexes. Here, a PCI index could point to an entry of a list of candidate PCI values higher layer configured/provided to the UE.
In another example, each of the one or more indicated joint/DL/UL TCI states—for determining or identifying the current serving beam(s) or assessing the radio link/beam quality(s) of the current serving beam(s) as specified/defined herein in the present disclosure—and therefore, the RS indexes in the RS sets indicated in each of the one or more indicated joint/DL/UL TCI states (as the QCL source RSs or RS configurations) could be associated or mapped or corresponding to one or more candidate joint/DL/UL TCI states, wherein the one or more candidate joint/DL/UL TCI states and the one or more indicated joint/DL/UL TCI states could be from the same (enhanced) unified TCI state(s) activation/deactivation MAC CE command such that the one or more candidate joint/DL/UL TCI states could also be referred to as active or activated joint/DL/UL TCI states, and/or the one or more candidate joint/DL/UL TCI states could be from the higher layer configured list(s) of joint/DL/UL TCI states but not activated yet by any (enhanced) unified TCI state(s) activate/deactivation MAC CE command (i.e., inactive TCI state(s)). For this design example, the UE could be provided, configured, indicated by the network, e.g., via higher layer RRC signalling(s)/parameter(s) and/or MAC CE command(s) and/or dynamic DCI based L1 signaling(s) based on or according to a corresponding UE's capability or capability signalling, the association/mapping/correspondence between the one or more indicated joint/DL/UL TCI states (and therefore, the RS indexes in the RS sets indicated/provided therein, e.g., the QCL source RSs or RS resource configurations provided/indicated therein) and the one or more candidate joint/DL/UL TCI states. In this case, the higher layer parameter(s) including TCI-State(s) and/or TCI-UL-State(s) that configures or provides the one or more candidate joint/DL/UL TCI states could provide or configure one or more RS sets each comprising one or more RS indexes (e.g., one or more CSI-RS resource configuration indexes and/or one or more SSB indexes), wherein the one or more RS indexes could be referred to or denoted by/as or regarded as candidate QCL source RS indexes. The UE could assess the radio link or beam quality(s) of the RS(s) or RS resource(s) including (periodic) CSI-RS(s) or CSI-RS resource(s) and/or SSB(s) corresponding to the one or more candidate QCL source RS indexes for the candidate beam(s) or as the radio link or beam quality(s) of the candidate beam(s) for triggering or initiating a UEI reporting according to or following those specified herein in the present disclosure (e.g., for detecting and/or declaring one or more of the events specified herein in the present disclosure). In addition, when/if inter-cell beam reporting (or beam management in general) is enabled—e.g., when/if the UE is higher layer provided or configured information related to PCI(s) other than the serving cell PCI and/or RS resource configuration(s) for PCI(s) other than the serving cell PCI, the higher layer parameter(s) including TCI-State(s) and/or TCI-UL-State(s) that provides or configures the one or more indicated joint/DL/UL TCI states could also provide or configure or comprise or include or contain one or more PCI values or PCI indexes each associated or corresponding or specific to a TCI state index/ID (and therefore, the corresponding candidate QCL source RS index(s) provided/configured therein) provided/configured in the same indicated joint/DL/UL TCI state(s) provided by the same higher layer parameter(s)/signalling(s) TCI-State(s) and/or TCI-UL-State(s). Optionally or alternatively, the higher layer parameter(s) including TCI-State(s) and/or TCI-UL-State(s) that provides or configures the one or more candidate joint/DL/UL TCI states could also provide or configure or comprise or include or contain one or more PCI values or PCI indexes. Here, a PCI index could point to an entry of a list of candidate PCI values higher layer configured/provided to the UE.
In another example, each of the one or more indicated joint/DL/UL TCI states—for determining or identifying the current serving beam(s) or assessing the radio link/beam quality(s) of the current serving beam(s) as specified/defined herein in the present disclosure—and therefore, the RS indexes in the RS sets indicated in each of the one or more indicated joint/DL/UL TCI states (as the QCL source RSs or RS configurations) could be associated or mapped or corresponding to one or more RSs, RS resources or RS resource configurations (referred to as one or more candidate RSs/RS resources/RS resource configurations, e.g., comprised in/by one or more RS resource sets and/or one or more RS resource configurations/settings), wherein the one or more candidate RSs, RS resources or RS resource configurations could be or could correspond to one or more CSI-RS resource configurations or configuration indexes and/or one or more SSBs or SSB indexes. For this design example, the UE could be provided, configured, indicated by the network, e.g., via higher layer RRC signalling(s)/parameter(s) and/or MAC CE command(s) and/or dynamic DCI based L1 signaling(s) based on or according to a corresponding UE's capability or capability signalling, the association/mapping/correspondence between the one or more indicated joint/DL/UL TCI states (and therefore, the RS indexes in the RS sets indicated/provided therein, e.g., the QCL source RSs or RS resource configurations indicated/provided therein) and the one or more candidate RSs/RS resources/RS resource configurations. In this case, the UE could assess the radio link or beam quality(s) of the one or more candidate RSs/RS resources/RS resource configurations for the candidate beam(s) or as the radio link or beam quality(s) of the candidate beam(s) for triggering or initiating a UEI reporting according to or following those specified herein in the present disclosure (e.g., for detecting and/or declaring one or more of the events specified herein in the present disclosure).

In the present disclosure, after a UE has determined or identified (e.g., based on network's configuration(s)/indication(s)) a candidate beam(s) set s̅₁ comprising one or more RS resource configuration indexes/IDs including one or more (periodic) CSI-RS resource configuration indexes and/or one or more SSB indexes according to or following those specified herein in the present disclosure, the UE could assess the radio link or beam quality(s) of the RS(s) or RS resource(s) or RS resource configuration(s) in the candidate beam(s) set s̅₁ according to SS/PBCH blocks on the PCell or the PSCell and/or (periodic) CSI-RS resource configurations that are quasi co-located with the RS index(es) in the RS set(s) in one or more candidate TCI states under the unified TCI framework as specified herein in the present disclosure, wherein the one or more candidate TCI states could be joint, DL and/or UL TCI state(s) provided by TCI-State(s) and/or TCI-UL-State(s), and/or the one or more candidate joint/DL/UL TCI states and the one or more indicated joint/DL/UL TCI states could be activated/provided/indicated in/from a same (enhanced) unified TCI state(s) activation/deactivation MAC CE command such that the one or more candidate joint/DL/UL TCI states could also be referred to as active or activated joint/DL/UL TCI states, and/or the one or more candidate joint/DL/UL TCI states could be from the higher layer configured list(s) of joint/DL/UL TCI states but not activated yet by any (enhanced) unified TCI state(s) activate/deactivation MAC CE command (i.e., inactive TCI state(s)). The UE could determine or identify the one or more candidate joint/DL/UL TCI states according to or following those specified herein in the present disclosure.

In one embodiment, a UE could determine or identify which one or more of the events (e.g., the first, second, third and fourth events defined/specified herein in the present disclosure) to use/apply for triggering or initiating a UEI (beam) reporting following those specified herein in the present disclosure according to whether or not the RS(s)/RS resource(s)—e.g., in a RS resource set s̅₀ as defined/specified herein in the present disclosure—for assessing the radio link or beam quality(s) of the current serving beam(s) and/or the RS(s)/RS resource(s)—e.g., in a RS resource set s̅₁ as defined/specified herein in the present disclosure—for assessing the radio link or beam quality(s) of the candidate beam(s) is/are configured or determined.
In one example, when/if the UE is configured (or provided) or configured to determine one or more RSs or RS resources or RS resource configurations—e.g., a RS resource set s̅₀—for assessing the radio link or beam quality(s) of the current serving beam(s) according to those specified herein in the present disclosure (e.g., the RS(s) and/or RS resource(s) and/or RS resource configuration(s) could be explicitly provided or indicated or configured by the network, e.g., via higher layer RRC signalling(s)/parameter(s) and/or MAC CE command(s) and/or dynamic DCI based L1 signaling(s) according to or based on a corresponding UE's capability or capability signalling, and/or implicitly determined by the UE according to or based on the (QCL source) RS index(es) provided in the indicated joint/DL/UL TCI state(s)), the UE could use or apply at least the first event as defined/specified herein in the present disclosure to trigger or initiate a potential UEI (beam) reporting—e.g., when/if the UE has detected and/or declared the first event according to or following the MAC procedures/operations defined or specified herein in the present disclosure.
In another example, when/if the UE is configured (or provided) or configured to determine one or more RSs or RS resources or RS resource configurations—e.g., a RS resource set s̅₀—for assessing the radio link or beam quality(s) of the candidate beam(s) according to those specified herein in the present disclosure (e.g., the RS(s) and/or RS resource(s) and/or RS resource configuration(s) could be explicitly provided or indicated or configured by the network, e.g., via higher layer RRC signalling(s)/parameter(s) and/or MAC CE command(s) and/or dynamic DCI based L1 signaling(s) according to or based on a corresponding UE's capability or capability signalling, and/or implicitly determined by the UE according to or based on the (QCL source) RS index(es) provided in the indicated joint/DL/UL TCI state(s)), the UE could use or apply at least the second event as defined/specified herein in the present disclosure to trigger or initiate a potential UEI (beam) reporting—e.g., when/if the UE has detected and/or declared the second event according to or following the MAC procedures/operations defined or specified herein in the present disclosure.
In another example, when/if (1) the UE is configured (or provided) or configured to determine one or more RSs or RS resources or RS resource configurations—e.g., a RS resource set s̅₀—for assessing the radio link or beam quality(s) of the current serving beam(s) according to those specified herein in the present disclosure (e.g., the RS(s) and/or RS resource(s) and/or RS resource configuration(s) could be explicitly provided or indicated or configured by the network, e.g., via higher layer RRC signalling(s)/parameter(s) and/or MAC CE command(s) and/or dynamic DCI based L1 signaling(s) according to or based on a corresponding UE's capability or capability signalling, and/or implicitly determined by the UE according to or based on the (QCL source) RS index(es) provided in the indicated joint/DL/UL TCI state(s)), and (2) the UE is configured (or provided) or configured to determine one or more RSs or RS resources or RS resource configurations—e.g., a RS resource set s̅₁—for assessing the radio link or beam quality(s) of the candidate beam(s) according to those specified herein in the present disclosure (e.g., the RS(s) and/or RS resource(s) and/or RS resource configuration(s) could be explicitly provided or indicated or configured by the network, e.g., via higher layer RRC signalling(s)/parameter(s) and/or MAC CE command(s) and/or dynamic DCI based L1 signaling(s) according to or based on a corresponding UE's capability or capability signalling, and/or implicitly determined by the UE according to or based on the (QCL source) RS index(es) provided in the indicated joint/DL/UL TCI state(s)), the UE could use or apply one or more of the first, second, third and fourth events as defined/specified herein in the present disclosure to trigger or initiate a potential UEI (beam) reporting—e.g., when/if the UE has detected and/or declared the one or more of the first, second, third and fourth events according to or following the MAC procedures/operations defined or specified herein in the present disclosure.

As specified herein in the present disclosure, a UE (e.g., the UE 116) could be configured (or provided) or configured to determine, in a single RS resource(s) set, one or more first RSs or RS resources or RS resource configurations—e.g., including one or more NZP CSI-RS resource configurations and/or one or more SSBs/SSB resources—for assessing the radio link or beam quality(s) of the current serving beam(s) according to those specified herein in the present disclosure (e.g., the first RS(s) and/or RS resource(s) and/or RS resource configuration(s) could be explicitly provided or indicated or configured by the network, e.g., via higher layer RRC signalling(s)/parameter(s) and/or MAC CE command(s) and/or dynamic DCI based L1 signaling(s) according to or based on a corresponding UE's capability or capability signalling, and/or implicitly determined by the UE according to or based on the (QCL source) RS index(es) provided in the indicated joint/DL/UL TCI state(s)) and one or more second RSs or RS resources or RS resource configurations—e.g., including one or more NZP CSI-RS resource configurations and/or one or more SSBs/SSB resources—for assessing the radio link or beam quality(s) of the candidate beam(s) according to those specified herein in the present disclosure (e.g., the second RS(s) and/or RS resource(s) and/or RS resource configuration(s) could be explicitly provided or indicated or configured by the network, e.g., via higher layer RRC signalling(s)/parameter(s) and/or MAC CE command(s) and/or dynamic DCI based L1 signaling(s) according to or based on a corresponding UE's capability or capability signalling, and/or implicitly determined by the UE according to or based on the (QCL source) RS index(es) provided in the indicated joint/DL/UL TCI state(s)).
In one example, the position(s) and/or ordering(s) and/or index(es) and/or entry(s) and/or field(s) and/or field number(s)/index(es) of the first RS(s)/RS resource(s)/RS resource configuration(s) in the RS resource(s) set and/or the position(s) and/or ordering(s) and/or index(es) and/or entry(s) and/or field(s) and/or field number(s)/index(es) of the second RS(s)/RS resource(s)/RS resource configuration(s) in the RS resource(s) set could be fixed in system specification(s) and/or per RRC configuration.
   For example, the odd (or even) position(s) and/or ordering(s) and/or index(es) and/or entry(s) and/or field(s) and/or field number(s)/index(es) in the RS resource(s) set could correspond to the first RS(s)/RS resource(s)/RS resource configuration(s) specific to/for the current serving beam(s), and the even (or odd) position(s) and/or ordering(s) and/or index(es) and/or entry(s) and/or field(s) and/or field number(s)/index(es) in the RS resource(s) set could correspond to the second RS(s)/RS resource(s)/RS resource configuration(s) specific to/for the candidate beam(s).
   For another example, the even (or odd) position(s) and/or ordering(s) and/or index(es) in the RS resource(s) set could correspond to the first RS(s)/RS resource(s)/RS resource configuration(s) specific to/for the current serving beam(s), and the odd (or even) position(s) and/or ordering(s) and/or index(es) in the RS resource(s) set could correspond to the second RS(s)/RS resource(s)/RS resource configuration(s) specific to/for the candidate beam(s).
   For another example, denote the number of the first RS(s)/RS resource(s)/RS resource configuration(s) specific to/for the current serving beam(s) by Mserv, and the number of the second RS(s)/RS resource(s)/RS resource configuration(s) specific to/for the candidate beam(s) by Mcand. For this design example, the first (or last) Mserv position(s) and/or ordering(s) and/or index(es) and/or entry(s) and/or field(s) and/or field number(s)/index(es) in the RS resource(s) set could correspond to the first RS(s)/RS resource(s)/RS resource configuration(s) specific to/for the current serving beam(s), and the rest (e.g., the last (or first) Mcand) position(s) and/or ordering(s) and/or index(es) and/or entry(s) and/or field(s) and/or field number(s)/index(es) in the RS resource(s) set could correspond to the second RS(s)/RS resource(s)/RS resource configuration(s) specific to/for the candidate beam(s).
   For another example, denote the number of the first RS(s)/RS resource(s)/RS resource configuration(s) specific to/for the current serving beam(s) by Mserv, and the number of the second RS(s)/RS resource(s)/RS resource configuration(s) specific to/for the candidate beam(s) by Mcand. For this design example, the first (or last) Mcand position(s) and/or ordering(s) and/or index(es) and/or entry(s) and/or field(s) and/or field number(s)/index(es) in the RS resource(s) set could correspond to the second RS(s)/RS resource(s)/RS resource configuration(s) specific to/for the candidate beam(s), and the rest (e.g., the last (or first) Mserv) position(s) and/or ordering(s) and/or index(es) and/or entry(s) and/or field(s) and/or field number(s)/index(es) in the RS resource(s) set could correspond to the first RS(s)/RS resource(s)/RS resource configuration(s) specific to/for the current serving beam(s).

The value(s) ofMserv and/orMcand could be determined according to: (i) fixed value(s) in system specification(s) or per RRC configuration, (ii) network's configuration(s) and/or indication(s), e.g., via higher layer RRC configuration(s)/indication(s) and/or MAC CE command(s) and/or dynamic DCI based L1 signaling(s) based on or according to a corresponding UE's capability or capability signalling(s), and/or (iii) UE's autonomous determination or selection, which could be further sent to the network via various UL channels/signals and/or a CSI/beam report and/or UE's capability signalling(s).
In another example, the UE could be provided, configured or indicated by the network, e.g., via higher layer RRC signalling(s)/parameter(s) and/or MAC CE command(s) and/or dynamic DCI based L1 signaling(s) based on or according to a corresponding UE's capability or capability signalling, the position(s) and/or ordering(s) and/or index(es) and/or entry(s) and/or field(s) and/or field number(s)/index(es) of the first RS(s)/RS resource(s)/RS resource configuration(s) in the RS resource(s) set and/or the position(s) and/or ordering(s) and/or index(es) and/or entry(s) and/or field(s) and/or field number(s)/index(es) of the second RS(s)/RS resource(s)/RS resource configuration(s) in the RS resource(s) set.
   For example, the higher layer parameter(s)/signalling(s) that configures or provides the RS resource(s) set could provide or include or configure or contain or comprise a first indicator and/or a second indicator. For this design example, the first indicator could correspond to a one-bit indicator with ‘0’ (or ‘1’ or ‘2’) corresponding to/indicating the current serving beam(s). Furthermore, the second indicator could correspond to a one-bit indicator with ‘1’ (or ‘0’ or ‘2’) corresponding to/indicating the candidate beam(s). Denote the number of the first RS(s)/RS resource(s)/RS resource configuration(s) specific to/for the current serving beam(s) byMserv; for this design example, the firstMserv position(s) and/or ordering(s) and/or index(es) and/or entry(s) and/or field(s) and/or field number(s)/index(es) following the position, index or field that provides, configures, carries or conveys the first indicator could correspond to the Mserv first RS(s) and/or RS resource(s) and/or RS resource configuration(s) specific to/for the current serving beam(s). In addition, denote the number of the second RS(s)/RS resource(s)/RS resource configuration(s) specific to/for the candidate beam(s) byMcand; for this design example, the first Mcand position(s) and/or ordering(s) and/or index(es) and/or entry(s) and/or field(s) and/or field number(s)/index(es) following the position, index or field that provides, configures, carries or conveys the second indicator could correspond to the Mcand second RS(s) and/or RS resource(s) and/or RS resource configuration(s) specific to/for the candidate beam(s). The position, index or field in the RS resource(s) set that provides, configures, carries or conveys the first indicator, and/or the position, index or field in the RS resource(s) set that provides, configures, carries or conveys the second indicator, could be fixed—e.g., the position, index or field in the RS resource(s) set that provides, configures, carries or conveys the first (or second) indicator could correspond to the first (or 1^{st}) position, index or field in the RS resource(s) set, and/or the position, index or field in the RS resource(s) set that provides, configures, carries or conveys the second (or first) indicator could correspond the first (or 1^{st}) position, index or field in the RS resource(s) set that follows or is after the last position, index or field in the RS resource(s) set that provides, configures, carries or conveys the first (or second) RS(s)/RS resource(s)/RS resource configuration(s) specific to/for the current serving (or candidate) beam(s). Furthermore, the position, index or field in the RS resource(s) set that provides, configures, carries or conveys the first indicator, and/or the position, index or field in the RS resource(s) set that provides, configures, carries or conveys the second indicator, could be determined according to/based on (i) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (ii) UE's autonomous determination/selection, which could be further sent to the network via various UL channels/signals including PUCCH, PUSCH, PRACH, and/or in part of a CSI/beam report and/or UE's capability signaling(s) and/or etc.
   For another example, the higher layer parameter(s)/signalling(s) that configures or provides the RS resource(s) set could provide or include or configure or contain or comprise a bitmap with each bit position/entry of the bitmap associated or specific or corresponding to a RS/RS resource/RS resource configuration in the RS resource(s) set. For this design example, when/if an entry/bit position of the bitmap is set to ‘0’ (or ‘1’), the RS or RS resource or RS resource configuration—in the RS resource(s) set—corresponding/associated/specific to the entry/bit position could correspond to a first RS or RS resource or RS resource configuration specific to/for the current serving beam(s), and when/if an entry/bit position of the bitmap is set to ‘1’ (or ‘0’), the RS or RS resource or RS resource configuration—in the RS resource(s) set—corresponding/associated/specific to the entry/bit position could correspond to a second RS or RS resource or RS resource configuration specific to/for the current serving beam(s).
   For another example, each of the RS(s) or RS resource(s) or RS resource configuration(s) in the RS resource(s) set could be associated or corresponding or specific to an indicator, which could be provided, configured, included, contained or comprised in the same higher layer RRC parameter(s)/signalling(s) that provides or configures the RS resource(s) set. For this design example, when/if an indicator is set to ‘1’ (or ‘0’), the RS or RS resource or RS resource configuration—in the RS resource(s) set—corresponding/associated/specific to the indicator could correspond to a first RS or RS resource or RS resource configuration specific to/for the current serving beam(s); otherwise, i.e., when/if an indicator is set to ‘0’ (or ‘1’), the RS or RS resource or RS resource configuration—in the RS resource(s) set—corresponding/associated/specific to the indicator could correspond to a second RS or RS resource or RS resource configuration specific to/for the candidate beam(s).

The value(s) of Mserv and/or Mcand could be determined according to: (i) fixed value(s) in system specification(s) or per RRC configuration, (ii) network's configuration(s) and/or indication(s), e.g., via higher layer RRC configuration(s)/indication(s) and/or MAC CE command(s) and/or dynamic DCI based L1 signaling(s) based on or according to a corresponding UE's capability or capability signalling(s), and/or (iii) UE's autonomous determination or selection, which could be further sent to the network via various UL channels/signals and/or a CSI/beam report and/or UE's capability signalling(s).

Furthermore, for the described or specified design examples herein, the bitwidth for indexing the first RS(s)/RS resource(s)/RS resource configuration(s) in the RS resource(s) set, or equivalently, the bitwidth for determining the index(es) of/for the first RS(s) or RS resource(s) or RS resource configuration(s) in the RS resource(s) set could be determined according to or based on one or more of the following design examples, according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Denote the number of the first RS(s)/RS resource(s)/RS resource configuration(s) specific to/for the current serving beam(s) in the RS resource(s) set by Mserv, and the number of the second RS(s)/RS resource(s)/RS resource configuration(s) specific to/for the candidate beam(s) in the RS resource(s) set by Mcand.
In one example, the bitwidth for indexing the first RS(s)/RS resource(s)/RS resource configuration(s) in the RS resource(s) set could be determined as log₂Mserv or [log₂Mserv] or [log₂Mserv].
In another example, the bitwidth for indexing the first RS(s)/RS resource(s)/RS resource configuration(s) in the RS resource(s) set could be determined as log₂(Mserv+Mcand) or [log₂(Mserv+Mcand)] or [log₂(Mserv+Mcand)].

Additionally, for the described or specified design examples herein, the bitwidth for indexing the second RS(s)/RS resource(s)/RS resource configuration(s) in the RS resource(s) set, or equivalently, the bitwidth for determining the index(es) of/for the second RS(s) or RS resource(s) or RS resource configuration(s) in the RS resource(s) set could be determined according to or based on one or more of the following design examples, according to or based on: (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Denote the number of the second RS(s)/RS resource(s)/RS resource configuration(s) specific to/for the candidate beam(s) in the RS resource(s) set by Mcand, and the number of the first RS(s)/RS resource(s)/RS resource configuration(s) specific to/for the current serving beam(s) in the RS resource(s) set by Mserv.
In one example, the bitwidth for indexing the second RS(s)/RS resource(s)/RS resource configuration(s) in the RS resource(s) set could be determined as log₂Mcand or [log₂Mcand] or [log₂Mcand].
In another example, the bitwidth for indexing the second RS(s)/RS resource(s)/RS resource configuration(s) in the RS resource(s) set could be determined as log₂(Mserv+Mcand) or [log₂(Mserv+Mcand)] or [log₂(Mserv+Mcand)].

According to those specified herein in the present disclosure, the first RS(s)/RS resource(s)/RS resource configuration(s) specific to/for the current serving beam(s) could correspond to or could comprise, include, contain or provide a mixture of NZP CSI-RS resource(s)/resource configuration(s)—e.g., identified by the corresponding higher layer parameter/signalling of nzp-CSI-RS-Resource with the corresponding resource ID/index—and SSB(s)/SSB resource(s)—e.g., identified by the corresponding higher layer parameter/signalling of SSB-Index. Furthermore, the second RS(s)/RS resource(s)/RS resource configuration(s) specific to/for the candidate beam(s) could correspond to or could comprise, include, contain or provide a mixture of NZP CSI-RS resource(s)/resource configuration(s)—e.g., identified by the corresponding higher layer parameter/signalling of nzp-CSI-RS-Resource with the corresponding resource ID/index—and SSB(s)/SSB resource(s)—e.g., identified by the corresponding higher layer parameter/signalling of SSB-Index.

For the design examples described, discussed and/or specified herein in the present disclosure, whether the first RS(s)/RS resource(s)/RS resource configuration(s) specific to the current serving beam(s) or used/applied for measuring or obtaining the radio link/beam quality(s) for the current serving beam(s) and the second RS(s)/RS resource(s)/RS resource configuration(s) specific to the candidate beam(s) or used/applied for measuring or obtaining the radio link/beam quality(s) for the candidate beam(s) could be in a/same RS resource(s) set or in two separate RS resource(s) sets could be determined based on or according to: (i) fixed rule(s) in system specifications or per RRC configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals through, e.g., a CSI/beam report and/or UE's capability signaling(s). In addition, as described or specified herein in the present disclosure, a UE could receive from the network one or more MAC CEs to update one or more of the first RS(s)/RS resource(s)/RS resource configuration(s) for the current serving beam(s)—or to indicate one or more first RSs/RS resources/RS resource configurations for the current serving beam(s), and/or to update one or more of the second RS(s)/RS resource(s)/RS resource configuration(s) for the candidate beam(s)—or to indicate one or more second RSs/RS resources/RS resource configurations for the candidate beam(s).
In one example, the UE could receive from the network a first MAC CE indicating, activating or providing (information related to or of) one or more RSs or RS indexes or RS resource configuration indexes. For this design example, the first MAC CE could be associated or corresponding or specific to/for the current serving beam(s) such that the RS(s) or RS resource(s) or RS resource configuration(s) corresponding to the RS(s) or RS index(es) or RS resource configuration index(es) indicated, activated or provided in the first MAC CE could be used/applied to update one or more of the first RS(s)/RS resource(s)/RS resource configuration(s) specific to/for the current serving beam(s) or used/applied for measuring or obtaining the radio link/beam quality(s) for the current serving beam(s) according to those specified herein in the present disclosure—or to indicate one or more first RSs/RS resources/RS resource configurations specific to/for the current serving beam(s) or used/applied for measuring or obtaining the radio link/beam quality(s) for the current serving beam(s) according to those specified herein in the present disclosure. In addition, the UE could receive from the network a second MAC CE indicating, activating or providing (information related to or of) one or more RSs or RS indexes or RS resource configuration indexes. For this design example, the second MAC CE could be associated or corresponding or specific to/for the candidate beam(s) such that the RS(s) or RS resource(s) or RS resource configuration(s) corresponding to the RS(s) or RS index(es) or RS resource configuration index(es) indicated, activated or provided in the second MAC CE could be used/applied to update one or more of the second RS(s)/RS resource(s)/RS resource configuration(s) specific to/for the candidate beam(s) or used/applied for measuring or obtaining the radio link/beam quality(s) for the candidate beam(s) according to those specified herein in the present disclosure—or to indicate one or more second RSs/RS resources/RS resource configurations specific to/for the candidate beam(s) or used/applied for measuring or obtaining the radio link/beam quality(s) for the candidate beam(s) according to those specified herein in the present disclosure. For this design example, the first/second MAC CE could contain, provide, include, indicate or comprise an indicator to indicate whether a MAC CE, i.e., the first/second MAC CE, is specific or associated or corresponding to the current serving beam(s) or the candidate beam(s). In this case, the indicator could correspond to a one-bit indicator with ‘1’ (or ‘0’) indicating that the MAC CE that provides, indicates, comprises, includes or contains the indicator could correspond to the first MAC CE specific to/for the current serving beam(s), and ‘0’ (or ‘1’) indicating that the MAC CE that provides, indicates, comprises, includes or contains the indicator could correspond to the second MAC CE specific to/for the candidate beam(s). Additionally, the indicator could be provided or indicated by a field/entry (e.g., via a reserved ‘R’ field) in the corresponding (first/second) MAC CE.
In another example, the UE could receive from the network a MAC CE indicating, activating or providing (information related to or of) one or more RSs or RS indexes or RS resource configuration indexes. For this design example, the MAC CE could be associated or corresponding or specific to/for the current serving beam(s) and/or the candidate beam(s) such that the RS(s) or RS resource(s) or RS resource configuration(s) corresponding to the RS(s) or RS index(es) or RS resource configuration index(es) indicated, activated or provided by/via one or more first fields/entries in the MAC CE could be used/applied to update one or more of the first RS(s)/RS resource(s)/RS resource configuration(s) specific to/for the current serving beam(s) or used/applied for measuring or obtaining the radio link/beam quality(s) for the current serving beam(s) according to those specified herein in the present disclosure—or to indicate one or more first RSs/RS resources/RS resource configurations specific to/for the current serving beam(s) or used/applied for measuring or obtaining the radio link/beam quality(s) for the current serving beam(s) according to those specified herein in the present disclosure, and/or the RS(s) or RS resource(s) or RS resource configuration(s) corresponding to the RS(s) or RS index(es) or RS resource configuration index(es) indicated, activated or provided by/via one or more second fields/entries in the MAC CE could be used/applied to update one or more of the second RS(s)/RS resource(s)/RS resource configuration(s) specific to/for the candidate beam(s) or used/applied for measuring or obtaining the radio link/beam quality(s) for the candidate beam(s) according to those specified herein in the present disclosure—or to indicate one or more second RSs/RS resources/RS resource configurations specific to/for the candidate beam(s) or used/applied for measuring or obtaining the radio link/beam quality(s) for the candidate beam(s) according to those specified herein in the present disclosure. For this design example, one or more of the fields/entries in the MAC CE could be associated or corresponding or specific to an indicator provided, indicated, comprised, included or contained in the same MAC CE, wherein the indicator could indicate whether the associated/corresponding field(s)/entry(s) in the MAC CE is specific or associated or corresponding to the current serving beam(s) or the candidate beam(s). In this case, the indicator(s) could correspond to one-bit indicator(s); when/if an indicator is set to ‘1’ (or ‘0’), the field(s)/entry(s) that is associated/corresponding to the indicator in the MAC CE—and therefore, the corresponding RS(s)/RS resource(s)/RS resource configuration(s) conveyed or provided or indicated by/via the field(s)/entry(s)—could be specific to/for the current serving beam(s), and when/if an indicator is set to ‘0’ (or ‘1’), the field(s)/entry(s) that is associated/corresponding to the indicator in the MAC CE—and therefore, the corresponding RS(s)/RS resource(s)/RS resource configuration(s) conveyed or provided or indicated by/via the field(s)/entry(s)—could be specific to/for the candidate beam(s). Additionally, the indicator(s) could be provided or indicated by one or more fields/entries (e.g., via one or more reserved ‘R’ fields) in the corresponding MAC CE.

Throughout the present disclosure, a resource indicator including SSBRI/CRI (and therefore, the corresponding radio link or beam quality(s) as specified/defined herein in the present disclosure) reported in a UEI beam report for a current serving beam could correspond or refer to a RS resource or RS resource configuration including SSB/NZP CSI-RS resource configuration (and therefore, the corresponding measurement result(s)) determined/selected from the RS resource(s) or RS resource configuration(s) configured, provided or determined specific to/for the current serving beam(s) according to those specified herein in the present disclosure, and a resource indicator including SSBRI/CRI (and therefore, the corresponding radio link or beam quality(s)) reported in a UEI beam report for a candidate beam could correspond or refer to a RS resource or RS resource configuration including SSB/NZP CSI-RS resource configuration (and therefore, the corresponding measurement results(s)) determined/selected from the RS resource(s) or RS resource configuration(s) configured, provided or determined specific to/for the candidate beam(s) according to those specified herein in the present disclosure.

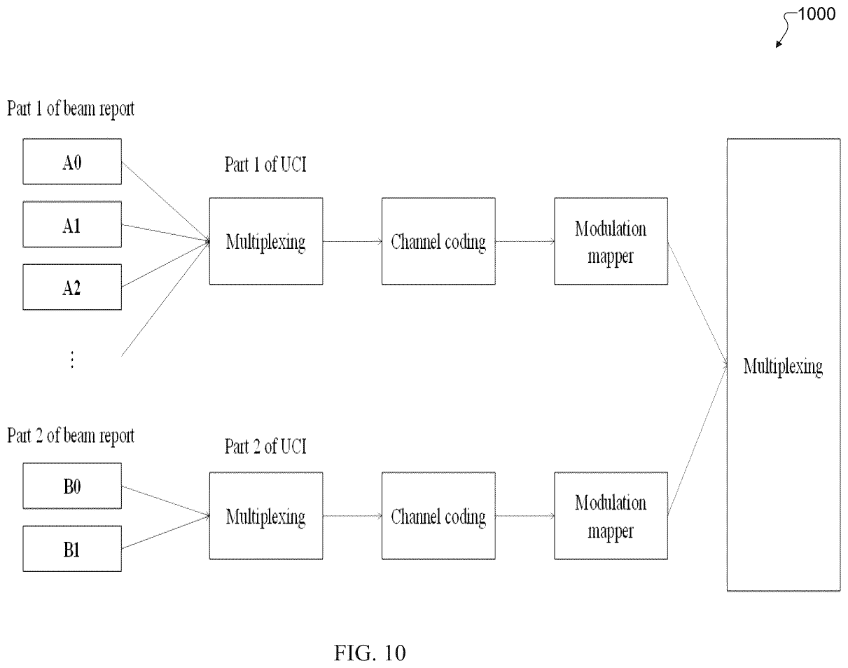

FIG. 10 illustrates an example of a two-part UEI report 1000 according to embodiments of the present disclosure. For example, two-part UEI report 1000 can be reported by any of the UEs 111-116 of FIG. 1. This example is for illustration only and other embodiments can be used without departing from the scope of the present disclosure.

In the specified/described design examples or in the design examples described herein, discussed or specified throughout the present disclosure, part 1 and/or part 2 of the UEI (beam) report and/or UCI could be separately encoded (see FIG. 10) and reported in a single reporting instance/CSI report. Components A0, A1, A2, . . . , B0, B1 in part 1 and/or part 2 of the two-part UEI report or UCI as illustrated in FIG. 10 could correspond to one or more of those specified/provided herein in the present disclosure. Furthermore, for any given two-part UEI (beam) report or two-part UCI design as specified herein in the present disclosure, the payload size of part 1 of the UEI report could be fixed for a given RRC configuration. The payload size of part 2 of the UEI report, however, could vary, and part 1 of the UEI (beam) report or UCI could provide/indicate and/or the contents in part 1 of the UEI report or UCI could be used to indicate/identify the payload size of part 2 of the UEI report.

The UEI report as specified herein in the present disclosure—e.g., with both PN message and the corresponding report content(s)/quantity(s) or with only the report content(s)/quantity(s)—could be via a one-part UCI (e.g., part 2 is not present) or a two-part UCI (both part 1 and part 2 as specified herein in the present disclosure) depending on one or more conditions. The one or more conditions could be according to (i) fixed rule(s)/value(s) specified/provided in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further reported to the network, e.g., in/via part of a/the CSI/beam report and/or UE's capability signaling(s). Specifically,
In one example, the UEI report(s) as specified herein in the present disclosure could be via a one-part UCI or a two-part UCI depending on a signaling from the NW. This signaling could be semi-static via higher layer RRC signaling (using a dedicated parameter or with a joint configuration parameter) or more dynamic via MAC CE or DCI based signaling (using a dedicated indication or with a joint indication).
In another example, as specified herein in the present disclosure, the UE could provide/indicate in part 1 of the UEI report whether part 2 of the UEI report according to those specified herein in the present disclosure is present (i.e., a two-part UCI) or not (i.e., a one-part UCI).
In yet another example, the UEI report(s) as specified herein in the present disclosure could be via a one-part UCI or a two-part UCI depending on a value N_x and a threshold x. For instance, when N_x<=x, the one-part UCI could be used for the UEI (beam) report(s) as specified herein in the present disclosure, and when N_x>x, the two-part UCI is used for the UEI report(s) as specified herein in the present disclosure. The value of the threshold x could be according to: (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further reported to the network, e.g., in/via part of a/the CSI/beam report and/or UE's capability signaling(s). The value N_x could be or could correspond to, e.g., the number of resource indicators and/or beam metrics or the number of report content(s)/quantity(s) (to be) reported in the UEI report (e.g., in part 1 and/or part 2 of the UEI report).
In yet another example, the UEI report(s) as specified herein in the present disclosure could be multiplexed with other types of CSI or beam reports, wherein whether one-part or two-part UCI is used for the CSI/beam report(s) as specified herein in the present disclosure could depend on the other CSI or beam reports. For example, the two-part UCI is used only when at least one of the other CSI or beam reports is configured with a two-part UCI.

For each of the events including the first, second, third and fourth events discussed/specified herein in the present disclosure, a UE could determine or identify the threshold(s) for detecting and/or declaring the corresponding event(s) following those specified herein in the present disclosure based on or according to: (1) higher layer RRC configured value(s) of the threshold(s), and/or (2) MAC CE/DCI indicated/updated value(s) of the threshold—e.g., based on or on top of or from the higher layer RRC configured value(s) of the threshold(s).
In one example, for a given event (e.g., the first, second, third or fourth event as specified herein in the present disclosure), a UE could be first configured or provided by the network, e.g., via higher layer RRC signaling(s)/parameter(s), the value(s) of the corresponding threshold(s). The UE could then receive from the network one or more MAC CE commands and/or one or more DCI formats to update or indicate the value(s) of the corresponding threshold(s).
   For example, for the first event, a UE could be first configured or provided by the network, e.g., via higher layer RRC signaling(s)/parameter(s), the value(s) of the threshold-A and/or threshold-A′ as defined/specified herein in the present disclosure. The UE could then receive from the network one or more MAC CE commands and/or one or more DCI formats to update or indicate the value(s) of the threshold-A and/or threshold-A′.
   For another example, for the second event, a UE could be first configured or provided by the network, e.g., via higher layer RRC signaling(s)/parameter(s), the value(s) of the threshold-B and/or threshold-B′ as defined/specified herein in the present disclosure. The UE could then receive from the network one or more MAC CE commands and/or one or more DCI formats to update or indicate the value(s) of the threshold-B and/or threshold-B′.
   For another example, for the third event, a UE could be first configured or provided by the network, e.g., via higher layer RRC signaling(s)/parameter(s), the value(s) of the threshold-A, threshold-A′, threshold-B and/or threshold-B′ as defined/specified herein in the present disclosure. The UE could then receive from the network one or more MAC CE commands and/or one or more DCI formats to update or indicate the value(s) of the threshold-A, threshold-A′, threshold-B and/or threshold-B′.
   For another example, for the fourth event, a UE could be first configured or provided by the network, e.g., via higher layer RRC signaling(s)/parameter(s), the value(s) of the threshold-C, threshold-C′ and/or threshold-C″ as defined/specified herein in the present disclosure. The UE could then receive from the network one or more MAC CE commands and/or one or more DCI formats to update or indicate the value(s) of the threshold-C, threshold-C′ and/or threshold-C″.
In one example, for a given event (e.g., the first, second, third or fourth event as specified herein in the present disclosure), a UE could be first configured or provided by the network, e.g., via higher layer RRC signaling(s)/parameter(s), a list/set of candidate value(s) for the corresponding threshold(s). The UE could then receive from the network one or more MAC CE commands and/or one or more DCI formats to sub-select and/or indicate one or more of the candidate value(s) in the list/set for the corresponding threshold(s) or as the value(s) of the corresponding threshold(s).
   For example, for the first event, a UE could be first configured or provided by the network, e.g., via higher layer RRC signaling(s)/parameter(s), a list/set of candidate value(s) for the threshold-A (and/or threshold-A′) as defined/specified herein in the present disclosure. The UE could then receive from the network a MAC CE command and/or a DCI format to sub-select or indicate one or more of the candidate value(s) in the list/set for the threshold-A (and/or threshold-A′) or as the value(s) of the threshold-A (and/or threshold-A′).
   For another example, for the second event, a UE could be first configured or provided by the network, e.g., via higher layer RRC signaling(s)/parameter(s), a list/set of candidate value(s) for the threshold-B (and/or threshold-B′) as defined/specified herein in the present disclosure. The UE could then receive from the network a MAC CE command and/or a DCI format to sub-select or indicate one or more of the candidate value(s) in the list/set for the threshold-B (and/or threshold-B′) or as the value(s) of the threshold-B (and/or threshold-B′).
   For another example, for the third event, a UE could be first configured or provided by the network, e.g., via higher layer RRC signaling(s)/parameter(s), a first list/set of candidate value(s) for the threshold-A (and/or threshold-A′) as defined/specified herein in the present disclosure. The UE could then receive from the network a MAC CE command and/or a DCI format to sub-select or indicate one or more of the candidate value(s) in the first list/set for the threshold-A (and/or threshold-A′) or as the value(s) of the threshold-A (and/or threshold-A′). Furthermore, the UE could also be first configured or provided by the network, e.g., via higher layer RRC signaling(s)/parameter(s), a second list/set of candidate value(s) for the threshold-B (and/or threshold-B′) as defined/specified herein in the present disclosure. The UE could then receive from the network a MAC CE command and/or a DCI format to sub-select or indicate one or more of the candidate value(s) in the second list/set for the threshold-B (and/or threshold-B′) or as the value(s) of the threshold-B (and/or threshold-B′).
   For another example, for the fourth event, a UE (e.g., the UE 116) could be first configured or provided by the network, e.g., via higher layer RRC signaling(s)/parameter(s), a list/set of candidate value(s) for the threshold-C (and/or threshold-C′ and/or threshold-C″) as defined/specified herein in the present disclosure. The UE could then receive from the network a MAC CE command and/or a DCI format to sub-select or indicate one or more of the candidate value(s) in the list/set for the threshold-C (and/or threshold-C′ and/or threshold-C″) or as the value(s) of the threshold-C (and/or threshold-C′ and/or threshold-C″).

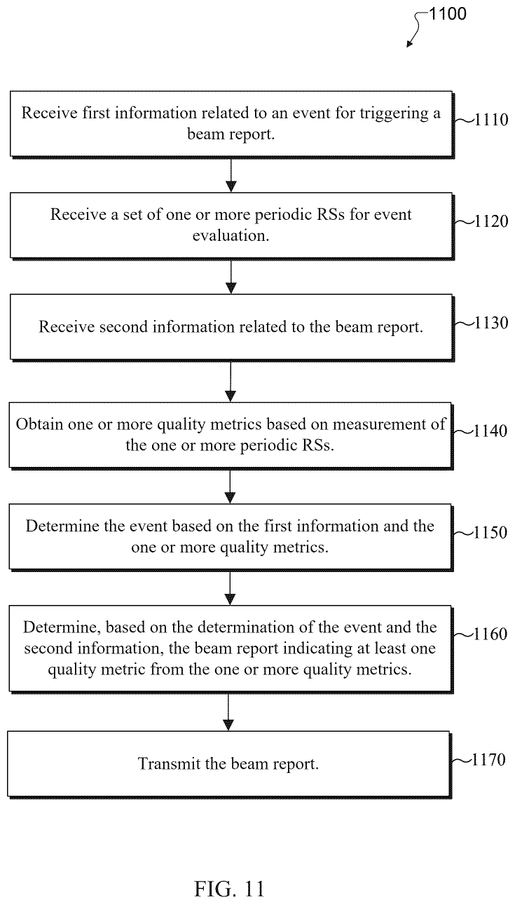

FIG. 11 illustrates an example method 1100 performed by a UE in a wireless communication system according to embodiments of the present disclosure. The method 1100 of FIG. 11 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1100 is for illustration only and other embodiments can be used without departing from the scope of the present disclosure.

The method 1100 begins with the UE receiving first information related to an event for triggering a beam report (1110). For example, in 1110, the first information may include an event type, a threshold value, a time window duration, and a maximum number of event instance count. The UE then receives a set of one or more periodic RSs for event evaluation (1120).

The UE then receives second information related to the beam report (1130). For example, in 1130, the second information may include a number of the one or more quality metrics to be indicated in the beam report and an indicator to enable inclusion of a quality metric, from the one or more quality metrics, corresponding to a current beam RS in the beam report. In various embodiments, when the indicator enables inclusion of the quality metric corresponding to the current beam RS in the beam report, a bitwidth of a resource indicator corresponding to a RS in the set is [log₂(M+1)], when the indicator does not enable inclusion of the quality metric corresponding to the current beam RS in the beam report, the bitwidth of the resource indicator corresponding to the RS in the set is [log₂M], and M represents a number of the one or more periodic RSs in the set.

The UE then obtains one or more quality metrics based on measurement of the one or more periodic RSs (1140). The UE then determines the event based on the first information and the one or more quality metrics (1150). In various embodiments, an event instance is determined when a L1-RSRP of a RS in the set is greater than a L1-RSRP of a current beam RS by a threshold value. For example, when a quality metric, from the one or more quality metrics, corresponding to the current beam RS is included in the beam report and when the event corresponding to the event instance is determined, the L1-RSRP of the current beam RS is quantized to a x₀-bit value with a y₀ dB step size with a reference to a largest measured L1-RSRP in the beam report and values of x₀ and y₀ are fixed. In various embodiments, an event instance is determined when a L1-RSRP of a current beam RS is lower than a threshold value, when a quality metric, from the one or more quality metrics, corresponding to the current beam RS is included in the beam report and when the event corresponding to the event instance is determined, the L1-RSRP of the current beam RS is quantized to a x₁-bit value with y₁ dB step size with a reference to the threshold value, and values of x₁ and y₁ are fixed.

The UE then determines, based on the determination of the event and the second information, the beam report indicating at least one quality metric from the one or more quality metrics (1160). For example, in 1160, the one or more quality metrics are associated with the event. The UE then transmit the beam report (1170).

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information related to an event for triggering a beam report;
receive a set of one or more periodic reference signals (RSs) for event evaluation; and
receive second information related to the beam report; and
a processor operably coupled with the transceiver, the processor configured to:
obtain one or more quality metrics based on measurement of the one or more periodic RSs;
determine the event based on the first information and the one or more quality metrics; and
determine, based on the determination of the event and the second information, the beam report indicating at least one quality metric from the one or more quality metrics, the one or more quality metrics associated with the event,
wherein the transceiver is further configured to transmit the beam report.

2. The UE of claim 1, wherein the first information includes:
an event type;
a threshold value;
a time window duration; and
a maximum number of event instance count.

3. The UE of claim 1, wherein the second information includes:
a number of the one or more quality metrics to be indicated in the beam report; and
an indicator to enable inclusion of a quality metric, from the one or more quality metrics, corresponding to a current beam RS in the beam report.

4. The UE of claim 3, wherein:
when the indicator enables inclusion of the quality metric corresponding to the current beam RS in the beam report, a bitwidth of a resource indicator corresponding to a RS in the set is [log₂(M+1)],
when the indicator does not enable inclusion of the quality metric corresponding to the current beam RS in the beam report, the bitwidth of the resource indicator corresponding to the RS in the set is [log₂M],
M represents a number of the one or more periodic RSs in the set.

5. The UE of claim 1, wherein an event instance is determined when a layer-1 reference signal receive power (L1-RSRP) of a RS in the set is greater than a L1-RSRP of a current beam RS by a threshold value.

6. The UE of claim 5, wherein:
when a quality metric, from the one or more quality metrics, corresponding to the current beam RS is included in the beam report and when the event corresponding to the event instance is determined, the L1-RSRP of the current beam RS is quantized to a x₀-bit value with a y₀ dB step size with a reference to a largest measured L1-RSRP in the beam report, and
values of x₀ and y₀ are fixed.

7. The UE of claim 1, wherein:
an event instance is determined when a layer-1 reference signal receive power (L1-RSRP) of a current beam RS is lower than a threshold value,
when a quality metric, from the one or more quality metrics, corresponding to the current beam RS is included in the beam report and when the event corresponding to the event instance is determined, the L1-RSRP of the current beam RS is quantized to a x₁-bit value with y₁ dB step size with a reference to the threshold value, and
values of x₁ and y₁ are fixed.

8. A base station (BS), comprising:
a processor; and
a transceiver operably coupled with the processor, the transceiver configured to:
transmit first information related to an event for triggering a beam report;
transmit a set of one or more periodic reference signals (RSs) for event evaluation;
transmit second information related to the beam report; and
receive the beam report after occurrence of the event,
wherein the beam report indicates at least one quality metric from one or more quality metrics associated with the one or more periodic RSs,
wherein the beam report is based on the second information,
wherein occurrence of the event is based on first information and the one or more quality metrics, and
wherein the one or more quality metrics are associated with the event.

9. The BS of claim 8, wherein the first information includes:
an event type;
a threshold value;
a time window duration; and
a maximum number of event instance count.

10. The BS of claim 8, wherein the second information includes:
a number of the one or more quality metrics to be indicated in the beam report; and
an indicator to enable inclusion of a quality metric, from the one or more quality metrics, corresponding to a current beam RS in the beam report.

11. The BS of claim 10, wherein:
when the indicator enables inclusion of the quality metric corresponding to the current beam RS in the beam report, a bitwidth of a resource indicator corresponding to a RS in the set is [log₂(M+1)],
when the indicator does not enable inclusion of the quality metric corresponding to the current beam RS in the beam report, the bitwidth of the resource indicator corresponding to the RS in the set is [log₂M],
M represents a number of the one or more periodic RSs in the set.

12. The BS of claim 8, wherein an event instance occurs when a layer-1 reference signal receive power (L1-RSRP) of a RS in the set is greater than a L1-RSRP of a current beam RS by a threshold value.

13. The BS of claim 12, wherein:
when a quality metric, from the one or more quality metrics, corresponding to the current beam RS is included in the beam report and when the event corresponding to the event instance occurs, the L1-RSRP of the current beam RS is quantized to a x₀-bit value with a y₀ dB step size with a reference to a largest measured L1-RSRP in the beam report, and
values of x₀ and y₀ are fixed.

14. The BS of claim 8, wherein:
an event instance occurs when a layer-1 reference signal receive power (L1-RSRP) of a current beam RS is lower than a threshold value,
when a quality metric, from the one or more quality metrics, corresponding to the current beam RS is included in the beam report and when the event corresponding to the event instance occurs, the L1-RSRP of the current beam RS is quantized to a x₁-bit value with y₁ dB step size with a reference to the threshold value, and
values of x₁ and y₁ are fixed.

15. A method performed by a user equipment (UE), the method comprising:
receiving first information related to an event for triggering a beam report;
receiving a set of one or more periodic reference signals (RSs) for event evaluation;
receiving second information related to the beam report;
obtaining one or more quality metrics based on measurement of the one or more periodic RSs;
determining the event based on the first information and the one or more quality metrics;
determining, based on the determination of the event and the second information, the beam report indicating at least one quality metric from the one or more quality metrics, the one or more quality metrics associated with the event; and
transmitting the beam report.

16. The method of claim 15, wherein the first information includes:
an event type;
a threshold value;
a time window duration; and
a maximum number of event instance count.

17. The method of claim 15, wherein the second information includes:
a number of the one or more quality metrics to be indicated in the beam report; and
an indicator to enable inclusion of a quality metric, from the one or more quality metrics, corresponding to a current beam RS in the beam report.

18. The method of claim 17, wherein:
when the indicator enables inclusion of the quality metric corresponding to the current beam RS in the beam report, a bitwidth of a resource indicator corresponding to a RS in the set is [log₂(M+1)],
when the indicator does not enable inclusion of the quality metric corresponding to the current beam RS in the beam report, the bitwidth of the resource indicator corresponding to the RS in the set is [log₂M],
M represents a number of the one or more periodic RSs in the set.

19. The method of claim 15, wherein an event instance is determined when a layer-1 reference signal receive power (L1-RSRP) of a RS in the set is greater than a L1-RSRP of a current beam RS by a threshold value.

20. The method of claim 19, wherein:
when a quality metric, from the one or more quality metrics, corresponding to the current beam RS is included in the beam report and when the event corresponding to the event instance is determined, the L1-RSRP of the current beam RS is quantized to a x₀-bit value with a y₀ dB step size with a reference to a largest measured L1-RSRP in the beam report, and
values of x₀ and y₀ are fixed.
